(19) United States
(12) Patent Application Publication
(10) Pub. No.: US 2025/0294166 A1
(43) Pub. Date: Sep. 18, 2025

(54) Methods and Devices on Intra Template Matching Prediction

(71) Applicant: BEIJING DAJIA INTERNET INFORMATION TECHNOLOGY CO., LTD., Beijing (CN)

(72) Inventors: Ning YAN, San Diego, CA (US); Xiaoyu XIU, San Diego, CA (US); Wei CHEN, San Diego, CA (US); Hong-Jheng JHU, San Diego, CA (US); Che-Wei KUO, San Diego, CA (US); Changyue MA, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 19/223,011

(22) Filed: May 29, 2025

Related U.S. Application Data
(63) Continuation of application No. PCT/US2023/082373, filed on Dec. 4, 2023.
(63) Continuation of application No. PCT/US2024/016568, filed on Feb. 20, 2024.
(63) Continuation of application No. PCT/US2024/018966, filed on Mar. 7, 2024.
(63) Continuation of application No. PCT/US2024/019450, filed on Mar. 11, 2024.
(60) Provisional application No. 63/429,971, filed on Dec. 2, 2022.
(60) Provisional application No. 63/447,040, filed on Feb. 20, 2023.
(60) Provisional application No. 63/450,658, filed on Mar. 7, 2023.
(60) Provisional application No. 63/451,546, filed on Mar. 10, 2023.

(51) Int. Cl. H04N 19/159; H04N 19/184; H04N 19/523; H04N 19/567

(52) U.S. Cl. CPC H04N 19/159; H04N 19/184; H04N 19/523; H04N 19/567

(57) ABSTRACT

Methods for video decoding and encoding, apparatuses and non-transitory computer-readable storage media thereof are provided. In one method for video decoding, a decoder may obtain a current template of a current coding unit (CU) coded with Intra template matching prediction (TMP) mode. Additionally, the decoder may obtain an optimal integer predicted template. Furthermore, the decoder may obtain fractional-pel predicted templates. Moreover, the decoder may obtain a final prediction for the current CU based on a distance between the current template and the optimal integer predicted template and the fractional-pel predicted templates.

### CROSS-REFERENCE TO RELATED APPLICATION

This application is based on and claims priority to International Application No. PCT/US2023/082373, filed on Dec. 4, 2023, which claims priority to U.S. Provisional Application No. 63/429,971 filed on Dec. 2, 2022, and to International Application No. PCT/US2024/016568, filed on Feb. 20, 2024, which claims priority to U.S. Provisional Application No. 63/447,040 filed on Feb. 20, 2023, to International Application No. PCT/US2024/018966, filed on Mar. 7, 2024, which claims priority to U.S. Provisional Application No. 63/450,658 filed on Mar. 7, 2023, and to International Application No. PCT/US2024/019450, filed on Mar. 11, 2024, which claims priority to U.S. Provisional Application No. 63/451,546 filed on Mar. 10, 2023. The entireties of all the afore-mentioned patent applications are incorporated herein by reference for all purposes.

### FIELD

The present disclosure is related to video coding and compression, and in particular but not limited to, methods and apparatus to improve the coding efficiency of intra template matching prediction mode.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

The present disclosure provides examples of techniques relating to improving the coding efficiency of intra Template Matching Prediction (TMP) method in a video encoding or decoding process.

According to a first aspect of the present disclosure, there is provided a method for video decoding. In the method, a decoder may obtain a current template of a current coding unit (CU) coded with Intra template matching prediction (TMP) mode. Furthermore, the decoder may obtain an optimal integer predicted template. Additionally, the decoder may obtain fractional-pel predicted templates. Moreover, the decoder may obtain a final prediction for the current CU based on a distance between the current template and the optimal integer predicted template and the fractional-pel predicted templates.

According to a second aspect of the present disclosure, there is provided an apparatus for video decoding. The apparatus includes one or more processors, and a memory coupled to the one or more processors and configured to store instructions executable by the one or more processors. The one or more processors, upon execution of the instructions, are configured to, individually or collectively, perform operations including: obtaining, by a decoder, a current template of a current coding unit (CU) coded with Intra template matching prediction (TMP) mode; obtaining, by the decoder, an optimal integer predicted template; obtaining, by the decoder, fractional-pel predicted templates; and obtaining, by the decoder, a final prediction for the current CU based on distances between the current template and the optimal integer predicted template and the fractional-pel predicted templates.

According to a third aspect of the present disclosure, there is provided a non-transitory computer-readable storage medium. The storage medium stores a bitstream to be decoded by operations of the method according to the first aspect.

According to a fourth aspect of the present disclosure, there is provided a method of storing a bitstream. The method includes: generating a bitstream by performing an encoding method; and storing the bitstream, wherein the encoding method comprises: encoding, by an encoder, a current template of a current coding unit (CU) coded with Intra template matching prediction (TMP) mode; obtaining, by the encoder, an optimal integer predicted template; obtaining, by the encoder, fractional-pel predicted templates; and obtaining, by the encoder, a final prediction for the current CU based on distances between the current template and the optimal integer predicted template and the fractional-pel predicted templates.

### BRIEF DESCRIPTION OF THE DRAWINGS

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1 is a block diagram illustrating an exemplary system for encoding and decoding video blocks in accordance with some examples of the present disclosure.

FIG. 2 is a block diagram illustrating an exemplary video encoder in accordance with some examples of the present disclosure.

FIG. 3 is a block diagram illustrating an exemplary video decoder in accordance with some examples of the present disclosure.

FIGS. 4A through 4E are block diagrams illustrating how a frame is recursively partitioned into multiple video blocks of different sizes and shapes in accordance with some examples of the present disclosure.

FIG. 5 is a diagram illustrating a computing environment coupled with a user interface, according to some examples of the present disclosure.

FIG. 6 illustrates a diagram of intra modes as defined in VVC in accordance with some examples of the present disclosure;

FIG. 7 illustrates a diagram of multiple reference lines for intra prediction in accordance with some examples of the present disclosure;

FIGS. 8A and 8B illustrate diagrams of reference samples for Position-Dependent intra Prediction Combination (PDPC) in a top-right diagonal mode and a bottom-left diagonal mode respectively in accordance with some examples of the present disclosure;

FIG. 9A illustrates a diagram of sub-partitions for 4×8 and 8×4 CUs in accordance with some examples of the present disclosure;

FIG. 9B illustrates a diagram of sub-partitions for CUs other than 4×8, 8×4 and 4×4 CUs in accordance with some examples of the present disclosure;

FIG. 10 illustrates a diagram of locations of left and above samples of a CU involved in a Cross-Component Linear Model (CCLM) prediction in accordance with some examples of the present disclosure;

FIG. 11 illustrates a diagram of a Matrix weighted Intra Prediction (MIP) process in accordance with some examples of the present disclosure.

FIG. 12 illustrates a diagram of Intra template matching search area used in accordance with some examples of the present disclosure;

FIG. 13 illustrates a diagram of half-pel interpolation and template matching search in accordance with some examples of the present disclosure.

FIG. 14 is a flow chart illustrating a method for video decoding in accordance with some examples of the present disclosure.

FIG. 15 is a flow chart illustrating a method for video encoding corresponding to the method for video decoding as shown in FIG. 14 in accordance with some examples of the present disclosure.

FIG. 16 is a flow chart illustrating a method for video decoding in accordance with some examples of the present disclosure.

FIG. 17 is a flow chart illustrating a method for video encoding corresponding to the method for video decoding as shown in FIG. 16 in accordance with some examples of the present disclosure.

FIG. 18 illustrates a diagram of Intra template matching search area used in accordance with some examples of the present disclosure.

FIG. 19 illustrates the use of Intra TMP block vector for IBC block in accordance with some examples of the present disclosure.

FIG. 20 illustrates spatial locations for a linear filter model in accordance with some examples of the present disclosure.

FIG. 21 illustrates the reference area used to derive the filter coefficients of the linear filter model in accordance with some examples of the present disclosure.

FIG. 22 illustrates a diagram of locations of left and above samples of a CU involved in a Cross-Component Linear Model (CCLM) prediction in accordance with some examples of the present disclosure.

FIG. 23 illustrates the reference area (with its paddings) used to derive the filter coefficients of CCCM in accordance with some examples of the present disclosure.

FIG. 24 illustrates the four Sobel based gradient patterns for GLM in accordance with some examples of the present disclosure.

FIG. 25 is a flow chart illustrating a method for video decoding in accordance with some examples of the present disclosure.

FIG. 26 is a flow chart illustrating a method for video encoding corresponding to the method for video decoding as shown in FIG. 25 in accordance with some examples of the present disclosure.

FIG. 27 is a flow chart illustrating a method for video decoding in accordance with some examples of the present disclosure.

FIG. 28 is a flow chart illustrating a method for video encoding corresponding to the method for video decoding as shown in FIG. 27 in accordance with some examples of the present disclosure.

FIG. 29 is a flow chart illustrating a method for video decoding in accordance with some examples of the present disclosure.

FIG. 30 is a flow chart illustrating a method for video encoding corresponding to the method for video decoding as shown in FIG. 29 in accordance with some examples of the present disclosure.

FIG. 31 is a flow chart illustrating a method for video decoding in accordance with some examples of the present disclosure.

FIG. 32 is a flow chart illustrating a method for video encoding corresponding to the method for video decoding as shown in FIG. 31 in accordance with some examples of the present disclosure.

FIGS. 33A-33C illustrate diagrams of subblock intra TMP in accordance with some examples of the present disclosure.

FIG. 34 illustrates a diagram of rectangular region-based intra TMP in accordance with some examples of the present disclosure.

FIGS. 35A-35B illustrates diagrams of two-stage combination of intra and intra TMP in accordance with some examples of the present disclosure.

FIG. 36 is a flow chart illustrating a method for video decoding in accordance with some examples of the present disclosure.

FIG. 37 is a flow chart illustrating a method for video encoding corresponding to the method for video decoding as shown in FIG. 36 in accordance with some examples of the present disclosure.

FIG. 38 is a flow chart illustrating a method for video decoding in accordance with some examples of the present disclosure.

FIG. 39 is a flow chart illustrating a method for video encoding corresponding to the method for video decoding as shown in FIG. 38 in accordance with some examples of the present disclosure.

FIG. 40 illustrates a diagram showing dividing an intermediate prediction block into several subblocks and conducting into several subblocks based on subblocks in accordance with some examples of the present disclosure.

FIG. 41 illustrates a diagram showing using a subblock centered at a pixel position to find reference subblocks for the current pixel by minimizing the distance between the current subblock and the reference subblock in accordance with some examples of the present disclosure.

FIG. 42 is a flow chart illustrating a method for video decoding in accordance with some examples of the present disclosure.

FIG. 43 is a flow chart illustrating a method for video encoding corresponding to the method for video decoding as shown in FIG. 42 in accordance with some examples of the present disclosure.

### DETAILED DESCRIPTION

Reference will now be made in detail to specific examples, examples of which are illustrated in the accompanying drawings. In the following detailed description, numerous non-limiting specific details are set forth in order to assist in understanding the subject matter presented herein. But various alternatives may be used without departing from the scope of claims and the subject matter may be practiced without these specific details. For example, the subject matter presented herein can be implemented on many types of electronic devices with digital video capabilities.

Terms used in the disclosure are only adopted for the purpose of describing specific embodiments and not intended to limit the disclosure. “A/an,” “said,” and “the” in a singular form in the disclosure and the appended claims are also intended to include a plural form, unless other meanings are clearly denoted throughout the disclosure. It is also to be understood that term “and/or” used in the disclosure refers to and includes one or any or all possible combinations of multiple associated items that are listed.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, “first.” “second,” “third,” etc. are all used as nomenclature only for references to relevant elements, e.g., devices, components, compositions, steps, etc., without implying any spatial or chronological orders, unless expressly specified otherwise. For example, a “first device” and a “second device” may refer to two separately formed devices, or two parts, components, or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may comprise steps of. i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

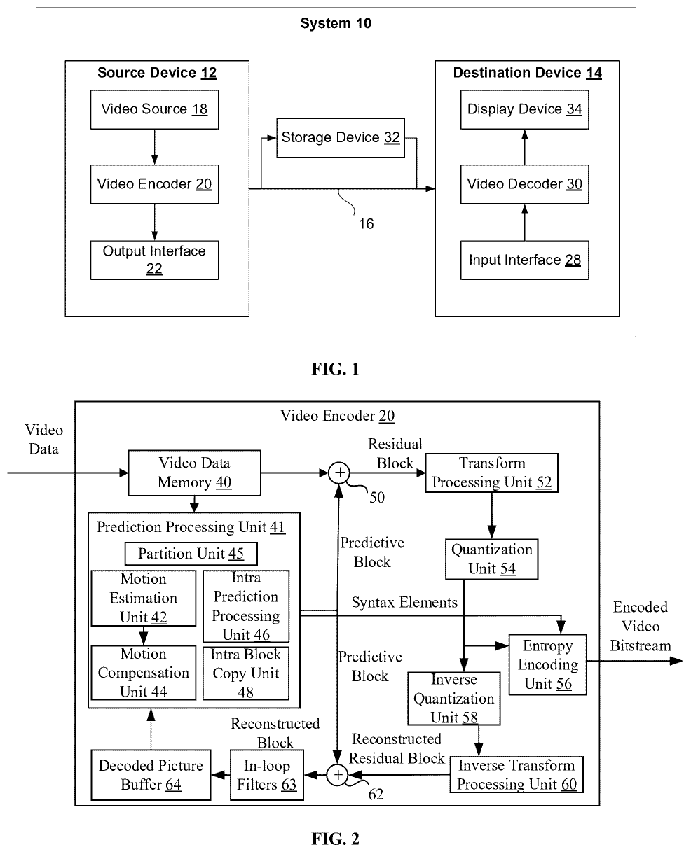

FIG. 1 is a block diagram illustrating an exemplary system 10 for encoding and decoding video blocks in parallel in accordance with some examples of the present disclosure. As shown in FIG. 1, the system 10 includes a source device 12 that generates and encodes video data to be decoded at a later time by a destination device 14. The source device 12 and the destination device 14 may include any of a wide variety of electronic devices, including cloud servers, server computers, desktop or laptop computers, tablet computers, smart phones, set-top boxes, digital televisions, cameras, display devices, digital media players, video gaming consoles, video streaming device, or the like. In some examples, the source device 12 and the destination device 14 are equipped with wireless communication capabilities.

In some examples, the destination device 14 may receive the encoded video data to be decoded via a link 16. The link 16 may include any type of communication medium or device capable of moving the encoded video data from the source device 12 to the destination device 14. In one example, the link 16 may include a communication medium to enable the source device 12 to transmit the encoded video data directly to the destination device 14 in real time. The encoded video data may be modulated according to a communication standard, such as a wireless communication protocol, and transmitted to the destination device 14. The communication medium may include any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other examples, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the examples described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some examples, the destination device 14 may include the display device 34, which can be an integrated display device and an external display device that is configured to communicate with the destination device 14. The display device 34 displays the decoded video data to a user, and may include any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

In some implementations, at least a part of components of the source device 12 (for example, the video source 18, the video encoder 20 or components included in the video encoder 20 as described below with reference to FIG. 1, and the output interface 22) and/or at least a part of components of the destination device 14 (for example, the input interface 28, the video decoder 30 or components included in the video decoder 30 as described below with reference to FIG. 3, and the display device 34) may operate in a cloud computing service network which may provide software, platforms, and/or infrastructure, such as Software as a Service (SaaS), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In an embodiment, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based” etc. herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

FIG. 2 is a block diagram illustrating another exemplary video encoder 20 in accordance with some examples described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some examples, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component, a Cb chroma component and a Cr chroma component according to any other of the luma component, the Cb chroma component and the Cr chroma component to modify said any component based on the selected offset. Further, it should also be illustrated that a first component mentioned herein may be any of the luma component, the Cb chroma component and the Cr chroma component, a second component mentioned herein may be any other of the luma component, the Cb chroma component and the Cr chroma component, and a third component mentioned herein may be a remaining one of the luma component, the Cb chroma component and the Cr chroma component. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g., a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some examples, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some examples, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some examples, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the examples described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 3 is another block diagram illustrating an exemplary video decoder 30 in accordance with some examples of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the examples of the present application. Also, in some examples, the examples of the present disclosure may be divided among one or more of the units of the video decoder 30. For example, the intra BC unit 85 may perform the examples of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

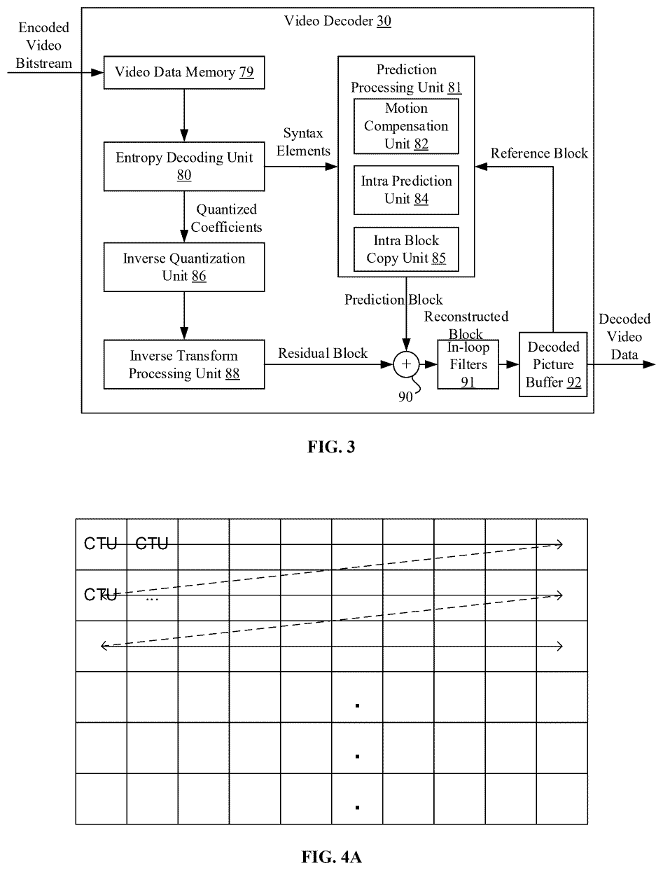

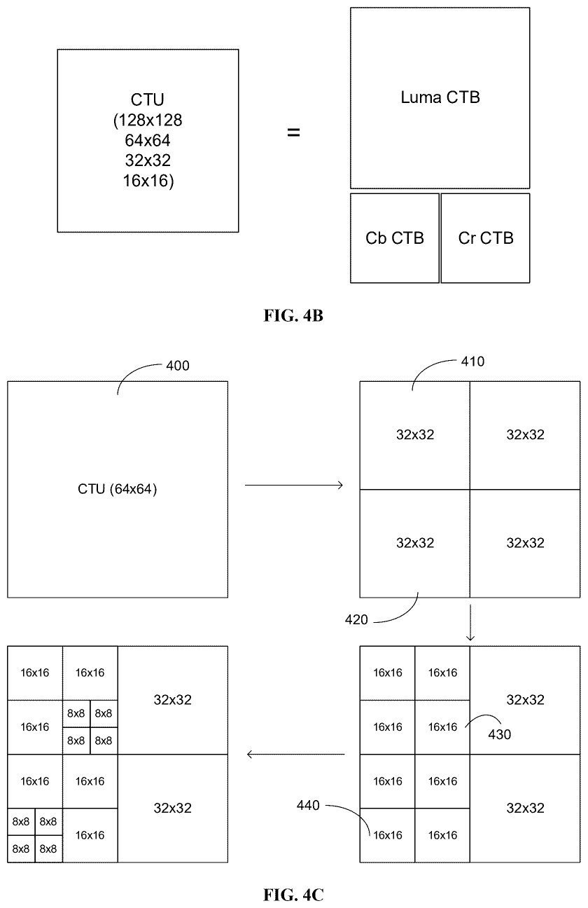

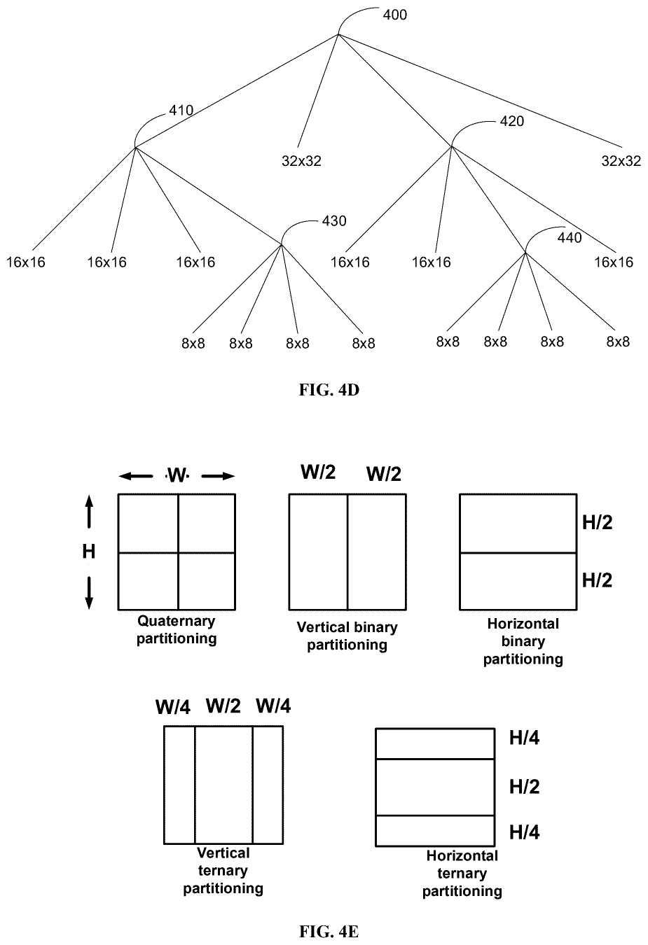

As shown in FIG. 4A, the video encoder 20 (or more specifically a partition unit in a prediction processing unit of the video encoder 20) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 4B, each CTU may include one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may include a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. FIGS. 4B-4E are block diagrams illustrating how a frame is recursively partitioned into multiple video blocks of different sizes and shapes in accordance with some implementations of the present disclosure. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may include a CB of luma samples and two corresponding coding blocks of chroma samples of a frame of the same size, and syntax elements used to code the samples of the coding blocks. In monochrome pictures or pictures having three separate color planes, a CU may include a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are five possible partitioning types of a coding block having a width W and a height H, i.e., quaternary partitioning, horizontal binary partitioning, vertical binary partitioning, horizontal ternary partitioning, and vertical ternary partitioning.

In some examples, the video encoder 20 may further partition a coding block of a CU into one or more M×N PBs. A PB is a rectangular (square or non-square) block of samples on which the same prediction, inter or intra, is applied. A PU of a CU may include a PB of luma samples, two corresponding PBs of chroma samples, and syntax elements used to predict the PBs. In monochrome pictures or pictures having three separate color planes, a PU may include a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may include a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may include a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

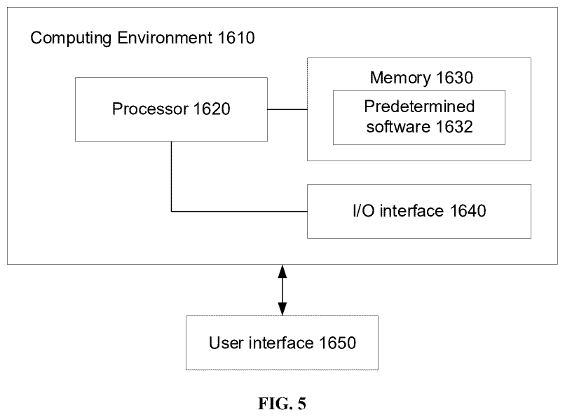

FIG. 5 shows a computing environment (or a computing device) 1610 coupled with a user interface 1650. In some embodiments, the computing device 1610 can perform any of various methods or processes (such as encoding/decoding methods or processes) as described hereinbefore in accordance with various examples of the present disclosure. The computing environment 1610 can be part of a data processing server. The computing environment 1610 includes a processor 1620, a memory 1630, and an Input/Output (I/O) interface 1640.

The processor 1620 typically controls overall operations of the computing environment 1610, such as the operations associated with display, data acquisition, data communications, and image processing. The processor 1620 may include one or more processors to execute instructions to perform all or some of the steps in the above-described methods. Moreover, the processor 1620 may include one or more modules that facilitate the interaction between the processor 1620 and other components. The processor may be a Central Processing Unit (CPU), a microprocessor, a single chip machine, a Graphical Processing Unit (GPU), or the like.

The memory 1630 is configured to store various types of data to support the operation of the computing environment 1610. The memory 1630 may include predetermined software 1632. Examples of such data includes instructions for any applications or methods operated on the computing environment 1610, video datasets, image data, etc. The memory 1630 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 1640 provides an interface between the processor 1620 and peripheral interface modules, such as a keyboard, a click wheel, buttons, and the like. The buttons may include but are not limited to, a home button, a start scan button, and a stop scan button. The I/O interface 1640 can be coupled with an encoder and decoder.

In general, the basic intra prediction scheme applied in VVC is almost kept the same as that of HEVC, except that several prediction tools are further extended, added and/or improved, e.g., extended intra prediction with wide-angle intra modes, Multiple Reference Line (MRL) intra prediction, PDPC, Intra Sub-Partition (ISP) prediction, CCLM prediction, MIP and intra template matching prediction (TMP).

Extended Intra Prediction with Wide-Angle Intra Modes

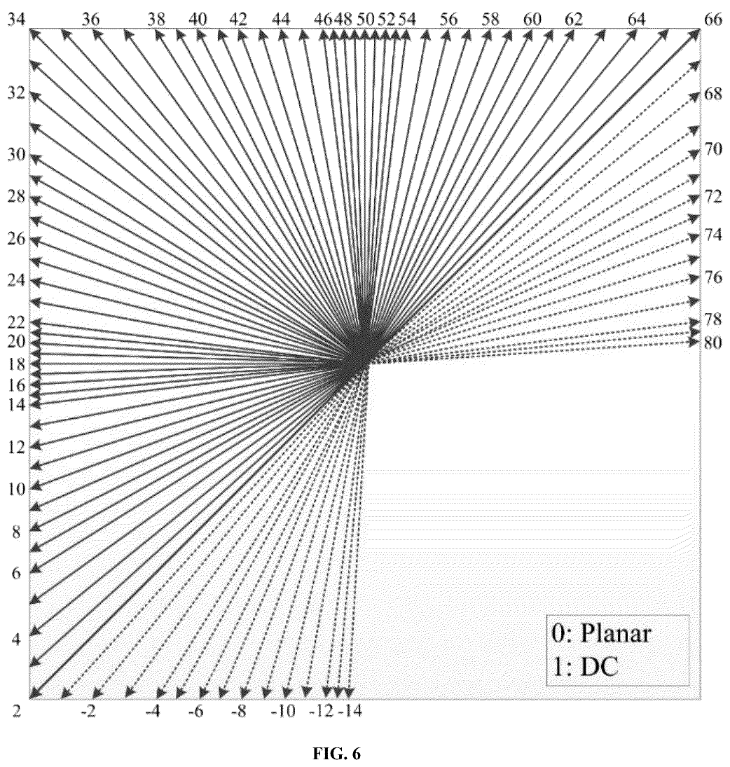

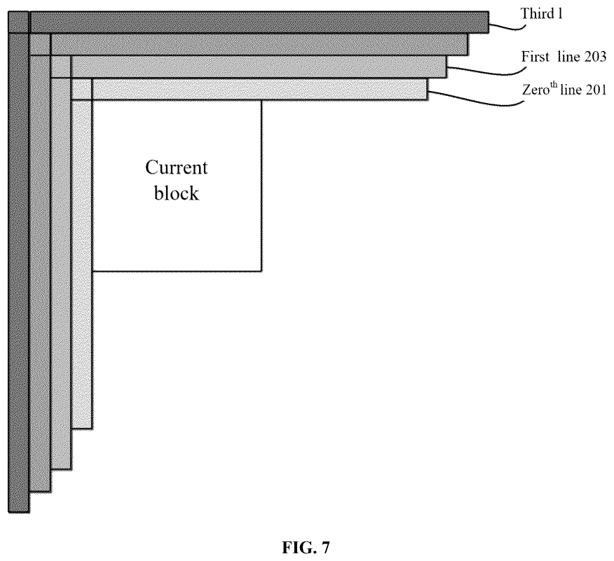

Like HEVC, VVC uses a set of reference samples neighboring a current CU (i.e., above the current CU or left to the current CU) to predict samples of the current CU. However, to capture finer edge directions present in natural video (especially for video content in high resolutions, e.g., 4K), a number of angular intra modes is extended from 33 in HEVC to 93 in VVC. FIG. 6 illustrates a diagram of intra modes as defined in VVC. As shown in FIG. 6, among the 93 angular intra modes, modes 2 to 66 are conventional angular intra modes, and modes −1 to −14 and modes 67 to 80 are wide-angle intra modes. In addition to the angular intra modes, the planar mode (mode 0 in FIG. 6) and Direct Current (DC) mode (mode 1 in FIG. 6) of HEVC are also applied in VVC.

Since a quad/binary/ternary tree partition structure is applied in VVC, besides video blocks in square shape, rectangular video blocks also exist for the intra prediction in VVC. Due to unequal width and height of one given video block, various sets of angular intra modes may be selected from the 93 angular intra modes for different block shapes. More specifically, for both square and rectangular video blocks, besides planar and DC modes, 65 angular intra modes among the 93 angular intra modes are also supported for each block shape. When a rectangular block shape of a video block satisfies a certain condition, an index of a wide-angle intra mode of the video block may be adaptively determined by the video decoder 30 according to an index of a conventional angular intra mode received from the video encoder 20 using a mapping relationship as shown in Table 1 below. That is, for non-square blocks, the wide-angle intra modes are signaled by the video encoder 20 using the indexes of the conventional angular intra modes, which are mapped to indexes of the wide-angle intra modes by the video decoder 30 after being parsed, thus ensuring that a total number (i.e., 67) of intra modes (i.e., the planar mode, the DC mode and 65 angular intra modes among the 93 angular intra modes) is unchanged, and the intra mode coding method is unchanged. As a result, a good efficiency of signaling intra modes is achieved while providing a consistent design across different block sizes.

Table 1 shows a mapping relationship between indexes of conventional angular intra modes and indexes of wide-angle intra modes for the intra prediction of different block shapes in VCC, wherein W represents a width of a video block, and H represents a height of the video block.

TABLE 1

| | | Indexes of | Indexes of |
|---|---|---|---|
| Block | | conventional | wide-angle |
| shape | Aspect ratio | angular intra modes | intra modes |
| Square, | W/H == 1 | None | None |
| W = H | | | |
| Flat | W/H == 2 | 2, 3, 4, 5, 6, 7, 8, 9 | 67, 68, 69, 70, 71, 72, |
| rectangle, | | | 73, 74 |
| W > H | W/H == 4 | 2, 3, 4, 5, 6, 7, 8, 9, | 67, 68, 69, 70, 71, 72, |
| | | 10, 11 | 73, 74, 75, 76 |
| | W/H == 8 | 2, 3, 4, 5, 6, 7, 8, 9, | 67, 68, 69, 70, 71, 72, |
| | | 10, 11, 12, 13 | 73, 74, 75, 76, 77, 78 |
| | W/H == 16 | 2, 3, 4, 5, 6, 7, 8, 9, | 67, 68, 69, 70, 71, 72, |
| | | 10, 11, 12, 13, 14, | 73, 74, 75, 76, 77, 78, |
| | | 15 | 79, 80 |
| Tall | W/H == ½ | 59, 60, 61, 62, 63, | −8, −7, −6, −5, −4, |
| rectangle, | | 64, 65, 66 | −3, −2, −1 |
| W < H | W/H == ¼ | 57, 58, 59, 60, 61, | −10, −9, −8, −7, −6, |
| | | 62, 63, 64, 65, 66 | −5, −4, −3, −2, −1 |
| | W/H == ⅛ | 55, 56, 57, 58, 59, | −12, −11, −10, −9, −8, |
| | | 60, 61, 62, 63, 64, | −7, −6, −5, −4, −3, |
| | | 65, 66 | −2, −1 |
| | W/H == 1/16 | 53, 54, 55, 56, 57, | −14, −13, −12, −11, |
| | | 58, 59, 60, 61, 62, | −10, −9, −8, −7, −6, |
| | | 63, 64, 65, 66 | −5, −4, −3, −2, −1 |

### MRL Intra Prediction

Similar to the intra prediction in HEVC, all the intra modes (i.e., planar, DC and angular intra modes) in VVC utilize a set of reference samples above and left to a current video block for intra prediction. However, differently from HEVC where only the nearest row/column (i.e., a zeroth line 201 in FIG. 7) of reference samples are used, MRL intra prediction is introduced in VVC where in addition to the nearest row/column of reference samples, two additional rows/columns of reference samples (i.e., a first line 203 and a third line 205 in FIG. 7) may be used for the intra prediction. An index of a selected row/column of reference samples is signaled from the video encoder 20 to the video decoder 30. When a non-nearest row/column of reference samples (i.e., the first line 203 or the third line 205 in FIG. 7) is selected, the planar mode is excluded from a set of intra modes that may be used to predict the current video block. The MRL intra prediction is disabled for a first row/column of video blocks inside a current CTU to prevent using extended reference samples outside the current CTU.

### PDPC

As mentioned earlier, the intra prediction samples are generated from a set of neighboring reference samples, which may introduce discontinuities along block boundaries between a current video block and neighboring video blocks thereof. The PDPC tool is introduced in VVC to solve such problems by employing a weighted combination of intra prediction samples with boundary reference samples. In VVC, PDPC may be enabled for the following intra modes without signaling: planar mode, DC mode, angular intra modes with indexes less than or equal to that of a horizontal intra mode (i.e., mode 18), and angular intra modes with indexes greater than or equal to that of a vertical intra mode (i.e., mode 50) and less than or equal to 80. If a Block Differential Pulse Coded Modulation (BDPCM) mode is applied for the current block or an index of a selected row/column of reference samples for MRL intra prediction is greater than 0, PDPC is not applied. Assuming that a prediction sample of a current sample located at coordinate (x, y) is pred(x,y), a modified prediction sample pred′(x,y) after the PDPC is performed is calculated as:

$$pred ’ ( x , y ) = Clip 3 ( 0 , ( 1 ≪ BitDepth ) - 1 , ( wL \times {R}_{- 1 , y ’} + wT \times {R}_{x ’ , - 1} + ( 64 - wL - wT ) \times pred ( x , y ) + 32 ) ≫ 6 ) \qquad ( 1 )$$

where Bitdepth represents a bit depth of samples, Rx′,−1 and R−1,y′ represent reference samples located at top and left boundaries of the current sample, respectively, wL and wT are weights which are adaptively selected according to an intra mode and a block size of the current block, “>>” represents a bitwise right shift operation, and “<<” indicates a bitwise left shift operation.

The function Clip3(x, y, z) in the equation (1) may be defined as follows:

$$Clip 3 ( x , y , z ) = \{ \begin{matrix}x & z < x \\ y & z > y \\ z & otherwise\end{matrix} \qquad ( 2 )$$

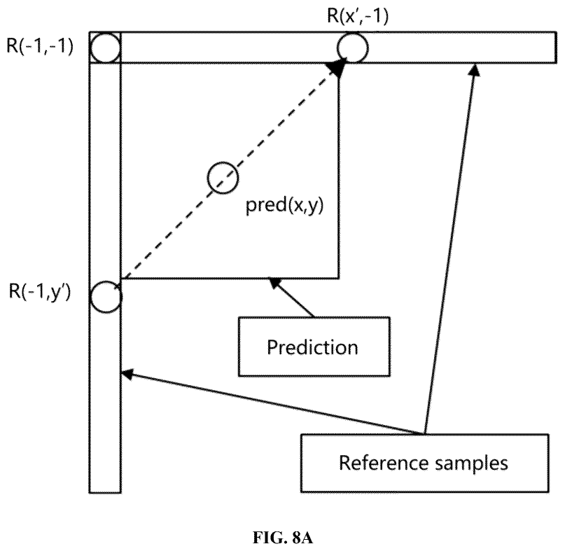

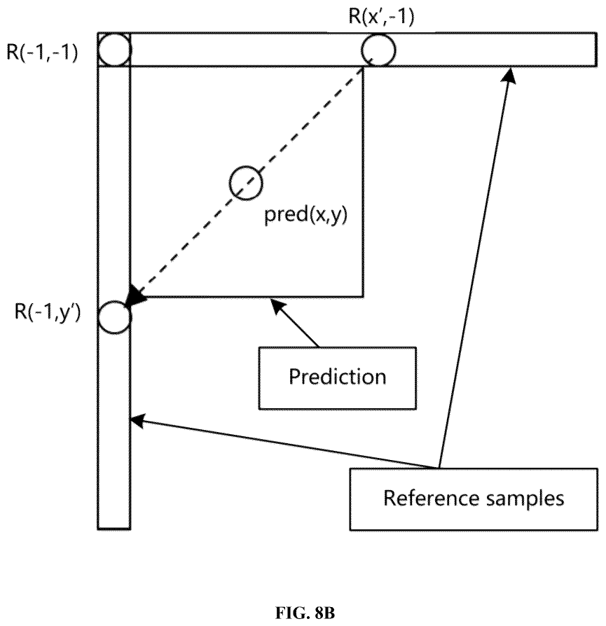

FIGS. 8A and 8B illustrate diagrams of reference samples for PDPC in a top-right diagonal mode and a bottom-left diagonal mode respectively. The prediction sample pred(x,y) is located at (x,y) in the prediction block. The reference sample Rx′,−1 has a horizontal coordinate of x′=x+y+1 and a vertical coordinate of −1, and the reference sample R−1,y′ has a horizontal coordinate of −1 and a vertical coordinate of y′=x+y+1.

### ISP Prediction

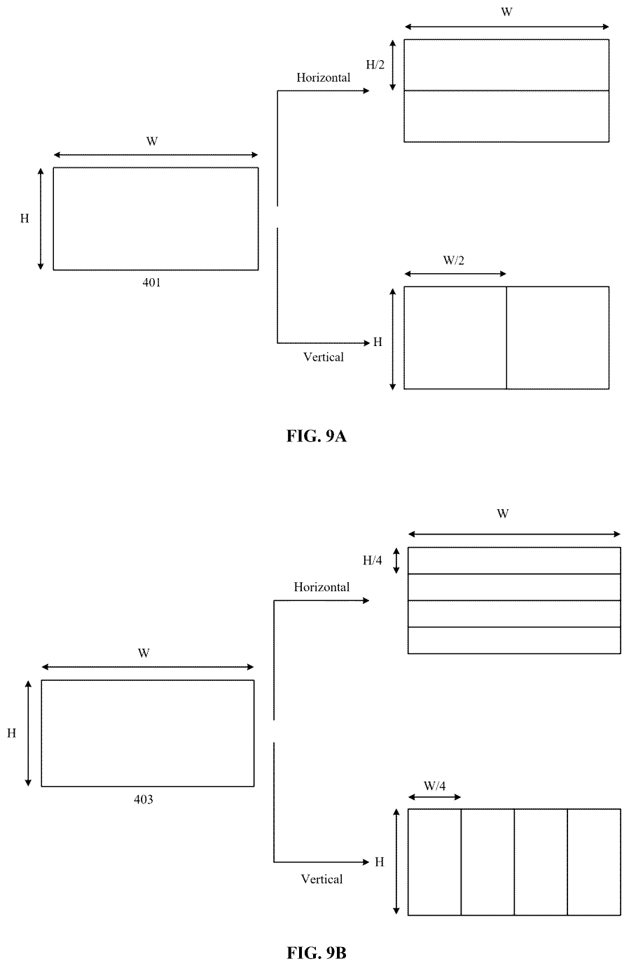

The ISP prediction is a tool applied for luma intra prediction modes, which divides luma video blocks vertically or horizontally into 2 or 4 sub-partitions depending on block sizes thereof, as shown in Table 2. For example, a minimum block size for ISP is 4×8 or 8×4. FIGS. 9A and 9B show diagrams of sub-partitions depending on a block size. If a block size W×H of a video block (for example, the video block 401 as shown in FIG. 9A) is equal to 4×8 or 8×4, then the video block is divided into 2 sub-partitions. If a block size W×H of a video block (for example, the video block 403 as shown in FIG. 9B) is greater than 4×8 or 8×4, then the video block is divided into 4 sub-partitions. A CU size that may use ISP is restricted to a maximum of 64×64. All sub-partitions fulfill a condition of having at least 16 samples.

TABLE 2

| Block size | Number of sub-partitions |
|---|---|
| 4 × 4 | Not divided |
| 4 × 8 and 8 × 4 | 2 |
| All other feasible cases | 4 |

For each sub-partition, reconstructed samples are obtained by adding a residual signal to a prediction signal. Here, the residual signal is generated by processes such as entropy decoding, inverse quantization and inverse transform. The reconstructed samples of each sub-partition are available to generate prediction of a next sub-partition. In addition, a first sub-partition to be processed is the one containing a top-left sample of the CU, and after the first sub-partition is processed, the ISP prediction continues downwards (for horizontal splitting as shown in FIGS. 9A and 9B) or rightwards (for vertical splitting as shown in FIGS. 9A and 9B). All sub-partitions share the same intra prediction mode.

### CCLM Prediction

To reduce the cross-component redundancy, a CCLM prediction mode is used in VVC, wherein chroma samples of a CU are predicted based on reconstructed luma samples rec_{L}(i,j) of the CU by using a linear model as follows:

$${pred}_{C} ( i , j ) = α \cdot {rec}_{L}^{′} ( i , j ) + β \qquad ( 3 )$$

where pred_{C}(i,j) represents predicted chroma samples in the CU, rec_{L}(i,j) represents down-sampled reconstructed luma samples of the CU which are obtained by performing down-sampling on the reconstructed luma samples rec_{L}(i,j), and α and β are linear model parameters which are derived from at most four neighboring chroma samples and their corresponding down-sampled luma samples. Suppose that a current chroma block has a size of W×H, then W′ and H′ are obtained as follows:
W′=W, H′=H when an LM mode is applied;
W′=W+H when an LM_A mode is applied;
H′=H+W when an LM_L mode is applied.

where in the LM mode, above samples and left samples of the CU are used together to calculate the linear model coefficients; in the LM_A mode, only the above samples of the CU are used to calculate the linear model coefficients; and in the LM_L mode, only the left samples of the CU are used to calculate the linear model coefficients.

If locations of above samples of a chroma block are denoted as S[0, −1] . . . S[W′−1, −1] and locations of left samples of the chroma block are denoted as S[−1, 0] . . . S[−1, H′−1], positions of four neighboring chroma samples are selected as follows:
S[W′/4, −1], S[3*W′/4, −1], S[−1, H′/4] and S[−1, 3*H′/4] are selected as the positions of the four neighboring chroma samples when the LM mode is applied and both of the above and left samples are available;
S[W′/8, −1], S[3*W′/8, −1], S[5*W′/8, −1] and S[7*W′/8, −1] are selected as the positions of the four neighboring chroma samples when the LM_A mode is applied and the above samples are available or when only the above samples are available;
S[−1, H′/8], S[−1, 3*H′/8], S[−1, 5*H′/8] and S[−1, 7*H′/8] are selected as the positions of the four neighboring chroma samples when the LM_L mode is applied and the left samples are available or when only the left samples are available.

Four neighboring luma samples corresponding to the selected locations are obtained by a down-sampling operation and the obtained four neighboring luma samples are compared four times to find two larger values: x0A and x1A and two smaller values: x0B and x1B. Chroma sample values corresponding to the two larger values and the two smaller values are denoted as y0A, y1A, y0B and y1B respectively. Then Xa, Xb, Ya and Yb are derived as:

$$\begin{matrix}{X}_{a} = ( {x}_{A}^{0} + {x}_{A}^{1} + 1 ) ≫ 1 ; \\ {X}_{b} = ( {x}_{B}^{0} + {x}_{B}^{1} + 1 ) ≫ 1 ; \\ {Y}_{a} = ( {y}_{A}^{0} + {y}_{A}^{1} + 1 ) ≫ 1 ; \\ {Y}_{b} = ( {y}_{B}^{0} + {y}_{B}^{1} + 1 ) ≫ 1.\end{matrix} \qquad ( 4 )$$

Finally, the linear model parameters α and β are obtained according to the following equations.

$$\begin{matrix}α = \frac{{Y}_{a} - {Y}_{b}}{{X}_{a} - {X}_{b}} \\ β = {Y}_{b} - α \cdot {X}_{b}\end{matrix} \qquad ( 5 )$$

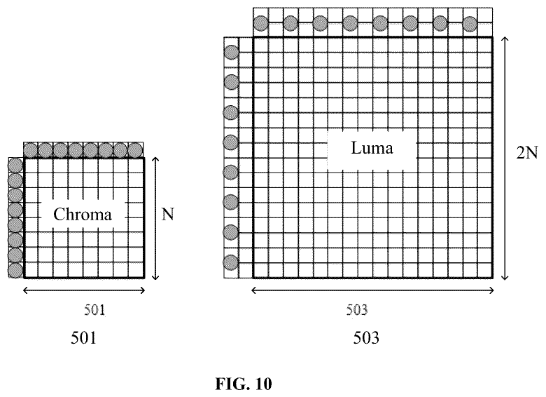

FIG. 10 shows a diagram of locations of left and above samples of the CU involved in the CCLM mode, including locations of left and above samples of an N×N chroma block 501 in the CU and locations of left and above samples of an 2N×2N luma block 503 in the CU.

The parameter computation described above is performed as part of the decoding process, and therefore no syntax element is used to convey values of α and β from the video encoder 20 to the video decoder 30.

### MIP

MIP is an intra prediction method newly added into VVC. In the MIP prediction method, a prediction signal of samples of a rectangular block of width W and height H is generated by taking one column of H reconstructed neighboring boundary samples left to the rectangular block and one row of W reconstructed neighboring boundary samples above the rectangular block as input based on the following three steps, which are averaging, matrix vector multiplication, and linear interpolation as shown in FIG. 11.

### First Step: Averaging Neighboring Samples

Four samples or eight samples are determined by averaging the neighboring boundary samples bdrytop and bdryleft based on block size and shape. For example, the neighboring boundary samples bdrytop and bdryleft are reduced to boundary samples bdry_{red}^{top} and bdry_{red}^{left} by averaging the neighboring boundary samples bdrytop and bdryleft according to a predefined rule depending on the block size. Then, the reduced boundary samples bdry_{red}^{top} and bdry_{red}^{left} are concatenated to a reduced boundary vector bdry_{red} which thus has a size of 4 for blocks of shape 4×4 and has a size of 8 for blocks of all other shapes. If Indexmode refers to the MIP-mode, this concatenation is defined as follows:

$${bdry}_{red} = \{ \begin{matrix}[ {bdry}_{red}^{top} , {bdry}_{red}^{left} ] & for W = H = 4 and {Index}_{mode} < 18 \\ [ {bdry}_{red}^{left} , {bdry}_{red}^{top} ] & for W = H = 4 and {Index}_{mode} \geq 18 \\ [ {bdry}_{red}^{top} , {bdry}_{red}^{left} ] & for max ( W , H ) = 8 and {Index}_{mode} < 10 \\ [ {bdry}_{red}^{left} , {bdry}_{red}^{top} ] & for max ( W , H ) = 8 and {Index}_{mode} \geq 10 \\ [ {bdry}_{red}^{top} , {bdry}_{red}^{left} ] & for max ( W , H ) > 8 and {Index}_{mode} < 6 \\ [ {bdry}_{red}^{left} , {bdry}_{red}^{top} ] & for max ( W , H ) > 8 and {Index}_{mode} \geq 6.\end{matrix} \qquad ( 6 )$$

### Second Step: Matrix Vector Multiplication

A matrix vector multiplication, followed by addition of an offset, is carried out with the averaged samples in the reduced boundary vector bdry_{red} as an input, to generate a reduced prediction signal of a down-sampled set of samples in the original block. In one or more examples, the reduced prediction signal pred_{red} is computed as:

$${pred}_{red} = A \cdot {bdry}_{red} + b \qquad ( 7 )$$

Here, A is a matrix that has W_{red}·H_{red} rows and 4 columns if W=H=4 or 8 columns in all other cases. b is an offset vector of size W_{red} H_{red}.

Here, W_{red} and H_{red} are defined as:

$${W}_{red} = \{ \begin{matrix}4 & for max ( W , H ) \leq 8 \\ min ( W , 8 ) & for max ( W , H ) > 8\end{matrix} \qquad ( 8 )$$

$${H}_{red} = \{ \begin{matrix}4 & for max ( W , H ) \leq 8 \\ min ( H , 8 ) & for max ( W , H ) > 8\end{matrix} \qquad ( 9 )$$

The matrix A and the offset vector b are taken from one of the sets S₀, S₁, S₂ An index idx of a set from which the matrix A and the offset vector b are taken is defined as follows:

$$idx = \{ \begin{matrix}0 & for W = H = 4 \\ 1 & for max ( W , H ) = 8 \\ 2 & for max ( W , H ) > 8\end{matrix} \qquad ( 10 )$$

Here, each coefficient of the matrix A is represented with 8-bit precision. The set S₀ consists of 16 matrices A₀ⁱ each of which has 16 rows and 4 columns and 16 offset vectors b₀ⁱ each of size 16, i∈{0, . . . , 15}. Matrices and offset vectors of that set are used for blocks of size 4×4. The set S₁ consists of 8 matrices A₁ⁱ each of which has 16 rows and 8 columns and 8 offset vectors b₁ⁱ each of size 16, i∈{0, . . . , 7}. The set S₂ consists of 6 matrices A₂ⁱ each of which has 64 rows and 8 columns and of 6 offset vectors b₂ⁱ of size 64, i∈{0, . . . , 5}.

### Third Step: Interpolation

The prediction signal at the remaining positions is generated from the reduced prediction signal of the down-sampled set of samples by linear interpolation which is a single step linear interpolation in each direction. The interpolation is performed firstly in the horizontal direction and then in the vertical direction regardless of block shape or block size.

### Intra Template Matching Prediction

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

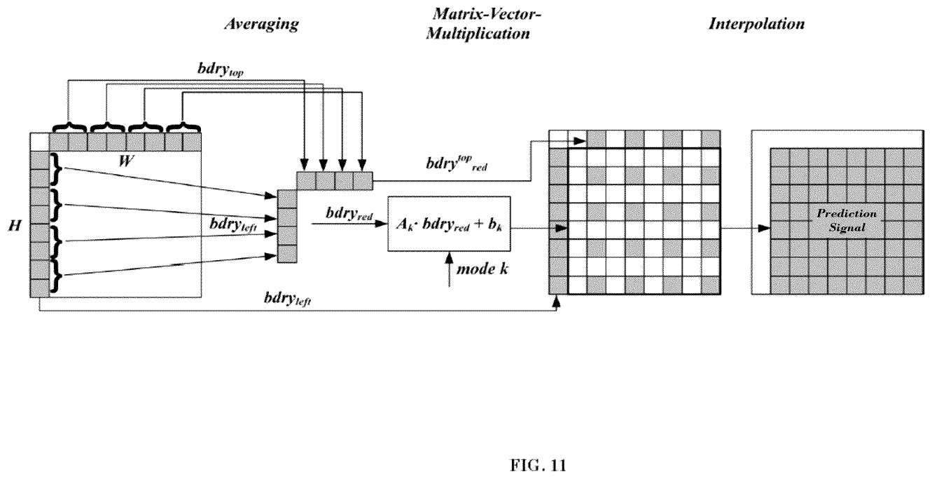

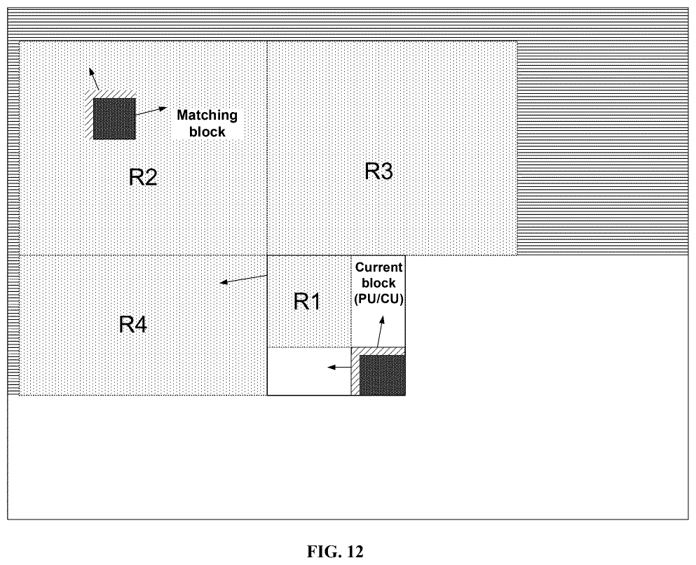

The prediction signal is generated by matching the L-shaped causal neighbor of the current block with another block in a predefined search area in FIG. 12 consisting of:
R1: current CTU
R2: top-left CTU
R3: above CTU
R4: left CTU

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

SearchRange_w=a*BlkW

SearchRange_h=a*BlkH

where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

Although the existing intra TMP scheme can provide significant improvement of intra coding in the ECM, its design can still be further improved. For example, the following deficiencies that exist in the current intra TMP design are identified in this disclosure:

In the current intra TMP, only integer-pel based template search is utilized while neglecting fractional interpolation, i.e., only integer-pel template matching block is used as the prediction block. It is known that fractional interpolation can improve the accuracy of prediction in inter-prediction, therefore the neglect of fractional interpolation makes the current intra TMP less effective.

In the current intra TMP, only one hypothesis is utilized, i.e., the best matching block which leads to the minimum matching cost is selected as the final prediction. However, single hypothesis may be vulnerable to the noise, making the prediction less accurate. Besides, it has been proved that in the inter prediction the introduction of multiple hypothesis can improve the prediction accuracy. Based on the above analysis, it is reasonable to provide examples implementing multi-hypothesis based intra TMP.

In this disclosure, methods are provided to further improve the compression efficiency of the intra TMP in the ECM. In general, the main features of the provided methods in this disclosure are summarized as follows:

To improve the prediction accuracy of intra TMP, the decoder/encoder may utilize fractional-pel template matching. The integer template matching blocks can be further refined by using fractional interpolation.

To improve the accuracy of intra TMP, examples of multi-hypothesis based intra TMP scheme are provided. In some examples, multiple template matching blocks are searched and weighted to generate the final prediction block. According to the derivation of the weighting factors, the provided multi-hypothesis intra TMP can be classified into two categories: fixed multi-hypothesis intra TMP and adaptive intra TMP.

### Fractional Intra TMP

In the current intra TMP mode, the prediction block is searched from the reconstructed region in the current frame using the L-shape template. In the template matching process, the best prediction block which leads to the minimum matching cost is identified and used as the final prediction block. In the current example of intra TMP, the template matching is based on integer pixel. To further improve the coding performance of the intra TMP mode, in this disclosure examples are provided to utilize fractional-pel template matching for intra TMP mode. The interpolation accuracy for fractional-pel template matching can be but not limited to half-pel, quarter-pel and so on.

In one or another embodiment, one index value can be signaled in the bitstream to indicate the interpolation accuracy used. The interpolation accuracy index can be signaled at PPS, SPS or slice header.

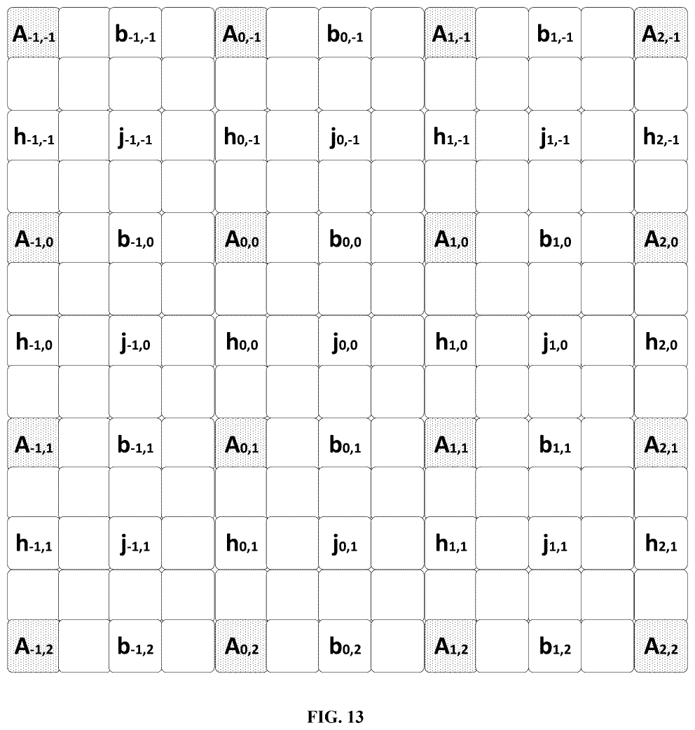

In one or another embodiment, the fractional intra TMP can be divided into two steps. In the first step, the template matching process in the current ECM is conducted to identify the optimal integer predicted template. In the second step, fractional templates surrounding the integer template are interpolated and fractional-pel template matching is conducted. FIG. 13 provides an example for half-pel template matching, in which A_{i,j} represents integer pixel and b_{i,j}, h_{i,j} and j_{i,j} represent half pixel. After the optimal integer predicted template is identified, the eight half-pel predicted templates are then interpolated. The distances between the current template and the optimal integer and the eight half-pel predicted templates are calculated and compared. The predicted template which leads to the minimum template matching cost is identified and used as the optimal predicted template. The corresponding predicted block of the optimal predicted template is used as the final prediction of the current block.

### Multi-hypothesis Intra TMP

In the current ECM, only the optimal template matched block which leads to the minimum template matching cost is used for prediction. In some examples, the optional template matched block is selected based on an ascending order of template matching cost, and a template leading to a template matching cost lower than template matching cost of other candidates is selected as the optimal template matched block/CU. To further improve the prediction accuracy of intra TMP, the multi-hypothesis prediction methods are provided in disclosure. In the multi-hypothesis intra TMP, more than one prediction block candidates are used and weighted to generate the final prediction of the current block. Assume that N prediction block candidates are used. In some examples, the block candidates are searched within a predefined search range, as the current intra TMP does.

### Prediction Block Candidate Derivation

In one and another embodiment, the prediction block candidates are searched and selected according to the criterion of minimizing template matching cost, i.e., the top N candidates with the minimum template matching cost or costs are selected. The template matching cost can be not limited to SAD (sum of absolute difference) and SSE (sum of square error).

### Fixed Multi-Hypothesis Intra TMP

In this embodiment, the weighting factors to generate the final prediction block are predefined and fixed at both the encoder and decoder side. As an example, equal weighting factors can be used, i.e., 1/N for all the candidate blocks.

### Adaptive Multi-Hypothesis Intra TMP

To adapt to the diverse characteristics of video content, examples of adaptive multi-hypothesis intra TMP methods are also provided.

### Method 1

In one and another embodiment, the weighting factors can be derived based on the template matching costs. Denote the template matching costs of the N candidates as C₁, C₂, . . . , C_{N}, the weighting factors are calculated as follow.

$${ω}_{i} = \frac{1}{N - 1} - \frac{{C}_{i}}{( N - 1 ) {\sum }_{k = 1}^{N} {C}_{k}} , i = 1 , 2 , … , N \qquad ( 11 )$$

It should be noted that the template matching cost can be measured with (but not limited to) SAD and SSE.

### Method 2

In yet another embodiment, the weighting factors can be derived at the encoder side and then signaled in the bitstream to the decoder. Denote the N prediction block candidates as P₁, P₂, . . . , P_{N} and the current block as X, then the weighting factors can be solved by the following equation:

$${\sum }_{k = 1}^{N} {ω}_{i} {P}_{i} = X \qquad ( 12 )$$

Equation (12) can be solved using Wiener-Hopf equations as ALF. The derived filter coefficients are then quantized to integer type and signaled in the block level.

### Method 3

In yet another embodiment, the weighting factors are derived based on the templates and the derived weighting factors are applied to the prediction block candidates to generate the final prediction block. Denote the templates of the prediction candidates as T₁, T₂, . . . , T_{N} and the current block as T, then the weighting factors can be derived using the following equation:

$${\sum }_{i = 1}^{N} {ω}_{i} {T}_{i} = T \qquad ( 13 )$$

Equation (13) can be solved using Wiener-Hopf equations. Then the final prediction block can be calculated as Σᵢ₌₁^{N}ωᵢPᵢ, where Pᵢ represents the i-th prediction block candidate.

### Method 4

Intra TMP mode exploits the nonlocal correlation to improve the prediction accuracy, in which similar blocks are searched and used to generate the final prediction block. In this embodiment, examples are provided to combine the nonlocal mean filtering and multi-hypothesis intra TMP, which is described as follow. In the first step, N prediction block candidates are searched and identified as conducted in the intra TMP of the ECM. In the second step, the weighting factor is calculated as follows.

$${ω}_{i} = \frac{1}{Z [ i ]} {e}^{- \frac{{D}_{i}}{{h}^{2}}} \qquad ( 14 )$$

where Dᵢ is used to measure the distance between the template of the i-th prediction block candidate and the template of the current block, h is used as the strength of weighting and Z[i] is the normalization constant:

$$Z [ i ] = {\sum }_{i = 1}^{N} {e}^{- \frac{{D}_{i}}{{h}^{2}}} \qquad ( 15 )$$

To calculate the weighting factor in equation (14), the strength of weighting or weighting strength should be determined first. In this disclosure, several methods are provided to decide the weighting strength.

In the first method, a weighting strength candidate list consisting of some typical weighting strength values is defined and fixed at both encoder and decoder side. At the encoder side, the weighting strength values are checked using rate distortion optimization and the optimal weighting strength value is identified and signaled in the bitstream to the decoder side.

In the second method, the weighting strength value is estimated using the template of the prediction block candidates and the template of the current block. Denote the templates of the prediction candidates as T₁, T₂, . . . , T_{N} and the current block as T. Then the weighting strength value can be solved using the following equation:

$${\sum }_{i = 1}^{N} {ω}_{i} {T}_{i} = {\sum }_{i = 1}^{N} \frac{1}{Z [ i ]} {e}^{- \frac{{D}_{i}}{{h}^{2}}} {T}_{i} = T \qquad ( 16 )$$

In the third method, the weighting strength value can be estimated using the QP value and variance of the template of the current block, i.e., the relationship between the weighting strength value, QP value and the template variance can be fitted offline.

### Method 5

To better exploit the nonlocal correlation in the intra TMP, in this embodiment singular value decomposition (SVD) is utilized to generate the final prediction block from the prediction block candidates. The width and height of the current block are denoted as W and H, the area of the current block is denoted as d=H×W.

Step1. K prediction block candidates yᵢ are searched and identified as conducted in the intra TMP of the ECM.

Step2. The K prediction block candidates of the current block y construct the block group G and are arranged as a matrix:

$${y}_{G} = [ {y}_{G}^{( 1 )} , {y}_{G}^{( 2 )} , … , {y}_{G}^{( K )} ] \qquad ( 17 )$$

where Y_{G} is a matrix with size of d×K by arranging every candidate in group G as a column vector.

Step3. Perform SVD decomposition on the matrix Y_{G}.

$$SVD ( {Y}_{G} ) = {U}_{G} {Λ}_{G} {V}_{G}^{*} \qquad ( 18 )$$

Step4. Apply soft-thresholding operation on the singular value matrix Λ_{G}.

$${Λ}_{{G}_{i} , τ} = softTh ( {Λ}_{G} , τ ) \qquad ( 19 )$$

where softTh( ) is a function which shrinks the diagonal elements of Λ_{G} with the threshold τ. For the k-th diagonal element in Λ_{G}, it is shrunken by the nonlinear function D_{τ(k)} at level τ(k):

$${D}_{τ ( k )} : {λ}_{k , τ ( k )} = max ( \vert {λ}_{k} \vert - τ ( k ) , 0 ) \qquad ( 20 )$$

Λ_{G,τ} is the matrix composed of the shrunken singular values, λ_{k,τ(k)} at diagonal positions.

Step5. Perform inverse SVD to obtain the filtered patch group.

$${\hat{X}}_{G} = {U}_{G} {Λ}_{G , τ} {V}_{G}^{*} \qquad ( 21 )$$

One of the key steps is to determine the thresholding values for each diagonal elements in Step 4. In this disclosure, the thresholding values are calculated as follows. The threshold is estimated for each group of image patches with the following equation:

$${τ}_{G} ( k ) = c \times \frac{{σ}_{n , G}^{2}}{{σ}_{x , G , k}} \qquad ( 22 )$$

where λ_{n,G} is the standard deviation of noise, and σ_{x,G,k} is the standard deviation of the original block in the k-th dimension of SVD space for group G. The deviation of the original block in SVD space is estimated as follow.

$${σ}_{x , G , k} = \sqrt{max ( \frac{{λ}_{G , k}^{2}}{min ( d , K )} - ω \times {σ}_{n , G}^{2} , 0 )} \qquad ( 23 )$$

where λ_{G,k}² is the k-th singular value of Y_{G}_{ᵢ}. When σ_{x,G,k} is zero, the soft-thresholding operation is skipped. In addition, the deviation of noise is estimated with the deviation of the predicted block using a power function which is parameterized with α and β.

$${σ}_{n} = α \times {σ}_{y}^{β} \qquad ( 24 )$$

where σ_{y} is calculated as follows,

$${σ}_{y} = \frac{1}{K} {\sum }_{k = 0}^{K} \sqrt[2]{{\sum }_{i = 1}^{{p}^{2}} \frac{{( {y}_{k} ( i ) - {μ}_{k} )}^{2}}{{p}^{2}}} , {μ}_{k} = \frac{1}{{p}^{2}} {\sum }_{i = 1}^{{p}^{2}} {y}_{k} ( i ) \qquad ( 25 )$$

Here γₖ (i) represents the i-th pixel of prediction block candidate vector γₖ.

### Multi-Hypothesis Intra TMP Signaling

In this disclosure, the provided multi-hypothesis intra TMP can be utilized as a replacement of the current intra TMP mode or the encoder can adaptively select intra TMP mode or multi-hypothesis intra TMP mode.

In one and another embodiment, the provided multi-hypothesis intra TMP is used as a replacement of the current intra TMP mode, i.e., always using multiple hypothesis for prediction.

In yet another embodiment, one of the multi-hypothesis intra TMP methods in the above sections is used jointly with the current intra TMP mode in the ECM. A flag is signaled in the bitstream to indicate whether multi-hypothesis intra TMP mode is applied to the CU.

In yet another embodiment, more than one multi-hypothesis intra TMP methods in the above sections is used jointly with the current intra TMP mode in the ECM. A flag is firstly signaled in the bitstream to indicate whether multi-hypothesis intra TMP mode is applied. Then an index is signaled to indicate which of the multi-hypothesis intra TMP methods is applied to the CU.

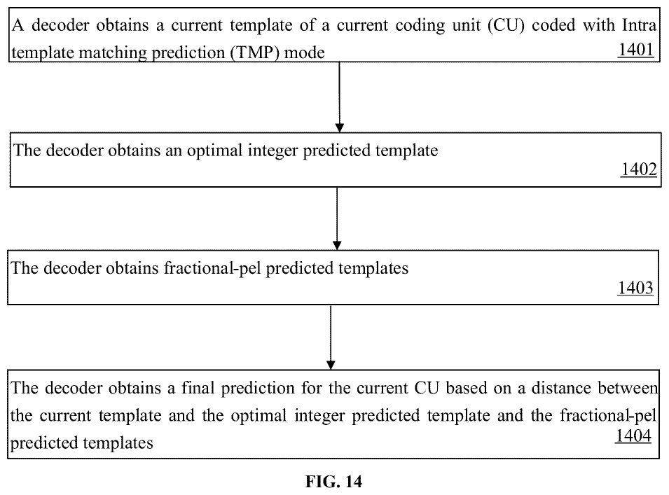

FIG. 14 is a flowchart illustrating a method for video decoding according to an example of the present disclosure.

In Step 1401, the processor 1620, at the side of a decoder, may obtain a current template of a current coding unit (CU) coded with Intra template matching prediction (TMP) mode. Intra TMP is a special intra prediction mode that copies a best prediction block from a reconstructed part of a current frame, whose L-shaped template matches the current template.

In Step 1402, the processor 1620 may obtain an optimal integer predicted template. In some examples, the processor 1620 may obtain the optimal integer predicted template by conducting a template matching process in a current ECM.

In Step 1403, the processor 1620 may obtain fractional-pel predicted templates.

In Step 1404, the processor 1620 may obtain a final prediction for the current CU based on a distance between the current template and the optimal integer predicted template and the fractional-pel predicted templates.

In some examples, the fractional-pel predicted templates may include half-pel templates and/or quarter-pel templates. For instance, the fractional-pel predicted templates may include half-pel templates, quarter-pel templates, or both half-pel templates and quarter-pel templates. In some examples, the processor 1620 may use a fractional value between 0 and 1 for the fractional-pel predicted templates, where the fractional value is other than ½ or ¼.

In some examples, the processor 1620 may obtain an index value signaled in a bitstream, where the index value indicates an interpolation accuracy. In some examples, the processor 1620 may further obtain the fractional-pel predicted templates based on the interpolation accuracy. In some examples, the index value may be signaled at a particular level comprising Picture Parameter Set (PPS), Sequence Parameter Set (SPS), or slice header.

In some examples, the processor 1620 may interpolate fractional templates surrounding the optimal integer predicted template in Step 1403, and may conduct fractional-pel template matching in Step 1404. In some examples, the processor 1620 may interpolate eight half-pel predicted templates. In some examples, the processor 1620 may conduct the fractional template matching as illustrated in FIG. 13, where A_{i,j} represents integer pixel and b_{i,j}, h_{i,j} and j_{i,j} represent half pixel.

In some examples, to conduct the fractional-pel template matching in Step 1404, the processor 1620 may compute a first distance between a current template and the optimal integer predicted template, compute several second distances between the current template and the fractional-pel predicted templates, compare the first distance and the several second distances, identify an optimal predicted template leading to a minimum template matching cost, and a predicted CU corresponding to the optimal predicted template, and set the predicted CU as the final prediction.

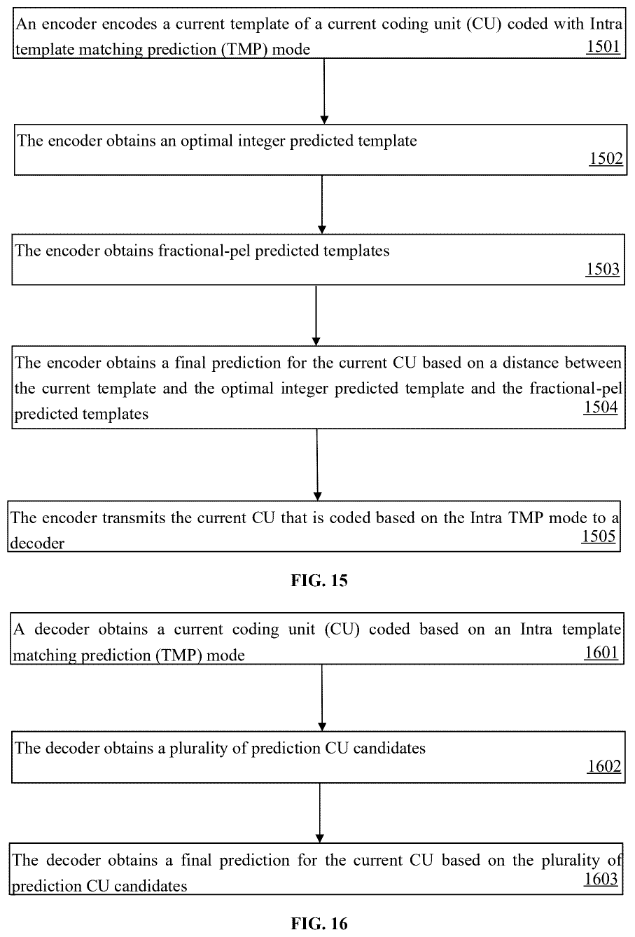

FIG. 15 is a flowchart illustrating a method for video encoding corresponding the method for video decoding as shown in FIG. 14.

In Step 1501, the processor 1620, at the side of an encoder, may encode a current template of a current coding unit (CU) coded with Intra template matching prediction (TMP) mode. In some examples, the processor 1620 may encode a current template of a current coding unit (CU) based on Intra TMP mode. Intra TMP is a special intra prediction mode that copies a best prediction block from a reconstructed part of a current frame, whose L-shaped template matches the current template.

In Step 1502, the processor 1620 may obtain an optimal integer predicted template. In some examples, the processor 1620 may obtain the optimal integer predicted template by conducting a template matching process in a current ECM.

In Step 1503, the processor 1620 may obtain fractional-pel predicted templates.

In Step 1504, the processor 1620 may obtain a final prediction for the current CU based on a distance between the current template and the optimal integer predicted template and the fractional-pel predicted templates.

In Step 1505, the processor 1620 may transmit the current CU that is coded based on the Intra TMP mode to a decoder.

In some examples, the fractional-pel predicted templates may include half-pel templates and/or quarter-pel templates. For instance, the fractional-pel predicted templates may include half-pel templates, quarter-pel templates, or both half-pel templates and quarter-pel templates. In some examples, the processor 1620 may use a fractional value between 0 and 1 for the fractional-pel predicted templates, where the fractional value is other than ½ or ¼.

In some examples, the processor 1620 may signal an index value in a bitstream, where the index value indicates an interpolation accuracy. In some examples, the processor 1620 may further obtain the fractional-pel predicted templates based on the interpolation accuracy. In some examples, the index value may be signaled at a particular level comprising Picture Parameter Set (PPS), Sequence Parameter Set (SPS), or slice header.

In some examples, the processor 1620 may interpolate fractional templates surrounding the optimal integer predicted template in Step 1503, and may conduct fractional-pel template matching in Step 1504. In some examples, the processor 1620 may interpolate eight half-pel predicted templates. In some examples, the processor 1620 may conduct the fractional template matching as illustrated in FIG. 13, where A_{i,j} represents integer pixel and b_{i,j}, h_{i,j} and j_{i,j} represent half pixel.

In some examples, to conduct the fractional-pel template matching in Step 1504, the processor 1620 may compute a first distance between a current template and the optimal integer predicted template, compute several second distances between the current template and the fractional-pel predicted templates, compare the first distance and the several second distances, identify an optimal predicted template leading to a minimum template matching cost, and a predicted CU corresponding to the optimal predicted template, and set the predicted CU as the final prediction.

FIG. 16 is a flowchart illustrating a method for video decoding according to an example of the present disclosure.

In Step 1601, the processor 1620, at the side of a decoder, may obtain a current coding unit (CU) coded with Intra template matching prediction (TMP) mode. Intra TMP is a special intra prediction mode that copies a best prediction block from a reconstructed part of a current frame, whose L-shaped template matches a current template.

In Step 1602, the processor 1620 may obtain a plurality of prediction CU candidates. In some examples, performing Step 1602 may improve prediction accuracy of the intra TMP.

In Step 1603, the processor 1620 may obtain a final prediction for the current CU based on the plurality of prediction CU candidates.

In some examples, in Step 1602, the processor 1620 may search for a plurality of CU candidates with template matching cost lower than template matching cost of other candidates, and then select the plurality of CU candidates as the plurality of prediction CU candidates. In some examples, the template matching costs may be measured with one of sum of absolute difference (SAD) or sum of square error (SSE).

In some examples, in Step 1603, the processor 1620 may obtain a plurality of weights corresponding to the plurality of prediction CU candidates, and obtain the final prediction for the current CU based on the plurality of prediction CU candidates and the plurality of weights. In some examples, the processor 1620 may obtain the plurality of weights based on fixed multi-hypothesis intra TMP. In some examples, the processor 1620 may obtain the plurality of weights based on adaptive multi-hypothesis intra TMP.

In some examples, in Step 1603, the processor 1620 may set each of the plurality of weights to be a reciprocal of an integer N, where N is a number of the plurality of prediction CU candidates. In the examples described in this paragraph, the processor 1620 obtains the plurality of weights based on the fixed multi-hypothesis intra TMP.

In some examples, in Step 1603, the processor 1620 may compute the plurality of weights based on a plurality of template matching costs. In some examples, the processor 1620 may obtain a plurality of prediction CU template matching costs of the plurality of prediction CU candidates, and obtain the plurality of weights based on the plurality of prediction CU template matching costs. In some examples, the plurality of template matching costs may be measured with one of sum of absolute difference (SAD) or sum of square error (SSE). In the examples described in this paragraph, the processor 1620 obtains the plurality of weights based on the adaptive multi-hypothesis intra TMP.

In some examples, in Step 1603, the processor 1620 may receive the plurality of weights signaled in a bitstream by an encoder. In the examples described in this paragraph, the processor 1620 obtains the plurality of weights based on the adaptive multi-hypothesis intra TMP.

In some examples, in Step 1603, the processor 1620 may obtain the plurality of weights based on a plurality of templates. In some examples, the processor 1620 may obtain a plurality of prediction CU templates of the plurality of prediction CU candidates, obtain a current CU template of the current CU, and obtain the plurality of weights based on the plurality of prediction CU templates and the current CU template. In some examples, the processor 1620 may obtain the plurality of weights based on the plurality of prediction CU templates and the current CU template by solving Wiener-Hopf equations. In the examples described in this paragraph, the processor 1620 obtains the plurality of weights based on the adaptive multi-hypothesis intra TMP.

In some examples, in Step 1603, the processor 1620 may obtain the plurality of weights using nonlocal mean filtering. In some examples, to obtain the plurality of weights using the nonlocal mean filtering, the processor 1620 may obtain a plurality of distances based on the plurality of prediction CU candidates and the current CU, and obtain the plurality of weights based on the plurality of distances and a degree of weighting. In some examples, the processor 1620 may further determine a weighting strength or strength of weighting. In the examples described in this paragraph, the processor 1620 obtains the plurality of weights based on the adaptive multi-hypothesis intra TMP.

In some examples, to determine the strength of weighting, the processor 1620 may define and fix a weighting strength candidate list comprising a plurality of typical weighting strength values, and select a typical weight strength value as an optimal weighting strength value based on a flag signaled in a bitstream. Alternatively or additionally, the processor 1620 may receive an optimal weighting strength value identified by an encoder and signaled in a bitstream.

In some examples, to determine the strength of weighting, the processor 1620 may obtain a plurality of prediction CU templates of the plurality of prediction CU candidates, obtain a current CU template of the current CU, and estimate the strength of weighting based on the plurality of prediction CU templates and the current CU template.

In some examples, to determine the strength of weighting, the processor 1620 may estimate the strength of weighting using a Quantization Parameter (QP) value and a variance of a current CU template of the current CU. In some examples, the processor 1620 may further fit a relationship between the strength of weighting, the QP value, and the variance of the current CU template offline.

In some examples, in Step 1603, the processor 1620 may perform singular value decomposition (SVD) on a matrix generated from the plurality of prediction CU candidates, and obtain the final prediction based on results of performing the SVD.

In some examples, to perform the SVD, the processor 1620 may obtain a block group matrix based on the plurality of prediction CU candidates, perform the SVD on the block group matrix, obtain a first decomposition result matrix, a second decomposition result matrix, and a third decomposition result matrix, obtain a fourth decomposition result matrix from the second decomposition result matrix, perform an inverse SVD on the first decomposition result matrix, the fourth decomposition result matrix, and the third decomposition result matrix, and obtain a filtered patch group. Additionally, in these examples, the processor 1620 may obtain the final prediction for the current CU based on the filtered patch group in Step 1603.

In some examples, to perform the SVD, the processor 1620 may apply soft-thresholding operation on the second decomposition result matrix. In some examples, the processor 1620 may further determine a plurality of thresholding values corresponding to diagonal elements of the second decomposition result matrix.

In some examples, the processor 1620 may receive a flag signaled in a bitstream, where the flag indicates that multi-hypothesis intra TMP mode is applied to the current CU. In some examples, the processor 1620 may further receive an index signaled in the bitstream, where the index indicates a multi-hypothesis intra TMP method applied to the current CU.

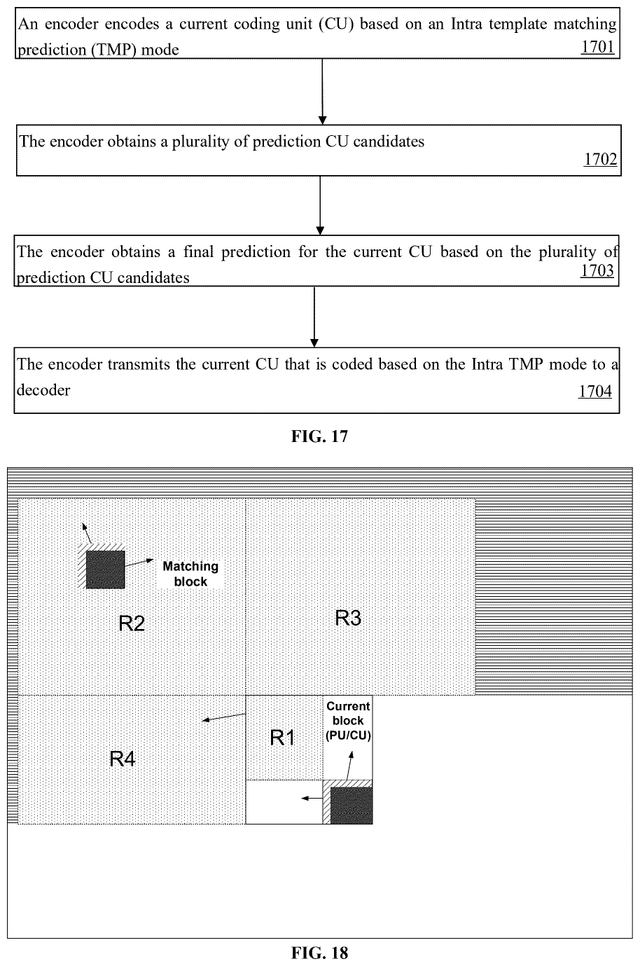

FIG. 17 is a flowchart illustrating a method for video encoding corresponding the method for video decoding as shown in FIG. 16.

In Step 1701, the processor 1620, at the side of an encoder, may encode a current coding unit (CU) based on an Intra template matching prediction (TMP) mode. Intra TMP is a special intra prediction mode that copies a best prediction block from a reconstructed part of a current frame, whose L-shaped template matches a current template.

In Step 1702, the processor 1620 may obtain a plurality of prediction CU candidates. In some examples, performing Step 1702 may improve prediction accuracy of the intra TMP.

In Step 1703, the processor 1620 may obtain a final prediction for the current CU based on the plurality of prediction CU candidates.

In Step 1704, the processor 1620 may transmit the current CU that is coded based on the Intra TMP mode to a decoder.

In some examples, in Step 1702, the processor 1620 may search for a plurality of CU candidates with template matching cost lower than template matching cost of other candidates, and then select the plurality of CU candidates as the plurality of prediction CU candidates. In some examples, the template matching costs may be measured with one of sum of absolute difference (SAD) or sum of square error (SSE).

In some examples, in Step 1703, the processor 1620 may obtain a plurality of weights corresponding to the plurality of prediction CU candidates, and obtain the final prediction for the current CU based on the plurality of prediction CU candidates and the plurality of weights. In some examples, the processor 1620 may obtain the plurality of weights based on fixed multi-hypothesis intra TMP. In some examples, the processor 1620 may obtain the plurality of weights based on adaptive multi-hypothesis intra TMP.

In some examples, in Step 1703, the processor 1620 may set each of the plurality of weights to be a reciprocal of an integer N, where N is a number of the plurality of prediction CU candidates. In these examples, the processor 1620 obtains the plurality of weights based on the fixed multi-hypothesis intra TMP.

In some examples, in Step 1703, the processor 1620 may compute the plurality of weights based on a plurality of template matching costs. In some examples, the processor 1620 may obtain a plurality of prediction CU template matching costs of the plurality of prediction CU candidates, and obtain the plurality of weights based on the plurality of prediction CU template matching costs. In some examples, the plurality of template matching costs may be measured with one of sum of absolute difference (SAD) or sum of square error (SSE). In the examples described in this paragraph, the processor 1620 obtains the plurality of weights based on the adaptive multi-hypothesis intra TMP.

In some examples, in Step 1703, the processor 1620 may obtain the plurality of weights based on the plurality of prediction CU candidates and the current CU, and may signal, in a bitstream, the plurality of weights. In the examples described in this paragraph, the processor 1620 obtains the plurality of weights based on the adaptive multi-hypothesis intra TMP.

In some examples, in Step 1703, the processor 1620 may obtain the plurality of weights based on a plurality of templates. In some examples, the processor 1620 may obtain a plurality of prediction CU templates of the plurality of prediction CU candidates, obtain a current CU template of the current CU, and obtain the plurality of weights based on the plurality of prediction CU templates and the current CU template. In some examples, the processor 1620 may obtain the plurality of weights based on the plurality of prediction CU templates and the current CU template by solving Wiener-Hopf equations. In the examples described in this paragraph, the processor 1620 obtains the plurality of weights based on the adaptive multi-hypothesis intra TMP.

In some examples, in Step 1703, the processor 1620 may obtain the plurality of weights using nonlocal mean filtering. In some examples, to obtain the plurality of weights using nonlocal mean filtering, the processor 1620 may obtain a plurality of distances based on the plurality of prediction CU candidates and the current CU, and obtain the plurality of weights based on the plurality of distances and a degree of weighting. In some examples, the processor 1620 may further determine a weighting strength or strength of weighting. In the examples described in this paragraph, the processor 1620 obtains the plurality of weights based on the adaptive multi-hypothesis intra TMP.

In some examples, to determine the strength of weighting, the processor 1620 may define and fix a weighting strength candidate list comprising a plurality of typical weighting strength values, check the plurality of typical weighting strength values using rate distortion optimization, identify an optimal weighting strength value, and signal, in a bitstream, the optimal weighting strength value.

In some examples, to determine the strength of weighting, the processor 1620 may obtain a plurality of prediction CU templates of the plurality of prediction CU candidates, obtain a current CU template of the current CU, and estimate the strength of weighting based on the plurality of prediction CU templates and the current CU template.

In some examples, to determine the strength of weighting, the processor 1620 may estimate the strength of weighting using a Quantization Parameter (QP) value and a variance of a current CU template of the current CU. In some examples, the processor 1620 may further fit a relationship between the strength of weighting, the QP value, and the variance of the current CU template offline.

In some examples, in Step 1703, the processor 1620 may perform singular value decomposition (SVD) on a matrix generated from the plurality of prediction CU candidates, and obtain the final prediction based on results of performing the SVD.

In some examples, to perform the SVD, the processor 1620 may obtain a block group matrix based on the plurality of prediction CU candidates, perform the SVD on the block group matrix, obtain a first decomposition result matrix, a second decomposition result matrix, and a third decomposition result matrix, obtain a fourth decomposition result matrix from the second decomposition result matrix, perform an inverse SVD on the first decomposition result matrix, the fourth decomposition result matrix, and the third decomposition result matrix, and obtain a filtered patch group. Additionally, in these examples, the processor 1620 may obtain the final prediction for the current CU based on the filtered patch group in Step 1703.

In some examples, to perform the SVD, the processor 1620 may apply soft-thresholding operation on the second decomposition result matrix. In some examples, the processor 1620 may further determine a plurality of thresholding values corresponding to diagonal elements of the second decomposition result matrix.

In some examples, the processor 1620 may receive a flag signaled in a bitstream, where the flag indicates that multi-hypothesis intra TMP mode is applied to the current CU. In some examples, the processor 1620 may further receive an index signaled in the bitstream, where the index indicates a multi-hypothesis intra TMP method applied to the current CU.

In the ECM, intra template matching prediction (intra TMP) is utilized to improve the compression efficiency of intra coding. In the following, intra TMP technique and its improvement methods are provided.

### Intra Template Matching Prediction

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

The prediction signal is generated by matching the L-shaped causal neighbor of the current block with another block in a predefined search area in FIG. 18 consisting of:
R1: current CTU
R2: top-left CTU
R3: above CTU
R4: left CTU

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

SearchRange_w=a*BlkW

SearchRange_h=a*BlkH

where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### Intra TMP Derived Block Vector Candidates for IBC

In this method, block vector (BV) derived from the intra template matching prediction (IntraTMP) is used for intra block copy (IBC). The stored IntraTMP BV of the neighbouring blocks along with IBC BV are used as spatial BV candidates in IBC candidate list construction.

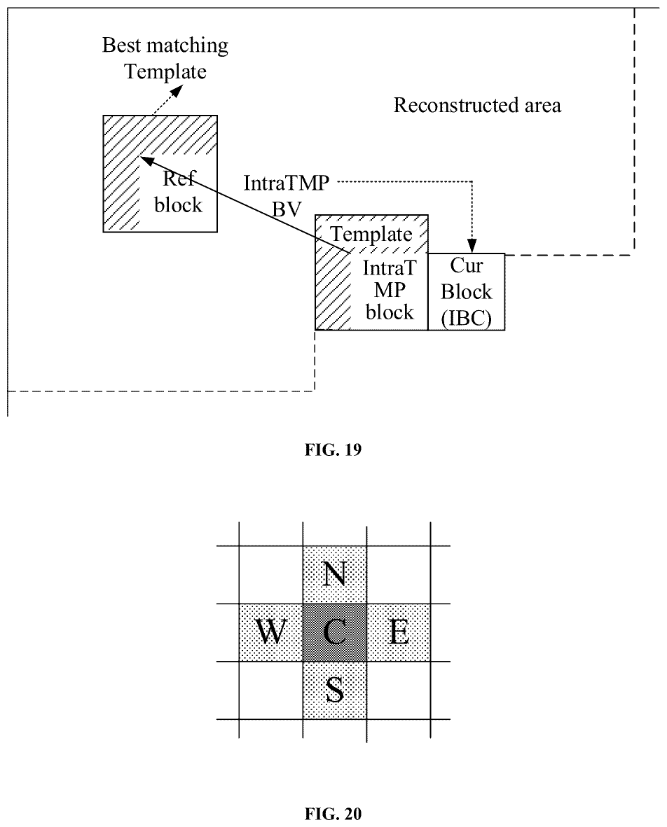

IntraTMP block vector is stored in the IBC block vector buffer and, the current IBC block can use both IBC BV and IntraTMP BV of neighbouring blocks as BV candidate for IBC BV candidate list as shown in FIG. 19.

Intra TMP with Linear Filter Model

In JVET-AC0109, it is proposed to apply a linear filter model for the prediction of Intra TMP (Intra TMP-FLM). The proposed 6-tap filter consist of a 5-tap plus sign shape spatial component and a bias term. The input to the spatial 5-tap component of the filter consists of a center (C) sample in the reference block which is at corresponding locations with the sample in the current block to be predicted and its above/north (N), below/south (S), left/west (W) and right/east (E) neighbors as illustrated in FIG. 20.

The bias term B represents a scalar offset between the input and output and is set to middle luma value (512 for 10-bit content).

Output of the filter is calculated as follows:

$$predLumaVal = c 0 C + c 1 N + c 2 S + c 3 E + c 4 W + c 5 B$$

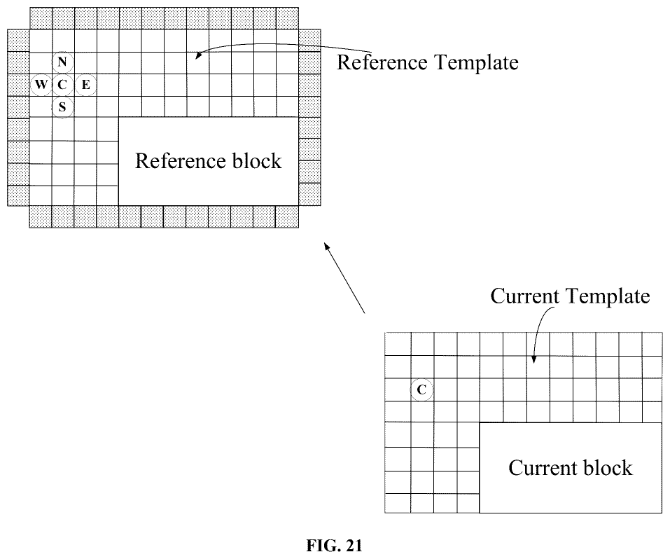

The filter coefficients ci are calculated by minimising the MSE between the reference template and current template, as shown in FIG. 21. The extensions to the area shown in dotted area needed to support the “side samples” of the plus shaped spatial filter and are padded when in unavailable areas.

The MSE minimization is performed by calculating autocorrelation matrix for the reference template input and current template output. Autocorrelation matrix is LDL decomposed and the final filter coefficients are calculated using back-substitution.

Usage of the Intra TMP-FLM mode is signalled coded CU level flag. Specifically, Intra TMP-FLM is considered a sub-mode of Intra TMP. That is, Intra TMP-FLM flag is only signalled if Intra TMP flag is true.

Combination of intra and intra TMP

In the JVET-AC meeting, several methods are proposed to fuse the prediction of intra mode and intra TMP mode. For example, in the JVET-AC0097, it is proposed to combine intra prediction and intra TMP with the geometric partitioning. In the JVET-AC0201, the spatial CIIP mode is proposed, in which the intra prediction and intra TMP can be fused in the way of CIIP.

### CCLM Prediction

To reduce the cross-component redundancy, a CCLM prediction mode is used in VVC, where chroma samples of a CU are predicted based on reconstructed luma samples rec_{L}(i,j) of the CU by using a linear model as follows:

$${pred}_{C} ( i , j ) = α \cdot {rec}_{L}^{′} ( i , j ) + β \qquad ( 1 )$$

where pred_{C}(i,j) represents predicted chroma samples in the CU, rec_{L}′(i,j) represents down-sampled reconstructed luma samples of the CU which are obtained by performing down-sampling on the reconstructed luma samples rec_{L}(i,j), and α and β are linear model parameters which are derived from at most four neighbouring chroma samples and their corresponding down-sampled luma samples. Suppose that a current chroma block has a size of W×H, then W′ and H′ are obtained as follows:

$${W}^{′} = W , {H}^{′} = H when an LM mode is applied ;$$

$${W}^{′} = W + H when an LM\_A mode is applied ;$$

$${H}^{′} = H + W when an LM\_L mode is applied .$$

where in the LM mode, above samples and left samples of the CU are used together to calculate the linear model coefficients; in the LM_A mode, only the above samples of the CU are used to calculate the linear model coefficients; and in the LM_L mode, only the left samples of the CU are used to calculate the linear model coefficients.

If locations of above samples of a chroma block are denoted as S[0, −1] . . . S[W′−1, −1] and locations of left samples of the chroma block are denoted as S[−1, 0] . . . S[−1, H′−1], positions of four neighbouring chroma samples are selected as follows:
S[W′/4, −1], S[3*W′/4, −1], S[−1, H′/4] and S[−1, 3*H′/4] are selected as the positions of the four neighbouring chroma samples when the LM mode is applied and both of the above and left samples are available;
S[W′/8, −1], S[3*W′/8, −1], S[5*W′/8, −1] and S[7*W′/8, −1] are selected as the positions of the four neighbouring chroma samples when the LM_A mode is applied and the above samples are available or when only the above samples are available;
S[−1, H′/8], S[−1, 3*H′/8], S[−1, 5*H′/8] and S[−1, 7*H′/8] are selected as the positions of the four neighbouring chroma samples when the LM_L mode is applied and the left samples are available or when only the left samples are available.

Four neighbouring luma samples corresponding to the selected locations are obtained by a down-sampling operation and the obtained four neighbouring luma samples are compared four times to find two larger values: x⁰_{A} and x¹_{A} and two smaller values: x⁰_{B} and x¹_{B}. Chroma sample values corresponding to the two larger values and the two smaller values are denoted as y⁰_{A}, y¹_{A}, y⁰_{B} and y¹_{B} respectively. Then Xₐ, X_{b}, Yₐ and Y_{b} are derived as:

$${X}_{a} = ( {x}_{A}^{0} + {x}_{A}^{1} + 1 ) >> 1 ; \qquad ( 2 )$$

$${X}_{b} = ( {x}_{B}^{0} + {x}_{B}^{1} + 1 ) >> 1 ;$$

$${Y}_{a} = ( {y}_{A}^{0} + {y}_{A}^{1} + 1 ) >> 1 ;$$

$${Y}_{b} = ( {y}_{B}^{0} + {y}_{B}^{1} + 1 ) >> 1.$$

Finally, the linear model parameters α and β are obtained according to the following equations.

$$α = \frac{{Y}_{a} - {Y}_{b}}{{X}_{a} - {X}_{b}} \qquad ( 3 )$$

$$β = {Y}_{b} - α \cdot {X}_{b}$$

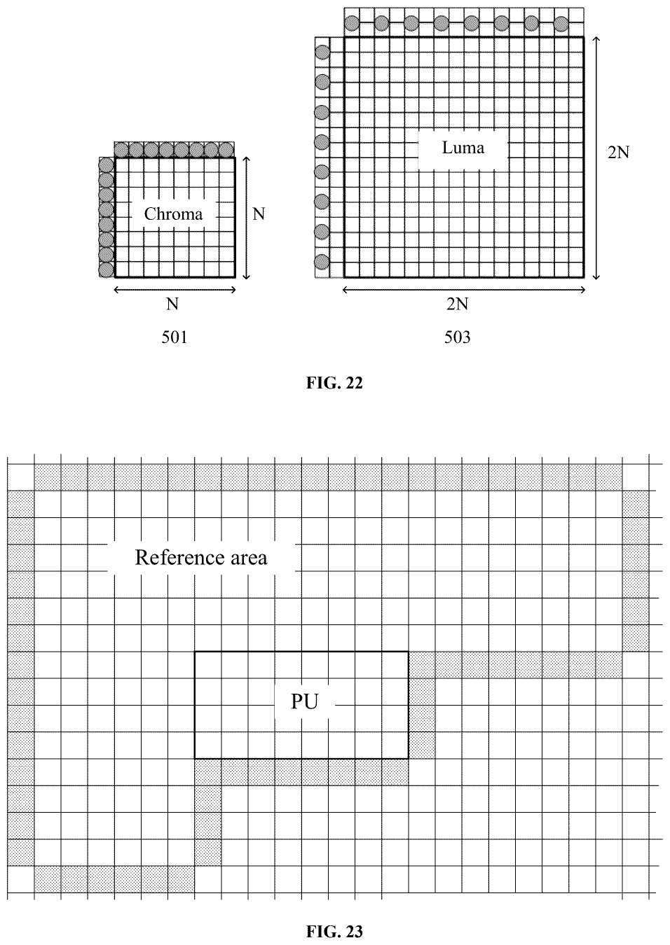

FIG. 22 shows a diagram of locations of left and above samples of the CU involved in the CCLM mode, including locations of left and above samples of an N×N chroma block 501 in the CU and locations of left and above samples of an 2N×2N luma block 503 in the CU.

The parameter computation described above is performed as part of the decoding process, and therefore no syntax element is used to convey values of α and β from the video encoder 20 to the video decoder 30.

### Convolutional Cross-Component Intra Prediction Model

In this method, convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### Convolutional Filter

The convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south (S), left/west (W) and right/east (E) neighbors as illustrated in FIG. 20.

The nonlinear term P is represented as power of two of the center luma sample C and scaled to the sample value range of the content:

$$P = ( C * C + midVal ) >> bitDepth$$

That is, for 10-bit content it is calculated as:

$$P = ( C * C + 512 ) >> 10$$

The bias term B represents a scalar offset between the input and output (similarly to the offset term in CCLM) and is set to middle chroma value (512 for 10-bit content).

Output of the filter is calculated as a convolution between the filter coefficients ci and the input values and clipped to the range of valid chroma samples:

$$predChromaVal = c 0 C + c 1 N + c 2 S + c 3 E + c 4 W + c 5 P + c 6 B$$

### Calculation of Filter Coefficients

The filter coefficients ci are calculated by minimising MSE between predicted and reconstructed chroma samples in the reference area. FIG. 23 illustrates the reference area which consists of 6 lines of chroma samples above and left of the PU. Reference area extends one PU width to the right and one PU height below the PU boundaries. Area is adjusted to include only available samples. The extensions to the area shown in dotted are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

The autocorrelation matrix is calculated using the reconstructed values of luma and chroma samples. These samples are full range (e.g. between 0 and 1023 for 10-bit content) resulting in relatively large values in the autocorrelation matrix. This requires high bit depth operation during the model parameters calculation. It is proposed to remove fixed offsets from luma and chroma samples in each PU for each model. This is driving down the magnitudes of the values used in the model creation and allows reducing the precision needed for the fixed-point arithmetic. As a result, 16-bit decimal precision is proposed to be used instead of the 22-bit precision of the original CCCM implementation.

Reference sample values just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:
C′=C—offsetLuma
N′=N—offsetLuma
S′=S—offsetLuma
E′=E—offsetLuma
W′=W—offsetLuma
P′=nonLinear(C′)
B=midValue=1 (bitDepth−1)
   and the chroma value is predicted using the following equation, where offsetChroma is equal to offsetCr and offsetCb for Cr and Cb components, respectively:

predChromaVal=c0C′+c1N′+c2S′+c3E′+c4W′+c5P′+c6B+offsetChroma

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation the chroma offset is added to the bias term of the convolutional model.

The process of CCCM model parameter calculation requires division operations. Division operations are not always considered implementation friendly. The division operation is replaced with multiplication (with a scale factor) and shift operation, where scale factor and number of shifts are calculated based on denominator similar to the method used in calculation of CCLM parameters.

### Gradient Linear Model

For YUV 4:2:0 color format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β$$

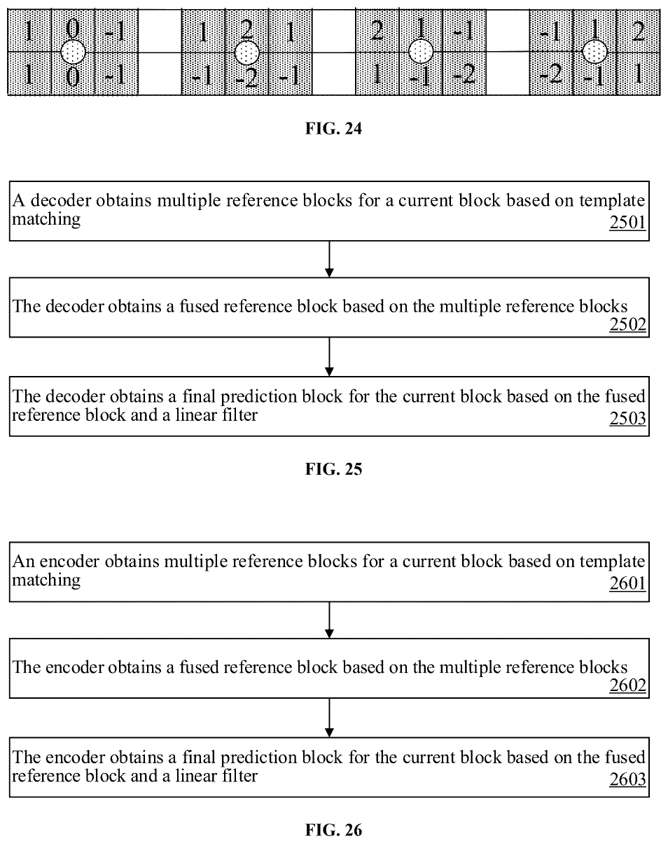

For signaling, when the CCLM mode is enabled to the current CU, one flag is signaled to indicate whether GLM is enabled for both Cb and Cr components; if the GLM is enabled, another flag is signaled to indicate which of the two GLM modes is selected and one syntax element is further signaled to select one of 4 gradient filters for the gradient calculation. The four gradient filters for the GLM are illustrated in FIG. 24.

### Bitstream Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA.

Although the existing intra TMP scheme can provide significant improvement of intra coding in the ECM, its design can still be further improved. For example, the following deficiencies that exist in the current intra TMP design are identified in this disclosure.

First, in the current intra TMP, only integer-pel based template search is utilized while neglecting fractional interpolation, i.e., only integer-pel template matching block is used as the prediction block. It is known that fractional interpolation can improve the accuracy of prediction in inter-prediction, therefore the neglect of fractional interpolation makes the current intra TMP less effective.

Second, in the current intra TMP, only one hypothesis is utilized, i.e., the best matching block which leads to the minimum matching cost is selected as the final prediction. However, single hypothesis may be vulnerable to the noise, making the prediction less accurate. Besides, it has been proved that in the inter prediction the introduction of multiple hypothesis can improve the prediction accuracy. Based on the above analysis, it is reasonable to propose multi-hypothesis based intra TMP.

Third, in the JVET-AC0109, the intra TMP block is further filtered using the linear filter model. More specifically, the intra TMP block is the reference block with the minimum template matching cost in the search range. However, as revealed above, the intra TMP with single hypothesis may be not effective enough. Therefore, it is proposed to combine multi-hypothesis and linear filter model.

Fourth, in the current ECM, intra TMP is only enabled for luma component without considering the chroma components. Therefore, it is proposed to enable intra TMP for chroma components.

Fifth, in the current methods of combining intra and intra TMP, the fused prediction is directly used as the final prediction without further refinement.

Sixth, in the current intra TMP, prediction is conducted based on the prediction block, of which the granularity may be too coarse, making it less effective.

In this disclosure, methods are proposed to further improve the compression efficiency of the intra TMP in the ECM. In general, the main features of the proposed methods in this disclosure are summarized as follows.

First, to improve the prediction accuracy of intra TMP, it is proposed to utilized fractional-pel template matching. The integer template matching blocks can be further refined by using fractional interpolation.

Second, to improve the accuracy of intra TMP, multi-hypothesis based intra TMP scheme is proposed. In the proposed scheme, multiple template matching blocks are searched and weighted to generate the final prediction block. According to the derivation of the weighting factors, the proposed multi-hypothesis intra TMP can be classified into two categories: fixed multi-hypothesis intra TMP and adaptive intra TMP.

Third, to further improve the prediction accuracy of intra TMP with linear filter model, multi-hypothesis is introduced where intra TMP is conducted with multiple hypothesis followed by the linear filter model.

Fourth, to further improve the prediction of chroma components, it is proposed to enable intra TMP for chroma components.

Fifth, to exploit the cross-component correlation between luma and chroma components, it is proposed to combine cross-component prediction and intra TMP for chroma components.

Sixth, to further improve the prediction of combining intra and intra TMP, the linear filter model is utilized to refine the fused prediction.

Seventh, to improve the granularity of prediction, the subblock-based intra TMP is provided.

Multi-Hypothesis Intra TMP with Linear Filter Model

The current intra TMP with linear filter model can be divided into two steps. In the first step, the reference block is firstly obtained with template matching. In the second step, the reference block is filtered with a linear filter to generate the final prediction block, where the filter coefficients are derived using the template. In the current method, only one reference block is utilized, i.e., only one hypothesis, which is less effective.

To improve the prediction quality of intra TMP with linear filter model, multi-hypothesis is introduced in the first step. Instead of only one reference block, multiple reference blocks are obtained and these reference blocks are utilized to generate a fused block. It should be noted that the methods of generating the fused block is not limited in this disclosure. The fused block is then used as the input of the second step.

For the derivation of the linear filter coefficients, the templates of these reference blocks are also fused with the same method as the reference blocks, the fused template and the template of the current block is utilized to derive the filter coefficients.

### Intra TMP for Chroma Components

In the current ECM, intra TMP is only enabled for luma component while not enabled for chroma component. To exploit the benefit of intra TMP for chroma components, methods are proposed to enable intra TMP for chroma components.

In one and another embodiment, for inter slices or intra slices with dual tree disabled, luma and chroma components share the same partitioning tree, only the template of luma component is utilized for template matching to identify the block vector of the current block. The reference blocks for chroma components are the collocated block of the reference block for luma component. In this embodiment, luma and chroma coding blocks share the same intra TMP flag to indicate the usage of intra TMP mode. Luma and chroma components are respectively luma and chroma coding blocks.

In yet another embodiment, for inter slices or intra slices with dual tree disabled, luma and chroma components share the same partitioning tree, the template of luma and two chroma components are utilized for template matching to identify the block vector of the current block. The total template matching cost is the weighted results of template matching cost for luma and chroma components. In this embodiment, luma and chroma coding blocks share the same intra TMP flag to indicate the usage of intra TMP mode.

$${cost}_{total} = {cost}_{Y} + ω \times ( {cost}_{C b} + {cost}_{C r} )$$

In yet another embodiment, for inter slices or intra slices with dual tree disabled, luma and chroma components share the same partitioning tree, the template matching process of luma coding block and two chroma coding blocks are conducted separately. The two chroma coding blocks share the same template matching process, i.e., the template matching cost is calculated by summing up the template matching cost for Cb and Cr component. In this embodiment, luma and chroma coding blocks share the same intra TMP flag to indicate the usage of intra TMP mode.

$${cost}_{c h r o m a} = {cost}_{C b} + {cost}_{C r}$$

In yet another embodiment, for inter slices or intra slices with dual tree disabled, luma and chroma components share the same partitioning tree, the template matching process of Y, U and V coding blocks are all conducted separately. In this embodiment, luma and chroma coding blocks share the same intra TMP flag to indicate the usage of intra TMP mode.

In yet another embodiment, for intra slices with dual tree enabled, template matching search is conducted separately for U and V components. One flag is signaled to indicate whether intra TMP is enabled for chroma components.

In yet another embodiment, for intra slices with dual tree enabled, template matching search is conducted separately for U and V components. One flag is signaled to indicate whether intra TMP is enabled for U component, and another flag is signaled to indicate whether intra TMP is enabled for V component.

In yet another embodiment, for intra slices with dual tree enabled, template matching search is conducted jointly for U and V components, i.e., the total template matching cost is the sum of the template matching cost of U and V components. One flag is signaled to indicate whether intra TMP is enabled for chroma components.

### Combination of Cross-Component Prediction and Intra TMP for Chroma Components

In the current ECM, to exploit the cross-component correlation, CCLM and CCCM are utilize to predict the chroma blocks with the collocated reconstructed luma block. While intra TMP exploits the nonlocal correlations. To exploit both cross-component correlation and nonlocal correlation, it is proposed to combine cross-component prediction and intra TMP for chroma components. Denote the current chroma block as B, the template of the current chroma block as T, the collocated luma block as B_{y} and the template of the collocated luma block as T_{y}.

In one example method to combine cross-component prediction and intra TMP, the proposed method can be divided into several steps as described below.

In the first step, intra template matching is conducted to generate the reference block and reference template, denoted as P_{intraTMP}, and T_{intraTMP}. Here, the reference template includes reference chroma template and reference luma template.

In the second step, the template of the current chroma block T, the reference chroma template T_{intraTMP} and the template of collocated luma block T_{y} obtained in the first step are used to derive the parameters of CCLM or CCCM. Denote the CCLM or CCCM model as F(·), the following equation is solved to derive the parameters of CCLM or CCCM.

$$T = {T}_{intraTMP} + F ( {T}_{Y} )$$

In the third step, the parameters derived in the second step are applied to the collocated luma block to generate the final prediction B_{pred} of the current chroma block, as described as below.

$${B}_{p r e d} = {P}_{intraTMP} + F ( {B}_{Y} )$$

Combination of Intra and Intra TMP with Linear Filter Model

In the current combination of intra and intra TMP, the intra prediction block and intra TMP block are weights to generate the final prediction block without further refinement. In this disclosure, it is proposed to refine the weighted prediction of intra and intra TMP using a linear filter model. The proposed method can be conducted in the following steps.

In the first step, the weighted prediction is generated by weighting the intra predicted block and intra TMP block.

In the second step, the coefficients of the linear filter are derived from the templates, including the template of the current block, the intra predicted template and the reference template. The intra predicted template is generated by conducting intra prediction with the current intra mode. The intra predicted template and reference template are fused to generate the fused template. The fused template and the current template are used to derive the filter coefficients by solving the least square equation.

In the third step, the derived filter coefficients in the second step are applied to the weighted prediction to generate the final prediction.

In this disclosure, several embodiments are proposed to apply the proposed combination of intra and intra TMP with linear filter model.

In one embodiment, the proposed method is always applied to the weighted prediction of intra and intra TMP. No syntax element change is needed.

In yet another embodiment, the usage of the proposed method is signaled with a flag. If the flag is 1, the linear filter model is applied otherwise the linear filter model is not applied. At the encoder side, RDO is conducted to decide whether the linear filter model is enabled for the block.

In one or another embodiment, the proposed combination of intra and intra TMP with linear filter model can be applied for both luma component and chroma components.

FIG. 25 is a flowchart illustrating a method for video decoding according to an example of the present disclosure. Specifically, FIG. 25 shows a method used in the multi-hypothesis intra TMP with linear filter model that improves the prediction quality of intra TMP with linear filter model.

In Step 2501, the processor 1620, at the side of a decoder, may obtain multiple reference blocks for a current block based on template matching.

In Step 2502, the processor 1620 may obtain a fused reference block based on the multiple reference blocks.

In Step 2503, the processor 1620 may obtain a final prediction block for the current block based on the fused reference block and a linear filter.

In some examples, the final prediction block may be obtained by filtering the fused reference block using the linear filter associated with a plurality of filter coefficients.

In one or more examples, filtering the fused reference block using the linear filter associated with the plurality of filter coefficients may be implemented using the following steps including: obtaining a fused template based on the multiple reference blocks; deriving the plurality of filter coefficients based on the fused template and a current template of the current block; and obtaining the final prediction block for the current block by filtering the fused reference block using the linear filter associated with the plurality of filter coefficients. For example, the plurality of filter coefficients may be derived by mminimizing the Mean Square Error (MSE) which may be performed by calculating autocorrelation matrix for the fused template input and current template output. Autocorrelation matrix is LDL decomposed and the final filter coefficients are calculated using back-substitution.

In some examples, the fused template may be obtained based on the multiple reference blocks by obtaining multiple templates for the multiple reference blocks and obtaining the fused template based on the multiple templates for the multiple reference blocks. In one or more examples, the fused template may be obtained in the same manner as obtaining the fused reference block based on the multiple reference blocks. For example, for the derivation of the linear filter coefficients, the templates of these reference blocks are also fused with the same method as the reference blocks, the fused template and the template of the current block is utilized to derive the filter coefficients.

FIG. 26 is a flowchart illustrating a method for video encoding corresponding the method for video decoding as shown in FIG. 25.

In Step 2601, the processor 1620, at the side of an encoder, may obtain multiple reference blocks for a current block based on template matching.

In Step 2602, the processor 1620 may obtain a fused reference block based on the multiple reference blocks.

In Step 2603, the processor 1620 may obtain a final prediction block for the current block based on the fused reference block and a linear filter.

In some examples, the final prediction block may be obtained by filtering the fused reference block using the linear filter associated with a plurality of filter coefficients.

In one or more examples, filtering the fused reference block using the linear filter associated with the plurality of filter coefficients may be implemented using the following steps including: obtaining a fused template based on the multiple reference blocks; deriving the plurality of filter coefficients based on the fused template and a current template of the current block; and obtaining the final prediction block for the current block by filtering the fused reference block using the linear filter associated with the plurality of filter coefficients. For example, the plurality of filter coefficients may be derived by mminimizing the Mean Square Error (MSE) which may be performed by calculating autocorrelation matrix for the fused template input and current template output. Autocorrelation matrix is LDL decomposed and the final filter coefficients are calculated using back-substitution.

In some examples, the fused template may be obtained based on the multiple reference blocks by obtaining multiple templates for the multiple reference blocks and obtaining the fused template based on the multiple templates for the multiple reference blocks. In one or more examples, the fused template may be obtained in the same manner as obtaining the fused reference block based on the multiple reference blocks. For example, for the derivation of the linear filter coefficients, the templates of these reference blocks are also fused with the same method as the reference blocks, the fused template and the template of the current block is utilized to derive the filter coefficients.

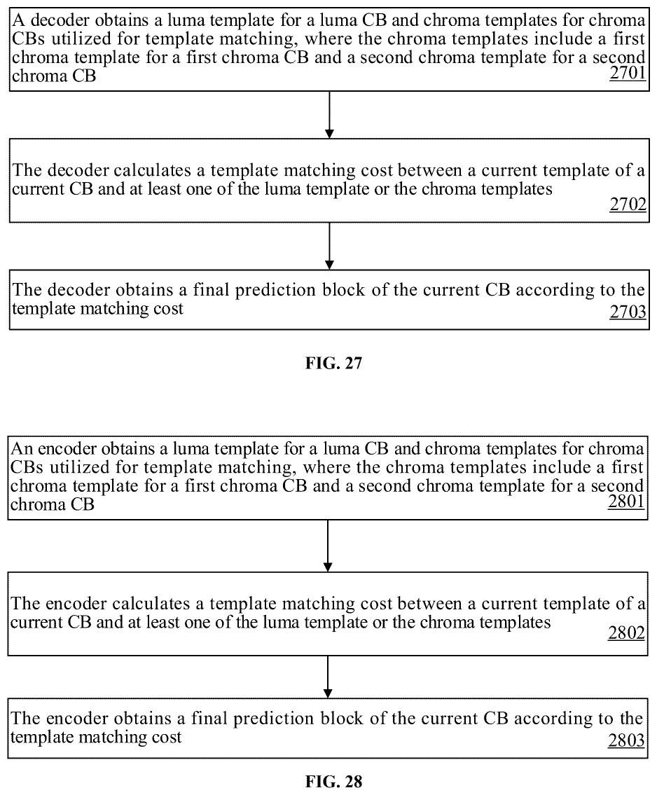

FIG. 27 is a flowchart illustrating a method for video decoding according to an example of the present disclosure. Specifically, FIG. 27 shows the method used in the intra TMP for chroma components.

In Step 2701, the processor 1620, at the side of a decoder, may obtain at least one of a luma template for a luma coding block (CB) or chroma templates for chroma CBs utilized for template matching, where the chroma templates include a first chroma template for a first chroma CB, and a second chroma template for a second chroma CB, where these templates may be utilized for template matching.

In Step 2702, the processor 1620 may calculate a template matching cost between a current template of a current CB and at least one of the luma template, the first chroma template, or the second chroma template.

In Step 2703, the processor 1620 may obtain a final prediction block of the current CB according to the template matching cost.

In some examples, the Step 2702 may be implemented by the following steps including: when a dual tree is disabled for inter slices or intra slices in a coding CTU including the current CB, i.e., the luma CB, the first and second chroma CB share a same partitioning tree, calculating the template matching cost between the luma template and a current template of the current CB; and obtaining the final prediction block according to the template matching cost.

In some examples, the processor 1620 may further receive a flag indicating whether an intra template matching prediction (TMP) is enabled to the luma CB and the chroma CBs when the dual tree is disabled for the inter slices or the intra slices, and obtain the luma template for the luma CB based on template matching in response to determining that the flag indicates that the intra TMP is enabled to the luma CB and the chroma CBs.

In some examples, the Steps 2702 and 2703 may be implemented by the following steps including: when the dual tree is disabled for the inter slices or the intra slices, obtaining a luma template cost between the luma template and the current template of the current CB, a first chroma template cost between the first chroma template and the current template, and a second chroma template cost between the second chroma template and the current template, calculating a total template matching cost as the template matching cost by weighting the luma template cost, the first chroma template cost, and the second chroma template cost, and obtaining the final prediction block according to the total template matching cost. For example, the total template matching cost may be obtained by:

$${cost}_{total} = {cost}_{Y} + ω \times ( {cost}_{C b} + {cost}_{C r} )$$

where ω may be a predefined empirical value.

In some examples, the processor 1620 may further receive a flag indicating whether an intra TMP is enabled to the luma CB and the first and second chroma CBs when the dual tree is disabled for the inter slices or the intra slices and obtain the luma template for the luma CB, the first chroma template for the first chroma CB, and the second chroma template for the second chroma CB in response to determining that the flag indicates that the intra TMP is enabled to the luma CB and the first and second chroma CBs. In one example, luma and chroma coding blocks may share the same flag, i.e., intra TMP flag, to indicate the usage of intra TMP mode.

In some examples, the Steps 2702 and 2703 may be implemented by the following steps including: when the dual tree is disabled for the inter slices or the intra slices, obtaining a luma template cost between the luma template and the current template of the current CB, a first chroma template cost between the first chroma template and the current template, and a second chroma template cost between the second chroma template and the current template, obtaining a chroma template cost by adding the first chroma template cost and the second chroma template cost, and obtaining the final prediction block according to the luma template cost and the chroma template cost.

In one or more examples, the processor 1620 may further receive a flag indicating whether an intra TMP is enabled to the luma CB and the chroma CBs when the dual tree is disabled for the inter slices or the intra slices and obtain the luma template for the luma CB, the first chroma template for the first chroma CB and the second chroma template for the second chroma CB in response to determining that the flag indicates that the intra TMP is enabled to the luma CB and the chroma CBs. In one example, luma and chroma coding blocks may share the same flag, i.e., intra TMP flag, to indicate the usage of intra TMP mode.

In some examples, the Steps 2702 and 2703 may be implemented by the following steps including: when the dual tree is disabled for the inter slices or the intra slices, obtaining a luma template matching cost between the luma template and a current template of the current CB and obtaining a luma prediction block based on the luma template matching cost, obtaining a first chroma template matching cost between the first chroma template and the current template and obtaining a first chroma prediction block based on the first chroma template matching cost, obtaining a second chroma template matching cost between the second chroma template and the current template and obtaining a second chroma prediction block based on the second chroma template matching cost, and obtaining the final prediction block based on the luma prediction block, the first chroma prediction block, and the second chroma prediction block. In these examples, the template matching process of Y, U and V coding blocks are all conducted separately.

In one or more examples, the processor 1620 may further receive a flag indicating whether an intra TMP is enabled to the luma CB and the chroma CBs when the dual tree is disabled for the inter slices or the intra slices and obtain the luma template for the luma CB, the first chroma template for the first chroma CB, and the second chroma template for the second chroma CB in response to determining that the flag indicates that the intra TMP is enabled to the luma CB and the chroma CBs. In these examples, luma and chroma coding blocks share the same flag, i.e., intra TMP flag, to indicate the usage of intra TMP mode.

In some examples, the Steps 2702 and 2703 may be implemented by the following steps including: when the dual tree is enabled for the intra slices, obtaining a first chroma template matching cost between the first chroma template and a current template of the current CB and obtaining a first chroma prediction block based on the first chroma template matching cost, obtain a second chroma template matching cost between the second chroma template and the current template and obtaining a second chroma prediction block based on the second chroma template matching cost, and obtain the final prediction block based on the first and second chroma prediction blocks. In these examples, template matching search is conducted separately for chroma components, i.e., U and V components.

In one or more examples, the processor 1620 may further receive a flag indicating whether an intra template matching prediction (TMP) is enabled for the first and second chroma CBs when the dual tree is enabled for the intra slices and obtain the first chroma template for the first chroma CB and the second chroma template for the second chroma CB in response to determining that the flag indicates that the intra TMP is enabled for the first and second chroma CBs.

In one or more examples, the processor 1620 may further receive a first flag indicating whether an intra template matching prediction (TMP) is enabled for the first chroma CB and a second flag indicating whether the intra TMP is enabled for the second chroma CB when the dual tree is enabled for the intra slices and obtain the first chroma template for the first chroma CB and the second chroma template for the second chroma CB in response to determining that the first flag indicates that the intra TMP is enabled for the first chroma CB and determining that the second flag indicates that the intra TMP is enabled for the second chroma CB.

In some examples, the Steps 2702 and 2703 may be implemented by the following steps including: when the dual tree is enabled for the intra slices, obtaining a first chroma template matching cost between the first chroma template and a current template of the current CB, obtaining a second chroma template matching cost between the second chroma template and the current template, calculating a chroma template matching cost by adding the first chroma template matching cost and the second chroma template matching cost, and obtaining the final prediction block based on the chroma template matching cost. In these examples, template matching search is conducted jointly for chroma components, i.e., U and V components, and the total template matching cost is the sum of the template matching cost of U and V components.

In one or more examples, the processor 1620 may further receive a flag indicating whether an intra TMP is enabled for the first and second chroma CBs when the dual tree is enabled for the intra slices and obtain the first chroma template for the first chroma CB and the second chroma template for the second chroma CB in response to determining that the flag indicates that the intra TMP is enabled for the first and second chroma CBs.

FIG. 28 is a flowchart illustrating a method for video encoding corresponding the method for video decoding as shown in FIG. 27.

In Step 2801, the processor 1620, at the side of an encoder, may obtain a luma template for a luma CB or chroma templates for chroma CBs utilized for template matching, where the chroma templates include a first chroma template for a first chroma CB and a second chroma template for a second chroma CB, where these templates may be utilized for template matching.

In Step 2802, the processor 1620 may calculate a template matching cost between a current template of a current CB and at least one of the luma template, the first chroma template, or the second chroma template.

In Step 2803, the processor 1620 may obtain a final prediction block of the current CB according to the template matching cost.

In some examples, the Step 2802 may be implemented by the following steps including: when a dual tree is disabled for inter slices or intra slices in a coding CTU including the current CB, obtaining the luma template for the luma CB based on template matching; calculating a template matching cost between the luma template and a current template of the current CB; and obtaining the final prediction block according to the template matching cost.

In one or more examples, the processor 1620 may further signal a flag indicating whether an intra template matching prediction (TMP) is enabled to the luma CB and the chroma CBs when the dual tree is disabled for the inter slices or the intra slices, and obtain the luma template for the luma CB based on template matching in response to the flag indicating that the intra TMP is enabled to the luma CB and the chroma CBs.

In some examples, the Steps 2802 and 2803 may be implemented by the following steps including: when the dual tree is disabled for the inter slices or the intra slices, obtaining a luma template cost between the luma template and the current template of the current CB, a first chroma template cost between the first chroma template and the current template, and a second chroma template cost between the second chroma template and the current template, calculating a total template matching cost by weighting the luma template cost, the first chroma template cost, and the second chroma template cost, and obtaining the final prediction block according to the total template matching cost. For example, the total template matching cost may be obtained by:

$${cost}_{total} = {cost}_{Y} + ω \times ( {cost}_{C b} + {cost}_{C r} )$$

where ω may be a predefined empirical value.

In one or more examples, the processor 1620 may further signal a flag indicating whether an intra TMP is enabled to the luma CB and the first and second chroma CBs when the dual tree is disabled for the inter slices or the intra slices and obtain the luma template for the luma CB, the first chroma template for the first chroma CB, and the second chroma template for the second chroma CB in response to the flag indicating that the intra TMP is enabled to the luma CB and the first and second chroma CBs. In one example, luma and chroma coding blocks may share the same flag, i.e., intra TMP flag, to indicate the usage of intra TMP mode.

In some examples, the Steps 2802 and 2803 may be implemented by the following steps including: when the dual tree is disabled for the inter slices or the intra slices, obtaining a luma template cost between the luma template and the current template of the current CB, a first chroma template cost between the first chroma template and the current template, and a second chroma template cost between the second chroma template and the current template, obtaining a chroma template cost by adding the first chroma template cost and the second chroma template cost, and obtaining the final prediction block according to the luma template cost and the chroma template cost.

In one or more examples, the processor 1620 may further signal a flag indicating whether an intra TMP is enabled to the luma CB and the chroma CBs when the dual tree is disabled for the inter slices or the intra slices and obtain the luma template for the luma CB, the first chroma template for the first chroma CB and the second chroma template for the second chroma CB in response to the flag indicating that the intra TMP is enabled to the luma CB and the chroma CBs. In one example, luma and chroma coding blocks may share the same flag, i.e., intra TMP flag, to indicate the usage of intra TMP mode.

In some examples, the Steps 2802 and 2803 may be implemented by the following steps including: when the dual tree is disabled for the inter slices or the intra slices, obtaining a luma template matching cost between the luma template and a current template of the current CB and obtaining a luma prediction block based on the luma template matching cost, obtaining a first chroma template matching cost between the first chroma template and the current template and obtaining a first chroma prediction block based on the first chroma template matching cost, obtaining a second chroma template matching cost between the second chroma template and the current template and obtaining a second chroma prediction block based on the second chroma template matching cost, and obtaining the final prediction block based on the luma prediction block, the first chroma prediction block, and the second chroma prediction block. In these examples, the template matching process of Y, U and V coding blocks are all conducted separately.

In one or more examples, the processor 1620 may further signal a flag indicating whether an intra TMP is enabled to the luma CB and the chroma CBs when the dual tree is disabled for the inter slices or the intra slices and obtain the luma template for the luma CB, the first chroma template for the first chroma CB, and the second chroma template for the second chroma CB in response to the flag indicating that the intra TMP is enabled to the luma CB and the chroma CBs. In one example, luma and chroma coding blocks may share the same flag, i.e., intra TMP flag, to indicate the usage of intra TMP mode.

In some examples, the Steps 2802 and 2803 may be implemented by the following steps including: when the dual tree is enabled for the intra slices, obtaining a first chroma template matching cost between the first chroma template and a current template of the current CB and obtaining a first chroma prediction block based on the first chroma template matching cost, obtaining a second chroma template matching cost between the second chroma template and the current template and obtaining a second chroma prediction block based on the second chroma template matching cost, and obtaining the final prediction block based on the first and second chroma prediction blocks. In these examples, template matching search is conducted separately for chroma components, i.e., U and V components.

In one or more examples, the processor 1620 may further signal a flag indicating whether an intra template matching prediction (TMP) is enabled for the first and second chroma CBs when the dual tree is enabled for the intra slices and obtain the first chroma template for the first chroma CB and the second chroma template for the second chroma CB in response to the flag indicating that the intra TMP is enabled for the first and second chroma CBs.

In one or more examples, the processor 1620 may further signal a first flag indicating whether an intra template matching prediction (TMP) is enabled for the first chroma CB and a second flag indicating whether the intra TMP is enabled for the second chroma CB when the dual tree is enabled for the intra slices and obtain the first chroma template for the first chroma CB and the second chroma template for the second chroma CB in response to the first flag indicating that the intra TMP is enabled for the first chroma CB and determining that the second flag indicates that the intra TMP is enabled for the second chroma CB.

In some examples, the Steps 2802 and 2803 may be implemented by the following steps including: when the dual tree is enabled for the intra slices, obtaining a first chroma template matching cost between the first chroma template and a current template of the current CB, obtaining a second chroma template matching cost between the second chroma template and the current template, calculating a chroma template matching cost by adding the first chroma template matching cost and the second chroma template matching cost, and obtain the final prediction block based on the chroma template matching cost. In these examples, template matching search is conducted jointly for chroma components, i.e., U and V components, and the total template matching cost is the sum of the template matching cost of U and V components.

In one or more examples, the processor 1620 may further signal a flag indicating whether an intra TMP is enabled for the first and second chroma CBs when the dual tree is enabled for the intra slices and obtain the first chroma template for the first chroma CB and the second chroma template for the second chroma CB in response to the flag indicating that the intra TMP is enabled for the first and second chroma CBs.

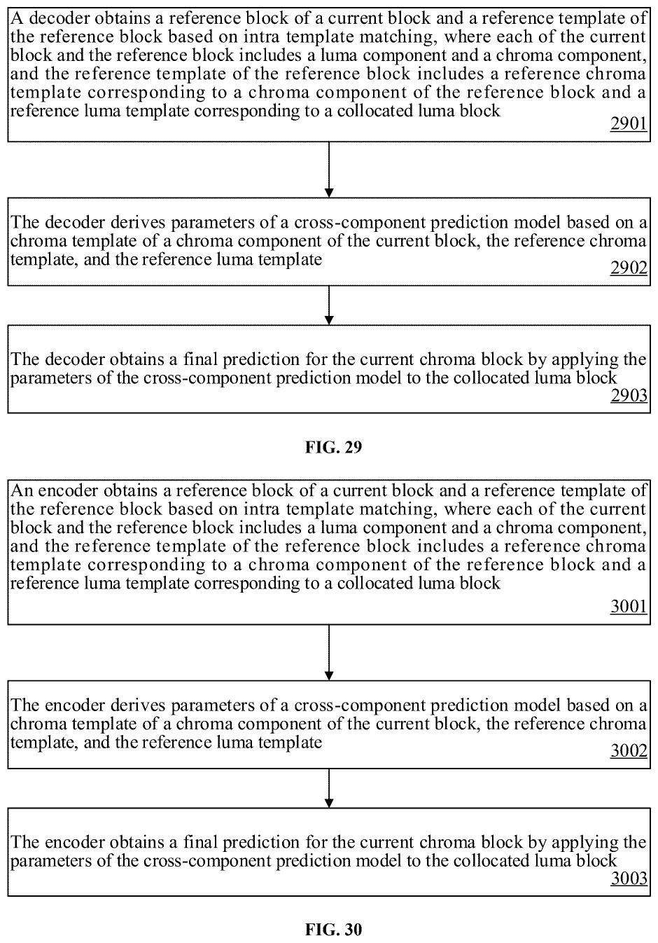

FIG. 29 is a flowchart illustrating a method for video decoding according to an example of the present disclosure. The method shown in FIG. 29 is utilized in the combination of cross-component prediction and intra TMP for chroma components.

In Step 2901, the processor 1620, at the side of a decoder, may obtain a reference block of a current block and a reference template of the reference block based on intra template matching, where each of the current block and the reference block includes a luma component and a chroma component, and the reference template of the reference block includes a reference chroma template corresponding to a chroma component of the reference block and a reference luma template corresponding to a collocated luma block.

In Step 2902, the processor 1620, at the side of the decoder, may derive parameters of a cross-component prediction model based on a chroma template of a chroma component of the current block, the reference chroma template, and the reference luma template.

In some examples, the cross-component prediction model may include one of following models: a convolutional cross-component model (CCCM) or a cross-component linear model (CCLM).

In Step 2903, the processor 1620, at the side of the decoder, may obtain a final prediction for the current chroma block by applying the parameters of the cross-component prediction model to the collocated luma block.

FIG. 30 is a flowchart illustrating a method for video encoding corresponding to the method illustrated in FIG. 29 according to an example of the present disclosure.

In Step 3001, the processor 1620, at the side of an encoder, may obtain a reference block of a current block and a reference template of the reference block based on intra template matching, where each of the current block and the reference block includes a luma component and a chroma component, and the reference template of the reference block includes a reference chroma template corresponding to a chroma component of the reference block and a reference luma template corresponding to a collocated luma block.

In Step 3002, the processor 1620, at the side of the encoder, may derive parameters of a cross-component prediction model based on a chroma template of a chroma component of the current block, the reference chroma template, and the reference luma template.

In some examples, the cross-component prediction model may include one of following models: a convolutional cross-component model (CCCM) or a cross-component linear model (CCLM).

In Step 3003, the processor 1620, at the side of the encoder, may obtain a final prediction for the current chroma block by applying the parameters of the cross-component prediction model to the collocated luma block.

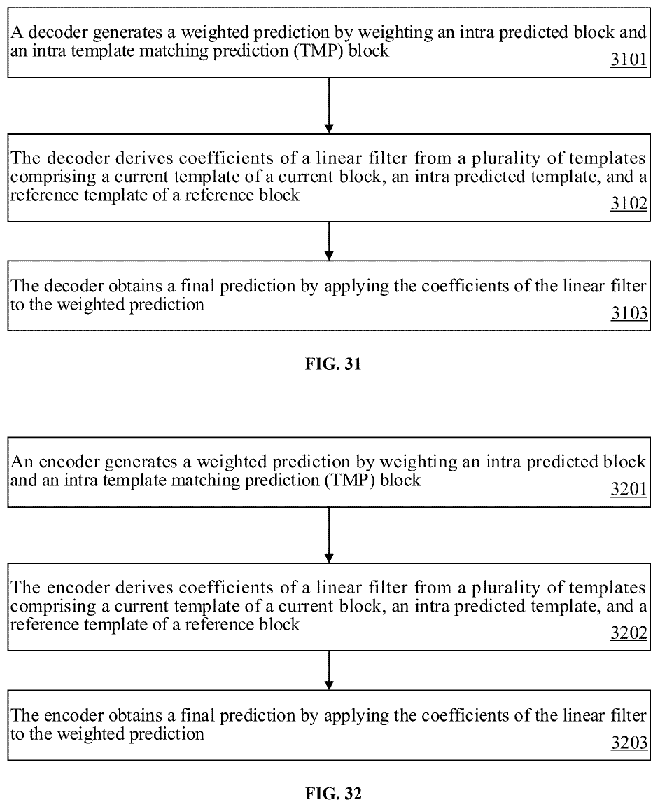

FIG. 31 is a flowchart illustrating a method for video decoding according to an example of the present disclosure. The method shown in FIG. 31 may be utilized in combination of intra and intra TMP with linear filter model.

In Step 3101, the processor 1620, at the side of a decoder, may generate a weighted prediction by weighting an intra predicted block and an intra template matching prediction (TMP) block. For example, the processor 1620 may apply weights to the intra predicted block and the intra TMP block and then generated the weighted prediction based on the weight sum of the intra predicted block and the intra TMP block.

In Step 3102, the processor 1620, at the side of the decoder, may derive coefficients of a linear filter from a plurality of templates including a current template of a current block, an intra predicted template, and a reference template of a reference block.

In some examples, the coefficients of the linear filter may be derived by obtaining the intra predicted template by conducting intra prediction with a current intra mode, obtaining a fused template by fusing the intra predicted template and the reference template, and deriving the coefficients of the linear filter using the fused template and the current template to solve a least square equation.

In some examples, the processor 1620 may receive a flag indicating whether the linear filter model applies, and derive the coefficients of the linear filter from the plurality of templates including the current template of the current block, the intra predicted template, and the reference template in response to determining that the flag indicates the linear filter model applies.

In some examples, the combination of intra and intra TMP with linear filter model can be used for luma and chroma blocks, separately. Specifically, the coefficients of the linear filter may be derived by deriving the coefficients of the linear filter from the plurality of templates including the current template of the current block, the intra predicted template, and the reference template, where each of the plurality of templates includes one of a luma component or chroma components.

In Step 3103, the processor 1620, at the side of the decoder, may obtain a final prediction by applying the coefficients of the linear filter to the weighted prediction.

FIG. 32 is a flowchart illustrating a method for video encoding according to an example of the present disclosure.

In Step 3201, the processor 1620, at the side of an encoder, may generate a weighted prediction by weighting an intra predicted block and an intra template matching prediction (TMP) block.

In Step 3202, the processor 1620, at the side of the encoder, may derive coefficients of a linear filter from a plurality of templates including a current template of a current block, an intra predicted template, and a reference template of a reference block.

In some examples, the coefficients of the linear filter may be derived by obtaining the intra predicted template by conducting intra prediction with a current intra mode, obtaining a fused template by fusing the intra predicted template and the reference template, and deriving the coefficients of the linear filter using the fused template and the current template to solve a least square equation.

In some examples, the processor 1620 may signal a flag indicating whether the linear filter model applies, and derive the coefficients of the linear filter from the plurality of templates including the current template of the current block, the intra predicted template, and the reference template in response to the flag indicating that the linear filter model applies. In one or more examples, at the encoder side, RDO is conducted to decide whether the linear filter model is enabled for the block.

In some examples, the combination of intra and intra TMP with linear filter model can be used for luma and chroma blocks, separately. Specifically, the coefficients of the linear filter may be derived by deriving the coefficients of the linear filter from the plurality of templates including the current template of the current block, the intra predicted template, and the reference template, where each of the plurality of templates includes one of a luma component or chroma components.

In Step 3203, the processor 1620, at the side of the encoder, may obtain a final prediction by applying the coefficients of the linear filter to the weighted prediction.

Sub-block intra TMP

In this disclosure, methods are provided to improve the coding efficiency of intra TMP by utilizing subblock-based intra TMP.

In one embodiment, the current prediction block is divided into several regions. For k-th region Rₖ, a corresponding template Tₖ is identified which is a subset of the template for intra TMP. The template Tₖ is used to conduct template matching to find the optimal prediction region for Rₖ. Several examples are provided to elaborate the proposed methods.

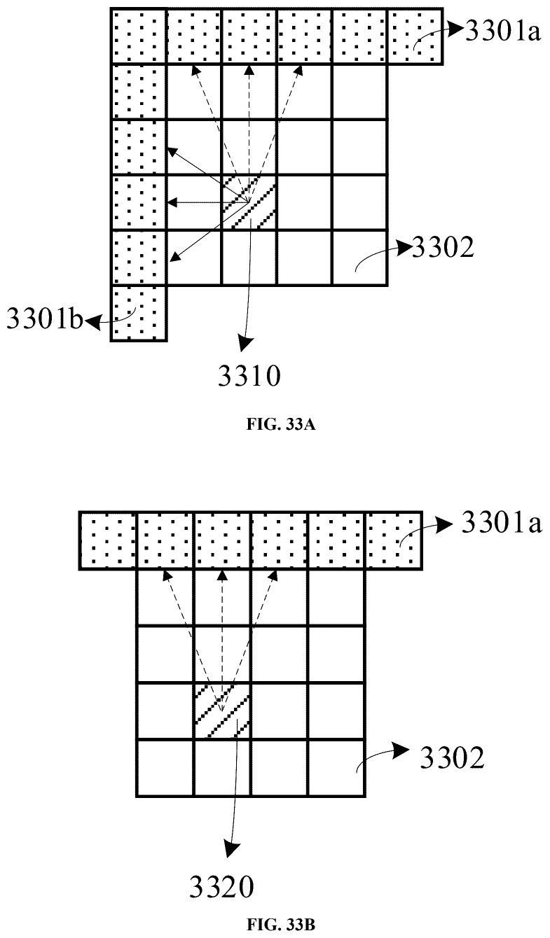

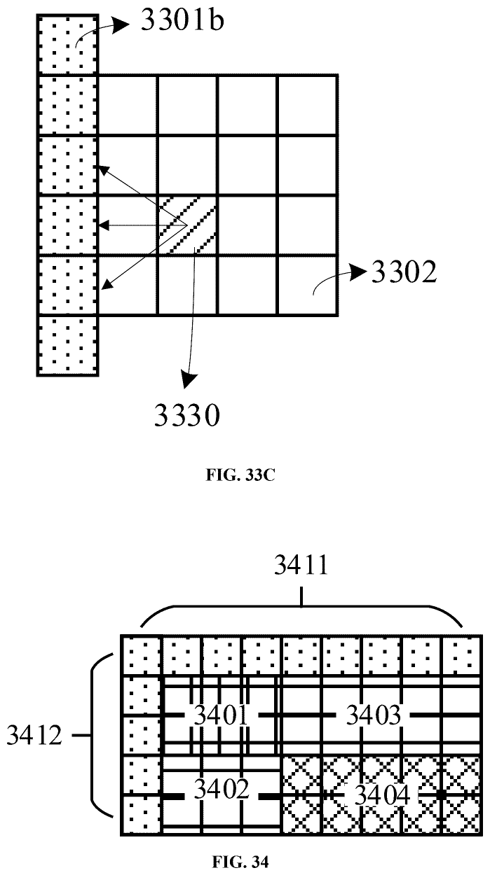

In one example, the current prediction block is divided into several subblocks and intra template matching is conducted for each subblock, as illustrated in FIGS. 33A-33C. More specifically, the template is also divided several segments. For the above/left template, it is divided into segments with width/height equaling to the subblock size. For each subblock, the above and left template segments nearest to the subblock are utilized for template matching.

In another example, the current prediction block is divided into four parts: the left-above region, right-above region, left-below region and right-below region, as illustrated in FIG. 34. Different templates are utilized for the four regions in template matching. For the left-above region and right-below region, both left and above templates are utilized for template matching. For the left-below region, only left template is utilized for template matching. While for the right-above region, only the above template is utilized for template matching.

In one embodiment, subblock intra TMP is always applied if the prediction block is coded with intra TMP mode.

In yet another embodiment, if intra TMP is used for the prediction block, an additional flag is signaled to indicate whether subblock intra TMP is utilized.

### Two Stage Combination of Intra and Intra TMP

In the first example, a subset of the predictors of the current prediction block is firstly determined by intra TMP; this process is termed the first prediction process and the subset is termed as first subset. Secondly, the other predictors of the current prediction block are then generated by regular intra prediction modes, including planar mode and angular modes defined in the HEVC or VVC; this process is termed as second prediction process and the other predictors are termed as second subset.

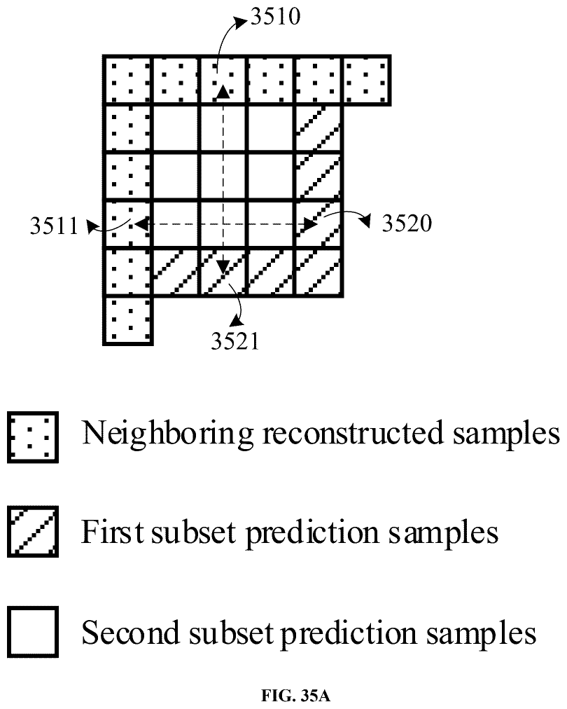

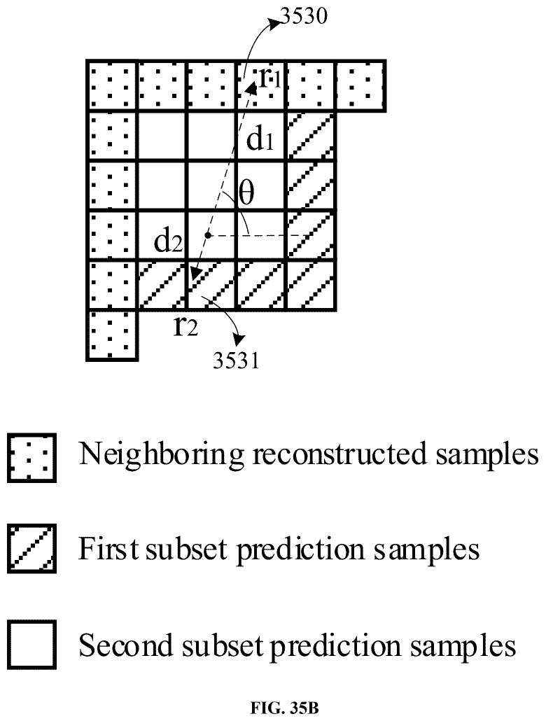

In one example, the first subset of the predictors generated by the first prediction process may be the bottom-right predictor as illustrated in the FIGS. 35A-35B. And the second subset contains the other prediction samples as illustrated in the FIGS. 35A-35B.

In one embodiment, the final prediction samples in the second subset may be derived in the second prediction process with planar mode.

$$p [ x ] [ y ] = ( w 0 [ x ] [ y ] * p [ x ] [ - 1 ] + w1 [ x ] [ y ] * p [ x ] [ height - 1 ] + w 2 [ x ] [ y ] * p [ - 1 ] [ y ] + w 3 [ x ] [ y ] * p [ width - 1 ] [ y ] ) / N$$

In some examples, the neighboring samples are denoted as p[x][y], with x=−1, y=−1 . . . height and x=0 . . . width, y=−1. Width and height are the width and height of the current prediction block. w0, w1, w2 and w3 are weighting factors which could be predefined. N is the normalization factor which is normally sum of all the weighting factors. N=w0[x][y]+w1[x][y]+w2[x][y]+w3[x][y]. In one specific example, the weighting factors are predefined as below:

$$w 0 [ x ] [ y ] = ( height - y ) , w 1 [ x ] [ y ] = y , w 2 [ x ] [ y ] = ( width - x ) , w 3 [ x ] [ y ] = x$$

In yet another embodiment, the final prediction samples in the second subset may be derived in the second prediction process with angular intra modes. The prediction samples in the first subset are firstly derived with intra TMP. Secondly, the prediction samples in the second subset by interpolating the neighboring reconstructed samples and the prediction samples in the first subset.

$$p [ x ] [ y ] = w 1 * {r}_{1} + w 2 * {r}_{2}$$

where w0 and w1 are calculated as:

$$w 1 = \frac{d 2}{d 1 + d 2} and w 2 = \frac{d 1}{d 1 + d 2}$$

In the second example, planar mode is always used as the prediction mode of the second prediction process. If the current coding block is coded with intra mode, a syntax element is signaled to indicate the usage of the provided method.

In the third example, both planar and angular modes may be selected as the prediction mode of the second prediction process. If the current coding block is coded with intra mode, a syntax element is signaled to indicate the usage of the proposed method. And another syntax element is signaled to indicate the intra prediction mode of the second prediction process.

In some examples, the above methods may be applied independently or combinedly.

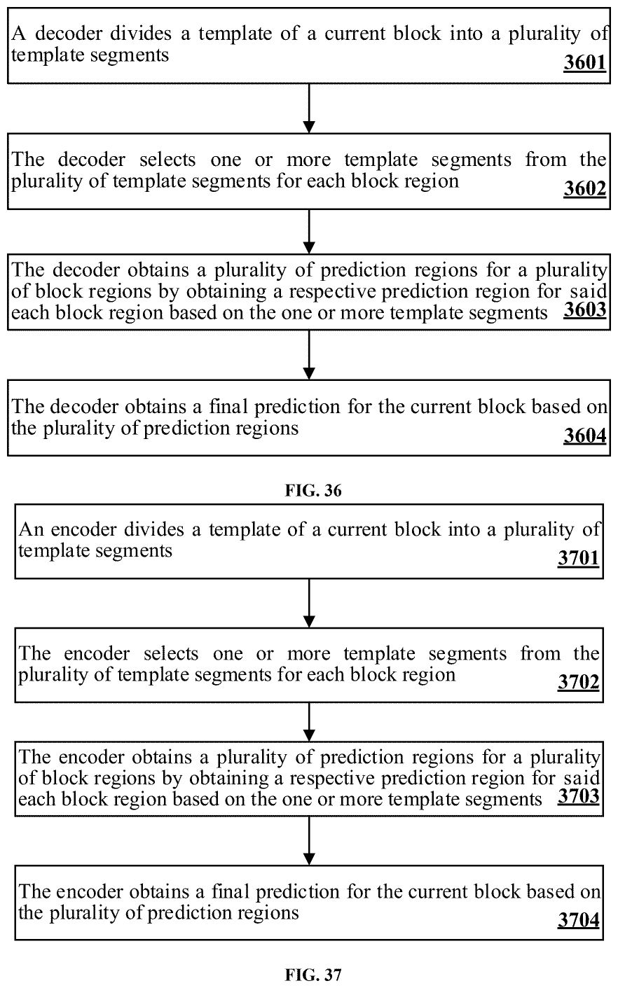

FIG. 36 is a flowchart illustrating a method for video decoding according to an example of the present disclosure. Specifically, FIG. 36 shows methods discussed in the section of “subblock-based intra TMP.”

In Step 3601, the processor 1620, at the side of a decoder, may divide a template of a current block into a plurality of template segments.

In Step 3602, the processor 1620 may select one or more template segments from the plurality of template segments for each block region.

In some examples, each block region may be a subblock 3302 of the current block (current coding block/current prediction block) and each subblock 3302 has a same size as each template segment 3301a or 3301b, as illustrated in FIGS. 33A-33C. The current block may be divided into multiple subblocks 3302. Furthermore, the plurality of template segments may include a plurality of first template segments 3301b that are on left of the current block and a plurality of second template segments 3301a that are on top of the current block.

In one example, the processor 1620 may select a first number of first template segments from the plurality of first template segments and select a second number of second template segments from the plurality of second template segments, where the first number of template segments may be the nearest template segments to each block region among the plurality of first template segments, and the second number of second template segments may be the nearest template segments to each block region among the plurality of second template segments. The first number and the second number may be different or the same. For example, as shown in FIG. 33A, three of first template segments 3301b that are the nearest to a prediction subblock 3310 are selected as shown by the three solid arrows; three of second template segments 3301a that are the nearest to the prediction subblock 3310 are selected as shown by the three dotted arrows.

In one example, the processor 1620 may select the first number of first template segments from the plurality of first template segments, where the first number of template segments are the nearest template segments to each block region among the plurality of first template segments. For example, as shown in FIG. 33C, three of first template segments 3301b that are nearest to a prediction subblock 3330 are selected as shown by the three solid arrows.

In one example, the processor 1620 may select the second number of second template segments from the plurality of second template segments, where the second number of template segments are the nearest template segments to each block region among the plurality of second template segments. For example, as shown in FIG. 33B, three of second template segments 3301a that are nearest to a prediction subblock 3320 are selected as shown by the three dotted arrows.

In some examples, each block region may include a plurality of subblocks, and the plurality of template segments may include a left template segment 3412 and a top template segment 3411, as shown in FIG. 34. The plurality of block regions may include a first block region 3401 that is adjacent to the left and the top template segments, one or more second block regions 3402 that are adjacent to the left template segment, one or more third block regions 3403 that are adjacent to the top template segment, and a fourth block region 3404 that is not adjacent to the left or the top template segment. FIG. 34 only shows that there is one second block region 3402 and one third block region 3403, but the number of second block region 3402 or the number of third block region 3403 are not limited to 1 in this disclosure.

In these examples, the processor 1620 may select both the left and the top template segments for the first block region and the fourth block region, i.e., the processor 1620 may select the left template segment 3412 and the top template segment 3411 for the first block region 3401 and select the left template segment 3412 and the top template segment 3411 for the fourth block region 3404. Furthermore, the processor 1620 may select the left template segment for a second block region and select the top template segment for a third block region, i.e., the processor 1620 may select the left template segment 3412 for second block region 3402 and select the top template segment 3411 for third block region 3403. As shown in FIG. 34, the left template segment 3412 is the left template of the current block and the top template segment 3411 is the top template of the current block.

In Step 3603, the processor 1620 may obtain a plurality of prediction regions for a plurality of block regions by obtaining a respective prediction region for said each block region based on the one or more template segments.

In some examples, for each block region, a respective prediction region may be obtained by conducting or applying template matching on the one or more template segments that are selected in Step 3601 to find the optimal prediction region with the optimal template matching cost. The optimal template matching cost may be a minimum cost obtained by comparing corresponding template segments of different block regions.

In one example, as shown in FIG. 33A, a respective prediction region may be obtained for each block region by conducting or applying template matching on the first number of first template segments and the second number of second template segments, that is, conducting or applying template matching on the three nearest first template segments 3301b and the three nearest second template segments 3301a.

In another example, as shown in FIG. 33C, a respective prediction region may be obtained for each block region by conducting or applying template matching on the first number of first template segments, that is, conducting or applying template matching on the three nearest first template segments 3301b.

In another example, as shown in FIG. 33B, a respective prediction region may be obtained for each block region by conducting or applying template matching on the second number of second template segments, that is, conducting or applying template matching on the three nearest second template segments 3301a.

In some examples, a respective prediction region may be obtained for the first block region 3401 by conducting or applying template matching on both the left template segment 3412 and the top template segment 3411, a respective prediction region may be obtained for the fourth block region 3404 by conducting or applying template matching on both the left template segment 3412 and the top template segment 3411, a respective prediction region may be obtained for a second block region 3402 by conducting or applying template matching on the left template segment 3412, and a respective prediction region may be obtained for a third block region 3403 by conducting or applying template matching on the top template segment 3411.

In Step 3604, the processor 1620 may obtain a final prediction for the current block based on the plurality of prediction regions.

In some examples, as shown in FIGS. 33A-33C, the final prediction may be obtained based on all respective prediction regions for all the block regions 3302 in the current block.

In some examples, as shown in FIG. 34, the final prediction may be obtained based on all respective prediction regions for all the block regions 3401, 3402, 3403, and 3404 in the current block.

In some examples, subblock intra TMP is always applied if the prediction block is coded with intra TMP mode. The processor 1620 may determine whether the current block is coded with intra TMP mode and may apply subblock intra TMP, i.e., may conduct Step 3601 to Step 3604, to the current block in response to determining that the current block is coded with the intra TMP mode.

In some examples, if intra TMP is used for the prediction block, an additional flag is signaled to indicate whether subblock intra TMP is utilized. The processor 1620 may determine whether the current block is coded with intra TMP mode. When the current block is coded with the intra TMP mode, the processor 1620 may receive a syntax element, e.g., a flag, that indicates whether the subblock intra TMP is utilized. The processor 1620 may apply the subblock intra TMP to the current block when the syntax element indicates that the subblock intra TMP is utilized.

FIG. 37 is a flowchart illustrating a method for video encoding corresponding the method for video decoding as shown in FIG. 36.

In Step 3701, the processor 1620, at the side of an encoder, may divide a template of a current block into a plurality of template segments.

In Step 3702, the processor 1620 may select one or more template segments from the plurality of template segments for each block region.

In some examples, each block region may be a subblock 3302 of the current block and each subblock 3302 has a same size as each template segment 3301a or 3301b, as illustrated in FIGS. 33A-33C. The current block may be divided into multiple subblocks 3302. Furthermore, the plurality of template segments may include a plurality of first template segments 3301b that are on left of the current block and a plurality of second template segments 3301a that are on top of the current block.

In one example, the processor 1620 may select a first number of first template segments from the plurality of first template segments and select a second number of second template segments from the plurality of second template segments, where the first number of template segments may be the nearest template segments to each block region among the plurality of first template segments, and the second number of second template segments may be the nearest template segments to each block region among the plurality of second template segments. The first number and the second number may be different or the same. For example, as shown in FIG. 33A, three of first template segments 3301b that are the nearest to a prediction subblock 3310 are selected as shown by the three solid arrows; three of second template segments 3301a that are the nearest to the prediction subblock 3310 are selected as shown by the three dotted arrows.

In one example, the processor 1620 may select the first number of first template segments from the plurality of first template segments, where the first number of template segments are the nearest template segments to each block region among the plurality of first template segments. For example, as shown in FIG. 33C, three of first template segments 3301b that are nearest to a prediction subblock 3330 are selected as shown by the three solid arrows.

In one example, the processor 1620 may select the second number of second template segments from the plurality of second template segments, where the second number of template segments are the nearest template segments to each block region among the plurality of second template segments. For example, as shown in FIG. 33B, three of second template segments 3301a that are nearest to a prediction subblock 3320 are selected as shown by the three dotted arrows.

In some examples, each block region may include a plurality of subblocks, and the plurality of template segments may include a left template segment 3412 and a top template segment 3411, as shown in FIG. 34. The plurality of block regions may include a first block region 3401 that is adjacent to the left and the top template segments, one or more second block regions 3402 that are adjacent to the left template segment, one or more third block regions 3403 that are adjacent to the top template segment, and a fourth block region 3404 that is not adjacent to the left or the top template segment. FIG. 34 only shows that there is one second block region 3402 and one third block region 3403, but the number of second block region 3402 or the number of third block region 3403 are not limited to 1 in this disclosure.

In these examples, the processor 1620 may select both the left and the top template segments for the first block region and the fourth block region, i.e., the processor 1620 may select the left template segment 3412 and the top template segment 3411 for the first block region 3401 and select the left template segment 3412 and the top template segment 3411 for the fourth block region 3404. Furthermore, the processor 1620 may select the left template segment for a second block region and select the top template segment for a third block region, i.e., the processor 1620 may select the left template segment 3412 for second block region 3402 and select the top template segment 3411 for third block region 3403. As shown in FIG. 34, the left template segment 3412 is the left template of the current block and the top template segment 3411 is the top template of the current block.

In Step 3703, the processor 1620 may obtain a plurality of prediction regions for a plurality of block regions by obtaining a respective prediction region for said each block region based on the one or more template segments.

In some examples, for each block region, a respective prediction region may be obtained by conducting or applying template matching on the one or more template segments that are selected in Step 3701 to find the optimal prediction region with the optimal template matching cost. The optimal template matching cost may be a minimum cost obtained by comparing corresponding template segments of different block regions.

In one example, as shown in FIG. 33A, a respective prediction region may be obtained for each block region by conducting or applying template matching on the first number of first template segments and the second number of second template segments, that is, conducting or applying template matching on the three nearest first template segments 3301b and the three nearest second template segments 3301a.

In another example, as shown in FIG. 33C, a respective prediction region may be obtained for each block region by conducting or applying template matching on the first number of first template segments, that is, conducting or applying template matching on the three nearest first template segments 3301b.

In another example, as shown in FIG. 33B, a respective prediction region may be obtained for each block region by conducting or applying template matching on the second number of second template segments, that is, conducting or applying template matching on the three nearest second template segments 3301a.

In some examples, a respective prediction region may be obtained for the first block region 3401 by conducting or applying template matching on both the left template segment 3412 and the top template segment 3411, a respective prediction region may be obtained for the fourth block region 3404 by conducting or applying template matching on both the left template segment 3412 and the top template segment 3411, a respective prediction region may be obtained for a second block region 3402 by conducting or applying template matching on the left template segment 3412, and a respective prediction region may be obtained for a third block region 3403 by conducting or applying template matching on the top template segment 3411.

In Step 3704, the processor 1620 may obtain a final prediction for the current block based on the plurality of prediction regions.

In some examples, as shown in FIGS. 33A-33C, the final prediction may be obtained based on all respective prediction regions for all the block regions 3302 in the current block.

In some examples, as shown in FIG. 34, the final prediction may be obtained based on all respective prediction regions for all the block regions 3401, 3402, 3403, and 3404 in the current block.

In some examples, subblock intra TMP is always applied if the prediction block is coded with intra TMP mode. When the current block is coded with the intra TMP mode, the processor 1620 may apply or conduct the subblock intra TMP, i.e., Step 3701 to Step 3704, to the current block when the current block is coded with the intra TMP mode.

In some examples, if intra TMP is used for the prediction block, an additional flag is signaled to indicate whether subblock intra TMP is utilized. The processor 1620 may signal a syntax element, i.e., a flag, to indicate whether the subblock intra TMP is utilized. When the current block is coded with the intra TMP mode, the processor 1620 may apply or conduct the subblock intra TMP, i.e., Step 3701 to Step 3704, to the current block.

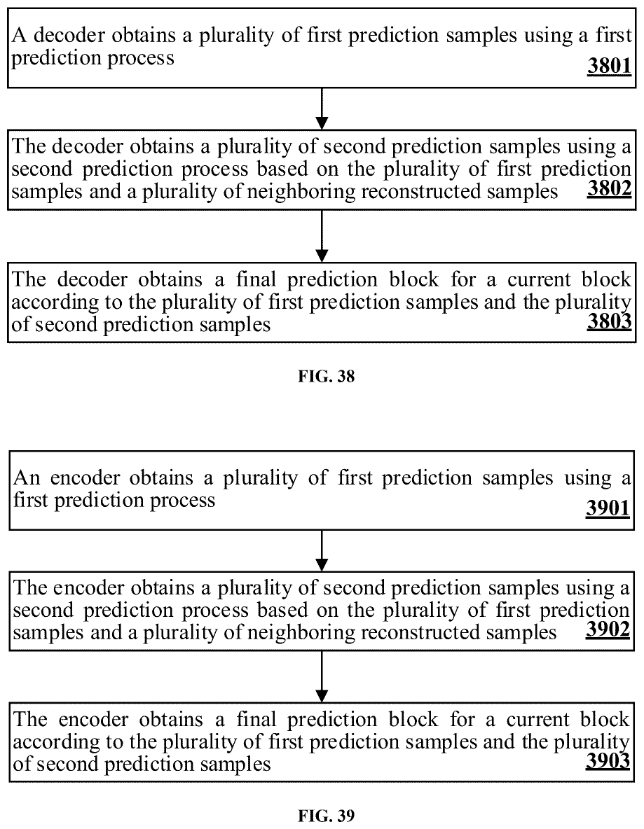

FIG. 38 is a flowchart illustrating a method for video decoding according to an example of the present disclosure. Specifically, FIG. 38 shows methods discussed in the section of “Two stage combination of intra and intra TMP.”

In Step 3801, the processor 1620, at the side of a decoder, may obtain a plurality of first prediction samples using a first prediction process.

In some examples, the first prediction process may be an intra TMP mode. For example, the plurality of first prediction samples, i.e., the first subsets of the predictors, may be generated by the first prediction process, e.g., intra TMP mode, shown as the bottom-right predictors/prediction samples/prediction pixels in FIGS. 35A-35B.

In Step 3802, the processor 1620 may obtain a plurality of second prediction samples using a second prediction process based on the plurality of first prediction samples and a plurality of neighboring reconstructed samples.

In some examples, the first prediction process may be a planar mode, an angular intra mode, or switching between the planar mode or the angular intra mode.

In one example, a second prediction sample may be obtained by weighting two projected neighboring reconstructed samples and two projected first prediction samples, as shown in FIG. 35A. For example, the two projected neighboring reconstructed samples may the two neighboring reconstructed samples 3510, 3511 indicated by two arrows, and the two projected first prediction samples may be the two first prediction samples 3520, 3521 indicated by two arrows.

In this example, the neighboring prediction samples may be denoted as p[x][y], with x=−1, y=−1 . . . height and x=0 . . . width, y=−1.

$$p [ x ] [ y ] = ( w 0 [ x ] [ y ] * p [ x ] [ - 1 ] + w 1 [ x ] [ y ] * p [ x ] [ height - 1 ] + w 2 [ x ] [ y ] * p [ - 1 ] [ y ] + w 3 [ x ] [ y ] * p [ width - 1 ] [ y ] ) / N$$

Width and height are the width and height of the current prediction block. w0, w1, w2 and w3 are weighting factors which could be predefined. N is the normalization factor which is normally sum of all the weighting factors. N=w0[x][y]+w1[x][y]+w2[x][y]+w3[x][y].

In some examples, the weighting factors may be predefined as below:

$$w 0 [ x ] [ y ] = ( height - y ) , w 1 [ x ] [ y ] = y , w 2 [ x ] [ y ] = ( width - x ) , w 3 [ x ] [ y ] = x$$

In one example, a second prediction sample may be obtained by interpolating a neighboring reconstructed sample 3530 and a first prediction sample 3531, as shown in FIG. 35B. For example, the neighboring prediction samples may be denoted as p[x][y]:

$$p [ x ] [ y ] = w 1 * {r}_{1} + w 2 * {r}_{2}$$

where w0 and w1 are calculated as:

$$w 1 = \frac{d 2}{d 1 + d 2} and w 2 = \frac{d 1}{d 1 + d 2}$$

In some examples, planar mode is always used as the prediction mode of the second prediction process. If the current coding block is coded with intra mode, a syntax element is signaled to indicate the usage of the provided method. For example, the processor 1620 may receive a syntax element that indicates whether to combine the first prediction process and the second prediction process to obtain the final prediction for the current block when the current block is coded with an intra mode.

In some examples, both planar and angular modes may be selected as the prediction mode of the second prediction process. If the current coding block is coded with intra mode, a syntax element is signaled to indicate the usage of the proposed method. And another syntax element is signaled to indicate the intra prediction mode of the second prediction process. For example, the processor 1620 may receive a first syntax element that indicates whether to combine the first prediction process and the second prediction process to obtain the final prediction for the current block when the current block is coded with an intra mode. Furthermore, in response to determining that the first syntax element indicates to combine the first prediction process and the second prediction process to obtain the final prediction for the current block, the processor 1620 may receive a second syntax element to determine whether the second prediction process is a planar mode or an angular mode.

In Step 3803, the processor 1620 may obtain a final prediction block for a current block according to the plurality of first prediction samples and the plurality of second prediction samples.

As shown in FIGS. 35A-35B, the final prediction block may be composed of the plurality of first prediction samples and the plurality of second prediction samples.

FIG. 39 is a flowchart illustrating a method for video encoding corresponding the method for video decoding as shown in FIG. 38.

In Step 3901, the processor 1620, at the side of an encoder, may obtain a plurality of first prediction samples using a first prediction process.

In some examples, the first prediction process may be an intra TMP mode. For example, the plurality of first prediction samples, i.e., the first subsets of the predictors, may be generated by the first prediction process, e.g., intra TMP mode, shown as the bottom-right predictors/prediction samples/prediction pixels in FIGS. 35A-35B.

In Step 3902, the processor 1620 may obtain a plurality of second prediction samples using a second prediction process based on the plurality of first prediction samples and a plurality of neighboring reconstructed samples.

In some examples, the first prediction process may be a planar mode, an angular intra mode, or switching between the planar mode or the angular intra mode.

In one example, a second prediction sample may be obtained by weighting two projected neighboring reconstructed samples and two projected first prediction samples, as shown in FIG. 35A. For example, the two projected neighboring reconstructed samples may the two neighboring reconstructed samples 3510, 3511 indicated by two arrows, and the two projected first prediction samples may be the two first prediction samples 3520, 3521 indicated by two arrows.

In this example, the neighboring prediction samples may be denoted as p[x][y], with x=−1, y=−1 . . . height and x=0 . . . width, y=−1.

$$p [ x ] [ y ] = ( w 0 [ x ] [ y ] * p [ x ] [ - 1 ] + w 1 [ x ] [ y ] * p [ x ] [ height - 1 ] + w 2 [ x ] [ y ] * p [ - 1 ] [ y ] + w 3 [ x ] [ y ] * p [ width - 1 ] [ y ] ) / N$$

Width and height are the width and height of the current prediction block. w0, w1, w2 and w3 are weighting factors which could be predefined. N is the normalization factor which is normally sum of all the weighting factors. N=w0[x][y]+w1[x][y]+w2[x][y]+w3[x][y].

In some examples, the weighting factors may be predefined as below:

$$w 0 [ x ] [ y ] = ( height - y ) , w 1 [ x ] [ y ] = y , w 2 [ x ] [ y ] = ( width - x ) , w 3 [ x ] [ y ] = x$$

In one example, a second prediction sample may be obtained by interpolating a neighboring reconstructed sample 3530 and a first prediction sample 3531, as shown in FIG. 35B. For example, the neighboring prediction samples may be denoted as p[x][y].

$$p [ x ] [ y ] = w 1 * {r}_{1} + w 2 * {r}_{2}$$

where w0 and w1 are calculated as:

$$w 1 = \frac{d 2}{d 1 + d 2} and w 2 = \frac{d 1}{d 1 + d 2}$$

In some examples, planar mode is always used as the prediction mode of the second prediction process. If the current coding block is coded with intra mode, a syntax element is signaled to indicate the usage of the provided method. For example, the processor 3520 may signal a syntax element to indicate whether to combine the first prediction process and the second prediction process to obtain the final prediction for the current block when the current block is coded with an intra mode.

In some examples, both planar and angular modes may be selected as the prediction mode of the second prediction process. If the current coding block is coded with intra mode, a syntax element is signaled to indicate the usage of the proposed method. And another syntax element is signaled to indicate the intra prediction mode of the second prediction process. For example, the processor 1620 may signal a first syntax element to indicate whether to combine the first prediction process and the second prediction process to obtain the final prediction for the current block when the current block is coded with an intra mode. Furthermore, when the first syntax element indicates to combine the first prediction process and the second prediction process to obtain the final prediction for the current block, the processor 1620 may signal a second syntax element to indicate whether the second prediction process is a planar mode or an angular mode.

In Step 3903, the processor 1620 may obtain a final prediction block for a current block according to the plurality of first prediction samples and the plurality of second prediction samples.

As shown in FIGS. 35A-35B, the final prediction block may be composed of the plurality of first prediction samples and the plurality of second prediction samples.

### Prediction Block Candidate Derivation

The first step of multi-hypothesis intra TMP is to derive the N reference block candidates which are utilized to generate the final prediction blocks. The following several methods are provided to derive the reference block candidates for multi-hypothesis intra TMP.

In the first embodiment, the prediction block candidates are searched and selected according to the criterion of minimizing template matching cost, i.e., the top N candidates which lead to the minimum template matching cost are selected. The matching cost may be sum of the absolute difference (SAD), sum of the squared difference (SSD) or any other means to measure the similarity between two blocks.

In the second embodiment, an intermediate prediction block denoted as P is firstly derived, the intermediate prediction block is then utilized to derive the reference block candidates used for multi-hypothesis intra TMP. Several methods are proposed in this disclosure to derive the intermediate prediction block.
a) In the first method, N reference block candidates are firstly derived according to the criterion of minimizing template matching cost described in the first embodiment. The N reference block candidates are then utilized to generate the intermediate prediction block. The method to generate the intermediate prediction block can be any methods, including but not limited to the fixed and adaptive multi-hypothesis intra TMP introduced in the previous sections.
b) In the second method, the intra TMP predictor, i.e., the reference block leading to the minimum template matching cost, is directly used as the intermediate prediction block.
c) In the third method, the intermediate prediction block is decided at the encoder side by minimizing the rate-distortion cost and the block vector (BV) of the intermediate prediction block is signaled in the bitstream to the decoder.

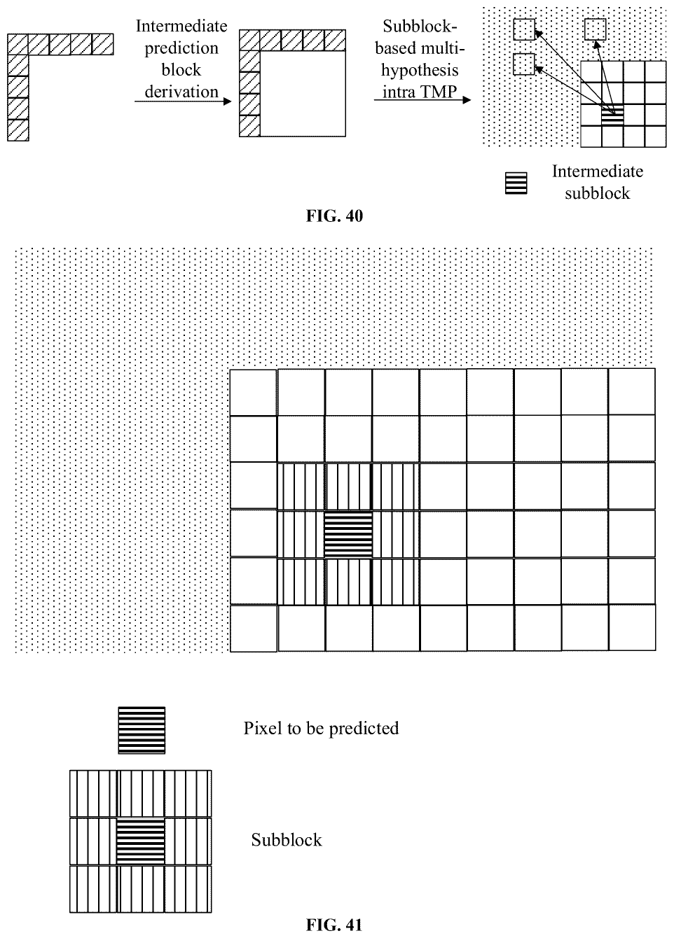

After the intermediate prediction block is identified, the intermediate prediction block is utilized to search the reference block candidates and conduct multi-hypothesis intra TMP. The following several methods are proposed to identify the reference block candidates and conduct multi-hypothesis intra TMP.
a) In the first method, the intermediate prediction block is directly used to search the N reference block candidates by minimizing the distance of the reference block and the intermediate prediction block. The top-N reference blocks leading to the minimum distance are selected as the reference block candidates. The distance may be sum of the absolute difference (SAD), sum of the squared difference (SSD) or any other means to measure the similarity between two blocks. After the reference block candidates are identified, any methods can be utilized to generate the final prediction block, including but not limited to the fixed and adaptive multi-hypothesis intra TMP methods described in the previous sections.
b) In the second method, the intermediate region (the intermediate prediction block along with the neighboring template) are directly used to search the N reference block candidates by minimizing the distance of the reference region and the intermediate region, where the reference region includes a reference block and its corresponding neighboring template. The top-N reference blocks leading to the minimum distance are selected as the reference block candidates. The distance may be sum of the absolute difference (SAD), sum of the squared difference (SSD) or any other means to measure the similarity between two blocks. After the reference block candidates are identified, any methods can be utilized to generate the final prediction block, including but not limited to the fixed and adaptive multi-hypothesis intra TMP methods described in the previous sections.
c) In the third method, the intermediate prediction block is firstly divided into several subblocks, then multi-hypothesis intra TMP is conducted based on subblock, as illustrated in FIG. 40. The subblock in the intermediate prediction block is termed as intermediate subblock in this disclosure. For each intermediate subblock, it is used to search the N reference subblock candidates by minimizing the distance of the reference subblock and the intermediate subblock. The top-N reference subblocks leading to the minimum distance are selected as the reference subblock candidates. The distance may be sum of the absolute difference (SAD), sum of the squared difference (SSD) or any other means to measure the similarity between two blocks. After the reference subblock candidates are identified, any methods can be utilized to generate the final prediction subblock, including but not limited to the fixed and adaptive multi-hypothesis intra TMP methods described in the previous sections.
d) In the fourth method, the multi-hypothesis intra TMP is conducted adaptively for each pixel in the intermediate prediction block, i.e., pixel-level multi-hypothesis intra TMP.

The following examples are provided to elaborate the pixel-level multi-hypothesis intra TMP method.

In the first example, the intermediate prediction block or the intermediate region (the intermediate prediction block along with the neighboring template) are utilized to identify the N reference block candidates. The intermediate prediction block and the N reference blocks are weighted to generate the final prediction block. The weighting factors are calculated for each pixel. Let the pixel of the k-th reference block and intermediate prediction block at (x,y) be Rₖ[x, y] and \hat{p}[x, y], respectively. The weighting factor for the pixel corresponding to the i-th reference block is calculated as:

$${ω}_{i} = \frac{1}{N} - \frac{{D}_{i}}{N \times {\sum }_{k = 0}^{N} {D}_{k}} , 0 = 1 , 2 , … , N$$

Noted that here ω₀ is the weighting factor of the intermediate prediction block. Dᵢ is the distance between the current pixel and the collocated pixel in the reference block.

Another method to calculate the weighting factor is shown as follow.

$${ω}_{i} = \frac{1}{Z} {e}^{- \frac{{D}_{i}}{{h}^{2}}} and Z = {\sum }_{i = 1}^{N} {e}^{- \frac{{D}_{i}}{{h}^{2}}}$$

Where h is used as the degree of weighting which can be fixed value or decided adaptively for each block/pixel.

In the second example, when the pixel at the position (x,y) is to be predicted, the subblock centered at (x,y) is used to find the reference subblocks for the current pixel by minimizing the distance between the current subblock and the reference subblock, as illustrated in FIG. 41. The distance between the current subblock and the reference subblock is utilized to calculate the weighting factor for the reference subblock. The two methods of calculating weighting factor in the first example may be used in this example.

In the third example, when the pixel at the position (x,y) is to be predicted, the subblock centered at (x,y) is used to find the reference subblocks for the current pixel by minimizing the distance between the current subblock and the reference subblock, as illustrated in FIG. 41. The distance between the current pixel at a centered of the current subblock and the reference pixel centered at the reference subblock is utilized to calculate the weighting factor for the reference subblock. The two methods of calculating weighting factor in the first example may be used in this example. In one or more examples, the reference subblocks or current subblock are of size (2n+1)*(2n+1), where n is a non-negative integer, so that a pixel at a center of a reference subblock or a pixel at the center of the current sublock is well defined.

In the fourth example, when the pixel at the position (x,y) is to be predicted, the subblock centered at (x,y) is used to find the reference subblocks for the current pixel by minimizing the distance between the current subblock and the reference subblock, as illustrated in FIG. 41. The current subblock and the reference subblocks are utilized to generate the prediction subblock by singular value decomposition (SVD) method introduced in the previous section. The pixel centered at the prediction subblock is used as the final predicted pixel at the position (x,y).

### Combination of IBC and Intra TMP

In this disclosure, it is provided to combine IBC and intra TMP to further improve the coding performance of intra coding. In one embodiment, intra TMP is firstly conducted to generate the first predictor of the current coding block. Then the block vector (BV) is utilized to identify the second predictor of the current coding block. The first predictor and second predictor are weighted to generate the final prediction block of the coding block.

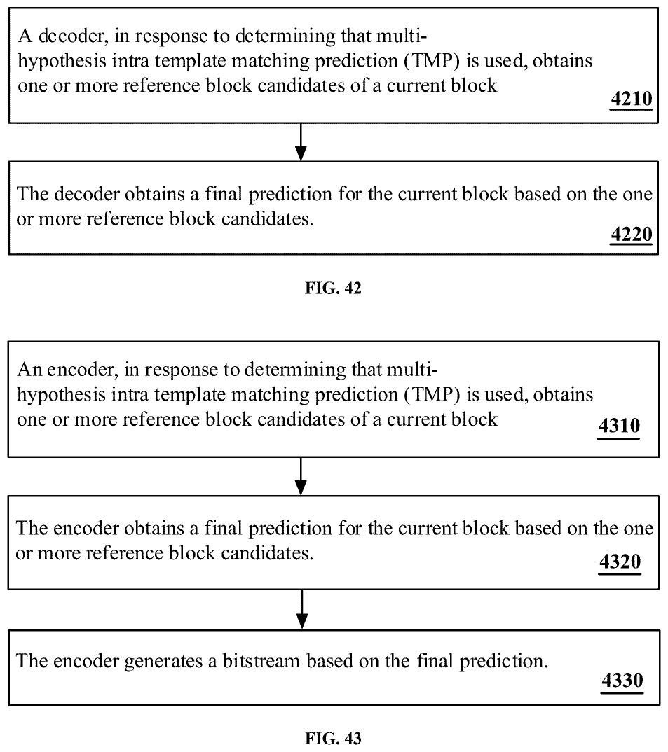

FIG. 42 is a flowchart illustrating a method for video decoding according to an example of the present disclosure. Specifically, FIG. 42 shows a method used in the multi-hypothesis intra TMP to derive reference block candidates.

In Step 4210, the processor 1620, in response to determining that multi-hypothesis intra template matching prediction (TMP) is used and at the side of a decoder, may obtain one or more reference block candidates of a current block.

In Step 4220, the processor 1620 may obtain a final prediction for the current block based on the one or more reference block candidates.

In some examples, in Step 4210, the processor 1620 may, at the side of the decoder, select one or more prediction block candidates based on minimizing a template matching cost, where template matching cost of the one or more prediction block candidates is less than template matching costs of other prediction block candidates; and set the one or more reference block candidates as the one or more prediction block candidates.

In some examples, the template matching cost includes a sum of absolute differences (SAD), a sum of squared differences (SSD), or a sum of other values that measure a similarity between two blocks. For example, the template matching cost may be a total template matching cost, where the total template matching cost may be obtained by:

$${cost}_{total} = {cost}_{Y} + ω \times ( {cost}_{Cb} + {cost}_{Cr} )$$

where ω may be a predefined empirical value.

In some examples, the processor 1620 may, at the side of the decoder, further obtain an intermediate prediction block. In some examples, in Step 4210, the processor 1620 may derive the one or more reference block candidates based on the intermediate prediction block. For instance, the intermediate prediction block may be generated with an existing multi-hypothesis intra TMP method.

In one or more examples, to obtain the intermediate prediction block, the processor 1620 may, at the side of the decoder, search for one or more intermediate reference block candidates, where template matching cost of the one or more intermediate reference block candidates is lower than template matching costs of other block candidates, and generate the intermediate prediction block based on the one or more intermediate reference block candidates. Here, the intermediate reference block may be obtained with an existing method. In some examples, the intermediate prediction block may be generated using a fixed multi-hypothesis intra TMP or an adaptive multi-hypothesis intra TMP.

In one or more examples, to obtain the intermediate prediction block, the processor 1620 may, at the side of the decoder, set the intermediate prediction block as a reference block, where a template matching cost of the reference block is lower than template matching costs of other reference blocks.

In one or more examples, to obtain the intermediate prediction block, the processor 1620 may, at the side of the decoder, receive a block vector (BV) corresponding to the intermediate prediction block signaled in a bitstream, where a rate-distortion cost of the intermediate prediction block is lower than rate-distortion costs of other prediction blocks. In some examples, the BV is configured to indicate the intermediate prediction block.

In one or more examples, to derive the one or more reference block candidates based on the intermediate prediction block, the processor 1620 may, at the side of the decoder, obtain one or more reference blocks, where distances between the one or more references blocks and the intermediate prediction block are less than distances between other reference blocks and the intermediate prediction block; and set the one or more reference block candidates as the one or more reference blocks.

In one or more examples, to derive the one or more reference block candidates based on the intermediate prediction block, the processor 1620 may, at the side of the decoder, obtain an intermediate region including the intermediate prediction block and a neighboring template corresponding to the intermediate prediction block, obtain one or more reference regions corresponding to one or more reference blocks where each of the one or more reference regions includes a reference block and a neighboring template corresponding to the reference block, obtain one or more reference blocks where distances between the one or more references regions containing the one or more reference blocks and the intermediate region are less than distances between other reference regions and the intermediate region, and set the one or more reference block candidates as the one or more reference blocks.

In one or more examples, the processor 1620 may, at the side of the decoder, further divide the intermediate prediction block into a plurality of intermediate subblocks; further, the processor 1620 may, at the side of the decoder and for each one of the plurality of intermediate subblocks, obtain one or more reference subblocks, where distances between the one or more reference subblocks and the one of the plurality of intermediate subblocks are less than distances between other reference subblocks and the one of the plurality of intermediate subblocks; and select the one or more reference subblocks as one or more reference subblock candidates. In one or more examples, the processor 1620 may obtain a final prediction for a current subblock using the one or more reference subblock candidates.

In one or more examples, a distance includes a sum of absolute differences (SAD), a sum of squared differences (SSD), or a sum of other values that measure a similarity between two blocks. In one or more examples, in Step 4220, the processor 1620 may, at the side of the decoder, obtain the final prediction for the current block based on the one or more reference block candidates and using a fixed multi-hypothesis intra TMP or an adaptive multi-hypothesis intra TMP.

In some examples, the intermediate prediction block includes one or more pixels, and the multi-hypothesis intra TMP includes a pixel-level multi-hypothesis intra TMP. In one or more examples, the processor 1620 may, at the side of the decoder, further determine one or more weighting factors, and in the Step 4220, the processor 1620 may obtain the final prediction for the current block based on the one or more reference block candidates, the multi-hypothesis intra TMP, and the one or more weighting factors.

In one or more examples, the one or more weighting factors correspond to one or more reference pixels in one or more reference blocks, and to determine the one or more weighting factors, the processor 1620 may, at the side of the decoder, obtain one or more distances, where each of the one or more distances is a distance between a current pixel and a collocated pixel in one of the one or more reference blocks; and compute the one or more weighting factors based on the one or more distances.

In one or more examples, the one or more weighting factors correspond to one or more reference pixels in one or more reference subblocks, and to determine the one or more weighting factors, the processor 1620 may, at the side of the decoder, obtain a current subblock, where the current subblock is centered at a current pixel; obtain the one or more reference subblocks, where distances between the one or more reference subblocks and the current subblock are less than distances between other reference subblocks and the current subblock; and compute the one or more weighting factors based on the distances between the one or more reference subblocks and the current subblock.

In one or more examples, the one or more weighting factors correspond to one or more reference pixels in one or more reference subblocks, and to determine the one or more weighting factors, the processor 1620 may, at the side of the decoder, obtain a current subblock, where the current subblock is centered at a current pixel; obtain the one or more reference subblocks, where distances between central pixels of the one or more reference subblocks and the current pixel are less than distances between central pixels of other reference subblocks and the current pixel; and compute the one or more weighting factors based on the distances between the central pixels of the one or more reference subblocks and the current pixel.

In some examples, to compute the one or more weighting factors, the processor 1620 may, at the side of the decoder, further compute the one or more weighting factors based on the one or more distances and a degree of weighting, where the degree of weighting is one of a fixed value or an adaptively decided value.

In some examples, the processor 1620 may, at the side of the decoder, further obtain a current subblock, where the current subblock is centered at a current pixel; and obtain one or more reference subblocks, where distances between the one or more reference subblocks and the current subblock are less than distances between other reference subblocks and the current subblock. In one or more examples, In Step 4220, the processor 1620 may, at the side of the decoder, generate using singular value decomposition (SVD) a prediction subblock based on the current subblock and the one or more reference subblocks; and set a pixel at a center of the prediction subblock as a final prediction for the current pixel corresponding to the current subblock.

FIG. 43 is a flowchart illustrating a method for video encoding corresponding the method for video decoding as shown in FIG. 42.

In Step 4310, the processor 1620, in response to determining that multi-hypothesis intra template matching prediction (TMP) is used and at the side of an encoder, may obtain one or more reference block candidates of a current block.

In Step 4320, the processor 1620 may obtain a final prediction for the current block based on the one or more reference block candidates.

In Step 4330, the processor 1620 may generate a bitstream based on the final prediction.

In some examples, in Step 4310, the processor 1620 may, at the side of the encoder, select one or more prediction block candidates based on minimizing a template matching cost, where template matching cost of the one or more prediction block candidates is less than template matching costs of other prediction block candidates; and set the one or more reference block candidates as the one or more prediction block candidates.

In some examples, the template matching cost includes a sum of absolute differences (SAD), a sum of squared differences (SSD), or a sum of other values that measure a similarity between two blocks. For example, the template matching cost may be a total template matching cost, where the total template matching cost may be obtained by:

$${cost}_{total} = {cost}_{Y} + ω \times ( {cost}_{Cb} + {cost}_{Cr} )$$

where ω may be a predefined empirical value.

In some examples, the processor 1620 may, at the side of the encoder, further obtain an intermediate prediction block. In some examples, in Step 4310, the processor 1620 may derive the one or more reference block candidates based on the intermediate prediction block.

In one or more examples, to obtain the intermediate prediction block, the processor 1620 may, at the side of the encoder, search for one or more intermediate reference block candidates, where template matching cost of the one or more intermediate reference block candidates is lower than template matching costs of other block candidates, and generate the intermediate prediction block based on the one or more intermediate reference block candidates. In some examples, the intermediate prediction block may be generated using a fixed multi-hypothesis intra TMP or an adaptive multi-hypothesis intra TMP.

In one or more examples, to obtain the intermediate prediction block, the processor 1620 may, at the side of the encoder, set the intermediate prediction block as a reference block, where a template matching cost of the reference block is lower than template matching costs of other reference blocks.

In one or more examples, to obtain the intermediate prediction block, the processor 1620 may, at the side of the encoder, signal a block vector (BV) corresponding to the intermediate prediction block in a bitstream, where a rate-distortion cost of the intermediate prediction block is lower than rate-distortion costs of other prediction blocks. In some examples, the BV is configured to indicate the intermediate prediction block.

In one or more examples, to derive the one or more reference block candidates based on the intermediate prediction block, the processor 1620 may, at the side of the encoder, obtain one or more reference blocks, where distances between the one or more references blocks and the intermediate prediction block are less than distances between other reference blocks and the intermediate prediction block; and set the one or more reference block candidates as the one or more reference blocks.

In one or more examples, to derive the one or more reference block candidates based on the intermediate prediction block, the processor 1620 may, at the side of the encoder, obtain an intermediate region including the intermediate prediction block and a neighboring template corresponding to the intermediate prediction block, obtain one or more reference regions corresponding to one or more reference blocks where each of the one or more reference regions includes a reference block and a neighboring template corresponding to the reference block, obtain one or more reference blocks where distances between the one or more references regions containing the one or more reference blocks and the intermediate region are less than distances between other reference regions and the intermediate region, and set the one or more reference block candidates as the one or more reference blocks.

In one or more examples, the processor 1620 may, at the side of the encoder, further divide the intermediate prediction block into a plurality of intermediate subblocks; further, the processor 1620 may, at the side of the encoder and for each one of the plurality of intermediate subblocks, obtain one or more reference subblocks, where distances between the one or more reference subblocks and one of the plurality of intermediate subblocks are less than distances between other reference subblocks and the one of the plurality of intermediate subblocks; and select the one or more reference subblocks as one or more reference subblock candidates. In one or more examples, the processor 1620 may obtain a final prediction for a current subblock using the one or more reference subblock candidates.

In one or more examples, a distance includes a sum of absolute differences (SAD), a sum of squared differences (SSD), or a sum of other values that measure a similarity between two blocks. In one or more examples, in Step 4320, the processor 1620 may, at the side of the encoder, obtain the final prediction for the current block based on the one or more reference block candidates and using a fixed multi-hypothesis intra TMP or an adaptive multi-hypothesis intra TMP.

In some examples, the intermediate prediction block includes one or more pixels, and the multi-hypothesis intra TMP includes a pixel-level multi-hypothesis intra TMP. In one or more examples, the processor 1620 may, at the side of the encoder, further determine one or more weighting factors, and in the Step 4320, the processor 1620 may obtain the final prediction for the current block based on the one or more reference block candidates, the multi-hypothesis intra TMP, and the one or more weighting factors.

In one or more examples, the one or more weighting factors correspond to one or more reference pixels in one or more reference blocks, and to determine the one or more weighting factors, the processor 1620 may, at the side of the encoder, obtain one or more distances, where each of the one or more distances is a distance between a current pixel and a collocated pixel in one of the one or more reference blocks; and compute the one or more weighting factors based on the one or more distances.

In one or more examples, the one or more weighting factors correspond to one or more reference pixels in one or more reference subblocks, and to determine the one or more weighting factors, the processor 1620 may, at the side of the encoder, obtain a current subblock, where the current subblock is centered at a current pixel; obtain the one or more reference subblocks, where distances between the one or more reference subblocks and the current subblock are less than distances between other reference subblocks and the current subblock; and compute the one or more weighting factors based on the distances between the one or more reference subblocks and the current subblock.

In one or more examples, the one or more weighting factors correspond to one or more reference pixels in one or more reference subblocks, and to determine the one or more weighting factors, the processor 1620 may, at the side of the encoder, obtain a current subblock, where the current subblock is centered at a current pixel; obtain the one or more reference subblocks, where distances between central pixels of the one or more reference subblocks and the current pixel are less than distances between central pixels of other reference subblocks and the current pixel; and compute the one or more weighting factors based on the distances between the central pixels of the one or more reference subblocks and the current pixel.

In some examples, to compute the one or more weighting factors, the processor 1620 may, at the side of the encoder, further compute the one or more weighting factors based on the one or more distances and a degree of weighting, where the degree of weighting is one of a fixed value or an adaptively decided value.

In some examples, the processor 1620 may, at the side of the encoder, further obtain a current subblock, where the current subblock is centered at a current pixel; and obtain one or more reference subblocks, where distances between the one or more reference subblocks and the current subblock are less than distances between other reference subblocks and the current subblock. In one or more examples, In Step 4320, the processor 1620 may, at the side of the encoder, generate using singular value decomposition (SVD) a prediction subblock based on the current subblock and the one or more reference subblocks; and a pixel at a center of the prediction subblock as final prediction for the current pixel corresponding to the current subblock.

In some examples, there is provided an apparatus for video coding. The apparatus includes a processor 1620 and a memory 1640 configured to store instructions executable by the processor; where the processor, upon execution of the instructions, is configured to perform any method as illustrated in FIGS. 14-17, 25-32, 36-39, and 42-43.

In an embodiment, there is also provided a non-transitory computer-readable storage medium comprising a plurality of programs, for example, in the memory 1630, executable by the processor 1620 in the computing environment 1610, for performing the above-described methods and/or storing a bitstream generated by the encoding method described above or a bitstream to be decoded by the decoding method described above. In one example, the plurality of programs may be executed by the processor 1620 in the computing environment 1610 to receive (for example, from the video encoder 20 in FIG. 2) a bitstream or data stream including encoded video information (for example, video blocks representing encoded video frames, and/or associated one or more syntax elements, etc.), and may also be executed by the processor 1620 in the computing environment 1610 to perform the decoding method described above according to the received bitstream or data stream. In another example, the plurality of programs may be executed by the processor 1620 in the computing environment 1610 to perform the encoding method described above to encode video information (for example, video blocks representing video frames, and/or associated one or more syntax elements, etc.) into a bitstream or data stream, and may also be executed by the processor 1620 in the computing environment 1610 to transmit the bitstream or data stream (for example, to the video decoder 30 in FIG. 3). Alternatively, the non-transitory computer-readable storage medium may have stored therein a bitstream or a data stream comprising encoded video information (for example, video blocks representing encoded video frames, and/or associated one or more syntax elements etc.) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

In an embodiment, the is also provided a computing device comprising one or more processors (for example, the processor 1620); and the non-transitory computer-readable storage medium or the memory 1630 having stored therein a plurality of programs executable by the one or more processors, where the one or more processors, upon execution of the plurality of programs, are configured to perform the above-described methods.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 1630, executable by the processor 1620 in the computing environment 1610, for performing the above-described methods. For example, the computer program product may include the non-transitory computer-readable storage medium.

In an embodiment, the computing environment 1610 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

In an embodiment, there is also provided a method of storing a bitstream, comprising storing the bitstream on a digital storage medium, where the bitstream includes encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

Various aspects of the present invention may be appreciated from the following Enumerated Example Embodiments (EEEs).

EEE 1_1. A method for video decoding, comprising: obtaining, by a decoder, a current template of a current coding unit (CU) coded with Intra template matching prediction (TMP) mode; obtaining, by the decoder, an optimal integer predicted template; obtaining, by the decoder, fractional-pel predicted templates; and obtaining, by the decoder, a final prediction for the current CU based on distances between the current template and the optimal integer predicted template and the fractional-pel predicted templates.

EEE 1_2. The method of EEE 1_1, wherein the fractional-pel predicted templates comprise at least one of half-pel templates or quarter-pel templates.

EEE 1_3. The method of EEE 1_1, further comprising: obtaining, by the decoder, an index value signaled in a bitstream, wherein the index value indicates an interpolation accuracy.

EEE 1_4. The method of EEE 1_3, wherein obtaining, by the decoder, fractional-pel predicted templates comprises: obtaining, by the decoder, the fractional-pel predicted templates based on the interpolation accuracy.

EEE 1_5. The method of EEE 1_3, wherein the index value is signaled at a particular level comprising Picture Parameter Set (PPS), Sequence Parameter Set (SPS), or slice header.

EEE 1_6. The method of EEE 1_1, wherein obtaining, by the decoder, the fractional-pel predicted templates comprises: interpolating, by the decoder, fractional templates surrounding the optimal integer predicted template; and wherein obtaining, by the decoder, the final prediction for the current CU comprises: conducting, by the decoder, template matchings.

EEE 1_7 The method of EEE 1_6, wherein interpolating, by the decoder, the fractional templates surrounding the optimal integer predicted template comprises: interpolating, by the decoder, eight half-pel predicted templates.

EEE 1_8. The method of EEE 1_6, wherein conducting, by the decoder, the template matchings comprise: computing, by the decoder, a first distance between a current template and the optimal integer predicted template; computing, by the decoder, several second distances between the current template and the fractional-pel predicted templates; comparing, by the decoder, the first distance and the several second distances; identifying, by the decoder, an optimal predicted template leading to a minimum template matching cost based on a result of comparing, by the decoder, the first distance and the several second distances, and a predicted CU corresponding to the optimal predicted template; and setting, by the decoder, the predicted CU as the final prediction.

EEE 1_9. A method for video encoding, comprising: encoding, by an encoder, a current template of a current coding unit (CU) coded with Intra template matching prediction (TMP) mode; obtaining, by the encoder, an optimal integer predicted template; obtaining, by the encoder, fractional-pel predicted templates; obtaining, by the encoder, a final prediction for the current CU based on distances between the current template and the optimal integer predicted template and the fractional-pel predicted templates; and transmitting, by the encoder, the current CU that is coded based on the Intra TMP mode to a decoder.

EEE 1_10. The method of EEE 19, wherein the fractional-pel predicted templates comprise at least one of half-pel templates or quarter-pel templates.

EEE 1_11. The method of EEE 19, further comprising: signaling, by the encoder, an index value in a bitstream, wherein the index value indicates an interpolation accuracy.

EEE 1_12. The method of EEE 1_11, further comprising: obtaining, by the encoder, the fractional-pel predicted templates based on the interpolation accuracy.

EEE 1_13. The method of EEE 111, wherein the index value is signaled at a particular level comprising Picture Parameter Set (PPS), Sequence Parameter Set (SPS), or slice header.

EEE 1_14. The method of EEE 19, wherein obtaining, by the encoder, the fractional-pel predicted templates comprises: interpolating, by the encoder, fractional templates surrounding the optimal integer predicted template; and wherein obtaining, by the encoder, the final prediction for the current CU comprises: conducting, by the encoder, template matchings.

EEE 1_15 The method of EEE 1_14, wherein interpolating, by the encoder, the fractional templates surrounding the optimal integer predicted template comprises: interpolating, by the encoder, eight half-pel predicted templates.

EEE 1_16. The method of EEE 1_14, wherein conducting, by the encoder, the template matchings comprise: computing, by the encoder, a first distance between a current template and the optimal integer predicted template; computing, by the encoder, second distances between the current template and the fractional-pel predicted templates; comparing, by the encoder, the first distance and the second distances; identifying, by the encoder, an optimal predicted template leading to a minimum template matching cost based on a result of comparing, by the decoder, the first distance and the several second distances, and a predicted CU corresponding to the optimal predicted template; and setting, by the encoder, the predicted CU as the final prediction.

EEE 1_17. A method for video decoding, comprising: obtaining, by a decoder, a current coding unit (CU) coded based on an Intra template matching prediction (TMP) mode; obtaining, by the decoder, a plurality of prediction CU candidates; and obtaining, by the decoder, a final prediction for the current CU based on the plurality of prediction CU candidates.

EEE 1_18. The method of EEE 1_17, further comprising: obtaining, by the decoder, a plurality of weights corresponding to the plurality of prediction CU candidates; and wherein obtaining, by the decoder, a final prediction for the current CU based on the plurality of prediction CU candidates comprises: obtaining, by the decoder, the final prediction for the current CU based on the plurality of prediction CU candidates and the plurality of weights.

EEE 1_19. The method of EEE 1_17, wherein obtaining, by the decoder, the plurality of prediction CU candidates comprises: searching, by the decoder, for a plurality of CU candidates with template matching cost lower than template matching cost of other candidates; and selecting, by the decoder, the plurality of CU candidates as the plurality of prediction CU candidates.

EEE 1_20. The method of EEE 1_19, wherein the template matching costs are measured with one of sum of absolute difference (SAD) or sum of square error (SSE).

EEE 1_21. The method of EEE 1_18, wherein obtaining, by the decoder, the plurality of weights corresponding to the plurality of prediction CU candidates comprises: setting each of the plurality of weights to be a reciprocal of an integer N, wherein N is a number of the plurality of prediction CU candidates.

EEE 1_22. The method of EEE 1_18, wherein obtaining, by the decoder, the plurality of weights corresponding to the plurality of prediction CU candidates comprises: computing, by the decoder, the plurality of weights based on a plurality of template matching costs.

EEE 1_23. The method of EEE 122, wherein obtaining, by the decoder, the plurality of weights corresponding to the plurality of prediction CU candidates further comprises: obtaining a plurality of prediction CU template matching costs of the plurality of prediction CU candidates as the plurality of template matching costs.

EEE 1_24. The method of EEE 1_22, wherein the plurality of template matching costs is measured with one of sum of absolute difference (SAD) or sum of square error (SSE).

EEE 1_25. The method of EEE 1_18, wherein obtaining, by the decoder, the plurality of weights corresponding to the plurality of prediction CU candidates comprises: receiving, by the decoder, the plurality of weights signaled in a bitstream by an encoder.

EEE 1_26. The method of EEE 1_18, wherein obtaining, by the decoder, the plurality of weights corresponding to the plurality of prediction CU candidates comprises: obtaining, by the decoder, the plurality of weights based on a plurality of templates.

EEE 1_27. The method of EEE 1_26, wherein obtaining, by the decoder, the plurality of weights corresponding to the plurality of prediction CU candidates further comprises: obtaining a plurality of prediction CU templates of the plurality of prediction CU candidates as the plurality of templates; and obtaining a current CU template of the current CU; wherein obtaining, by the decoder, the plurality of weights based on a plurality of templates comprises: obtaining the plurality of weights based on the plurality of prediction CU templates and the current CU template.

EEE 1_28. The method of EEE 1_18, wherein obtaining, by the decoder, the plurality of weights corresponding to the plurality of prediction CU candidates further comprises: obtaining, by the decoder and using nonlocal mean filtering, the plurality of weights.

EEE 1_29. The method of EEE 128, wherein obtaining, by the decoder and using the nonlocal mean filtering, the plurality of weights comprises: obtaining a plurality of distances based on the plurality of prediction CU candidates and the current CU; and obtaining the plurality of weights based on the plurality of distances and a strength of weighting.

EEE 1_30. The method of EEE 1_29, wherein before obtaining, by the decoder, the plurality of weights corresponding to the plurality of prediction CU candidates, the method further comprises: determining, by the decoder, the strength of weighting.

EEE 1_31. The method of EEE 1_30, wherein determining, by the decoder, the strength of weighting comprises: defining and fixing, by the decoder, a weighting strength candidate list comprising a plurality of typical weighting strength values; and selecting, by the decoder, a typical weight strength value as an optimal weighting strength value based on a flag signaled in a bitstream.

EEE 1_32. The method of EEE 130, wherein determining, by the decoder, the strength of weighting comprises: receiving, by the decoder, an optimal weighting strength value identified by an encoder and signaled in a bitstream.

EEE 1_33. The method of EEE 1_30, wherein determining, by the decoder, the strength of weighting comprises: obtaining, by the decoder, a plurality of prediction CU templates of the plurality of prediction CU candidates; obtaining, by the decoder, a current CU template of the current CU; and estimating, by the decoder, the strength of weighting based on the plurality of prediction CU templates and the current CU template.

EEE 1_34. The method of EEE 1_30, wherein determining, by the decoder, the strength of weighting comprises: estimating, by the decoder, the strength of weighting, using a Quantization Parameter (QP) value and a variance of a current CU template of the current CU.

EEE 1_35. The method of EEE 1_34, further comprising: fitting, by the decoder, the strength of weighting, a relationship between the QP value, and the variance of the current CU template offline.

EEE 1_36. The method of EEE 1_17, wherein obtaining, by the decoder, the final prediction for the current CU based on the plurality of prediction CU candidates comprises: performing, by the decoder, singular value decomposition (SVD) on a matrix generated from the plurality of prediction CU candidates; and obtaining, by the decoder, the final prediction based on results of performing the SVD.

EEE 1_37. The method of EEE 1_36, wherein performing, by the decoder, the SVD on the matrix generated from the plurality of prediction CU candidates comprises: obtaining a block group matrix based on the plurality of prediction CU candidates; performing the SVD on the block group matrix, and obtaining a first decomposition result matrix, a second decomposition result matrix, and a third decomposition result matrix; obtaining a fourth decomposition result matrix from the second decomposition result matrix; performing an inverse SVD on the first decomposition result matrix, the third decomposition result matrix, and the fourth decomposition result matrix, and obtaining a filtered patch group; and wherein obtaining, by the decoder, the final prediction based on the results of performing the SVD comprises: obtaining the final prediction for the current CU based on the filtered patch group.

EEE 1_38. The method of EEE 137, wherein obtaining the fourth decomposition result matrix from the second decomposition result matrix comprises: applying soft-thresholding operation on the second decomposition result matrix.

EEE 1_39. The method of EEE 1_38, wherein applying the soft-thresholding operation on the second decomposition result matrix comprises: determining a plurality of thresholding values corresponding to diagonal elements of the second decomposition result matrix.

EEE 1_40. The method of EEE 1_17, further comprising: receiving, by the decoder, a flag signaled in a bitstream, wherein the flag indicates that multi-hypothesis intra TMP mode is applied to the current CU.

EEE 1_41. The method of EEE 1_40, further comprising: receiving, by the decoder, an index signaled in the bitstream, wherein the index indicates a multi-hypothesis intra TMP method applied to the current CU.

EEE 1_42. A method for video encoding, comprising: encoding, by an encoder, a current coding unit (CU) based on an Intra template matching prediction (TMP) mode; obtaining, by the encoder, a plurality of prediction CU candidates; obtaining, by the encoder, a final prediction for the current CU based on the plurality of prediction CU candidates; and transmitting, by the encoder, the current CU that is coded based on the Intra TMP mode to a decoder.

EEE 1_43. The method of EEE 1_42, further comprising: obtaining, by the encoder, a plurality of weights corresponding to the plurality of prediction CU candidates; and obtaining, by the encoder, the final prediction for the current CU based on the plurality of prediction CU candidates and the plurality of weights.

EEE 1_44. The method of EEE 1_42, wherein obtaining, by the encoder, the plurality of prediction CU candidates comprises: searching, by the encoder, for a plurality of CU candidates with template matching cost lower than template matching cost of other candidates; and selecting, by the encoder, the plurality of CU candidates as the plurality of prediction CU candidates.

EEE 1_45. The method of EEE 1_44, wherein the template matching costs are measured with one of sum of absolute difference (SAD) or sum of square error (SSE).

EEE 1_46. The method of EEE 1_43, wherein obtaining, by the encoder, the plurality of weights corresponding to the plurality of prediction CU candidates comprises: setting each of the plurality of weights to be a reciprocal of an integer N, wherein N is a number of the plurality of prediction CU candidates.

EEE 1_47. The method of EEE 1_43, wherein obtaining, by the encoder, the plurality of weights corresponding to the plurality of prediction CU candidates comprises: computing, by the encoder, the plurality of weights based on a plurality of template matching costs.

EEE 1_48. The method of EEE 1_47, wherein computing, by the encoder, the plurality of weights based on the plurality of template matching costs comprises: obtaining a plurality of prediction CU template matching costs of the plurality of prediction CU candidates; and obtaining the plurality of weights based on the plurality of prediction CU template matching costs.

EEE 1_49. The method of EEE 147, wherein the plurality of template matching costs is measured with one of sum of absolute difference (SAD) or sum of square error (SSE).

EEE 1_50: The method of EEE 1_43, wherein obtaining, by the encoder, the plurality of weights corresponding to the plurality of prediction CU candidates comprises: obtaining, by the encoder, the plurality of weights based on the plurality of prediction CU candidates and the current CU; and signaling, by the encoder and in a bitstream, the plurality of weights.

EEE 1_51. The method of EEE 1_43, wherein obtaining, by the encoder, the plurality of weights corresponding to the plurality of prediction CU candidates comprises: obtaining, by the encoder, the plurality of weights based on a plurality of templates.

EEE 1_52. The method of EEE 1_51, wherein obtaining, by the encoder, the plurality of weights based on the plurality of templates comprises: obtaining a plurality of prediction CU templates of the plurality of prediction CU candidates; obtaining a current CU template of the current CU; and obtaining the plurality of weights based on the plurality of prediction CU templates and the current CU template.

EEE 1_53. The method of EEE 1_43, wherein obtaining, by the encoder, the plurality of weights corresponding to the plurality of prediction CU candidates further comprises: obtaining, by the encoder and using nonlocal mean filtering, the plurality of weights.

EEE 1_54. The method of EEE 153, wherein obtaining, by the encoder and using the nonlocal mean filtering, the plurality of weights comprises: obtaining a plurality of distances based on the plurality of prediction CU candidates and the current CU; and obtaining the plurality of weights based on the plurality of distances and a strength of weighting.

EEE 1_55. The method of EEE 1_54, wherein before obtaining, by the encoder, the plurality of weights corresponding to the plurality of prediction CU candidates, the method further comprises: determining, by the encoder, the strength of weighting.

EEE 1_56. The method of EEE 1_55, wherein determining, by the encoder, the strength of weighting comprises: defining and fixing, by the encoder, a weighting strength candidate list comprising a plurality of typical weighting strength values; checking, by the encoder, the plurality of typical weighting strength values using rate distortion optimization; identifying, by the encoder, an optimal weighting strength value; and signaling, by the encoder and in a bitstream, the optimal weighting strength value.

EEE 1_57. The method of EEE 155, wherein determining, by the encoder, the strength of weighting comprises: obtaining, by the encoder, a plurality of prediction CU templates of the plurality of prediction CU candidates; obtaining, by the encoder, a current CU template of the current CU; and estimating, by the encoder, the strength of weighting based on the plurality of prediction CU templates and the current CU template.

EEE 1_58. The method of EEE 1_55, wherein determining, by the encoder, the strength of weighting comprises: estimating, by the encoder, the strength of weighting, using a Quantization Parameter (QP) value and a variance of a current CU template of the current CU.

EEE 1_59. The method of EEE 1_58, further comprising: fitting, by the encoder, the strength of weighting, a relationship between the QP value, and the variance of the current CU template offline.

EEE 1_60. The method of EEE 1_42, wherein obtaining, by the encoder, the final prediction for the current CU based on the plurality of prediction CU candidates comprises: performing, by the encoder, singular value decomposition (SVD) on a matrix generated from the plurality of prediction CU candidates; and obtaining, by the encoder, the final prediction based on results of performing the SVD.

EEE 1_61. The method of EEE 1_60, wherein performing, by the encoder, the SVD on the matrix generated from the plurality of prediction CU candidates comprises: obtaining a block group matrix based on the plurality of prediction CU candidates; performing the SVD on the block group matrix, and obtaining a first decomposition result matrix, a second decomposition result matrix, and a third decomposition result matrix; obtaining a fourth decomposition result matrix from the second decomposition result matrix; performing an inverse SVD on the first decomposition result matrix, the fourth decomposition result matrix, and the third decomposition result matrix, and obtaining a filtered patch group; and wherein obtaining, by the encoder, the final prediction based on the results of performing the SVD comprises: obtaining the final prediction for the current CU based on the filtered patch group.

EEE 1_62. The method of EEE 161, wherein obtaining the fourth decomposition result matrix from the second decomposition result matrix comprises: applying soft-thresholding operation on the second decomposition result matrix.

EEE 1_63. The method of EEE 1_62, wherein applying the soft-thresholding operation on the second decomposition result matrix further comprises: determining a plurality of thresholding values corresponding to diagonal elements of the second decomposition result matrix.

EEE 1_64. The method of EEE 1_42, further comprising: receiving, by the encoder, a flag signaled in a bitstream, wherein the flag indicates that multi-hypothesis intra TMP mode is applied to the current CU.

EEE 1_65. The method of EEE 1_64, further comprising: receiving, by the encoder, an index signaled in the bitstream, wherein the index indicates a multi-hypothesis intra TMP method applied to the current CU.

EEE 1_66. An apparatus for video decoding, comprising: one or more processors; and a memory coupled to the one or more processors and configured to store instructions executable by the one or more processors, wherein the one or more processors, upon execution of the instructions, are configured to perform the method in any one of EEEs 1_1-1_8 and 1_17-1_41.

EEE 1_67. An apparatus for video encoding, comprising: one or more processors; and a memory coupled to the one or more processors and configured to store instructions executable by the one or more processors, wherein the one or more processors, upon execution of the instructions, are configured to perform the method in any one of EEEs 1_9-1_16 and 1_42-1_65.

EEE 1_68. A non-transitory computer-readable storage medium for storing computer-executable instructions that, when executed by one or more computer processors, cause the one or more computer processors to perform the method in any of EEEs 1_1-1_8 and 1_17-1_41.

EEE 1_69. A non-transitory computer-readable storage medium for storing computer-executable instructions that, when executed by one or more computer processors, cause the one or more computer processors to perform the method in any of EEEs 1_9-1_16 and 1_42-1_65.

EEE 1_70. A non-transitory computer-readable storage medium for storing a bitstream to be decoded by the method in any of EEEs 1_1-1_8 and 1_17-1_41.

EEE 1_71. A non-transitory computer-readable storage medium for storing a bitstream generated by the method in any of EEEs 1_9-1_16 and 1_42-1_65.

EEE 2_1. A method for video decoding, comprising: obtaining, by a decoder, multiple reference blocks for a current block based on template matching; obtaining, by the decoder, a fused reference block based on the multiple reference blocks; and obtaining, by the decoder, a final prediction block for the current block based on the fused reference block and a linear filter.

EEE 2_2. The method of EEE 2_1, wherein obtaining the final prediction block for the current block based on the fused reference block and the linear filter further comprises: obtaining the final prediction block for the current block by filtering the fused reference block using the linear filter associated with a plurality of filter coefficients.

EEE 2_3. The method of EEE 2_2, wherein obtaining the final prediction block for the current block by filtering the fused reference block using the linear filter associated with the plurality of filter coefficients comprises: obtaining a fused template based on the multiple reference blocks; deriving the plurality of filter coefficients based on the fused template and a current template of the current block; and obtaining the final prediction block for the current block by filtering the fused reference block using the linear filter associated with the plurality of filter coefficients.

EEE 2_4. The method of EEE 2_3, wherein obtaining the fused template based on the multiple reference blocks comprises: obtaining multiple templates for the multiple reference blocks; and obtaining the fused template based on the multiple templates for the multiple reference blocks.

EEE 2_5. A method for video encoding, comprising: obtaining, by an encoder, multiple reference blocks for a current block based on template matching; obtaining, by the encoder, a fused reference block based on the multiple reference blocks; and obtaining, by the encoder, a final prediction block for the current block based on the fused reference block and a linear filter.

EEE 2_6. The method of EEE 2_5, wherein obtaining the final prediction block for the current block based on the fused reference block and the linear filter further comprises: obtaining the final prediction block for the current block by filtering the fused reference block using the linear filter associated with a plurality of filter coefficients.

EEE 2_7. The method of EEE 2_6, wherein obtaining the final prediction block for the current block by filtering the fused reference block using the linear filter associated with the plurality of filter coefficients comprises: obtaining a fused template based on the multiple reference blocks; deriving the plurality of filter coefficients based on the fused template and a current template of the current block; and obtaining the final prediction block for the current block by filtering the fused reference block using the linear filter associated with the plurality of filter coefficients.

EEE 2_8. The method of EEE 2_7, wherein obtaining the fused template based on the multiple reference blocks comprises: obtaining multiple templates for the multiple reference blocks; and obtaining the fused template based on the multiple templates for the multiple reference blocks.

EEE 2_9. A method for video decoding, comprising: obtaining, by a decoder, at least one of a luma template for a luma coding block (CB) or chroma templates for chroma CBs utilized for template matching, wherein the chroma templates include a first chroma template for a first chroma CB and a second chroma template for a second chroma CB; calculating, by the decoder, a template matching cost between a current template of a current CB and at least one of the luma template or the chroma templates; and obtaining, by the decoder, a final prediction block of the current CB according to the template matching cost.

EEE 2_10. The method of EEE 2_9, wherein calculating the template matching cost between the current template and at least one of the luma template or the chroma templates comprises: calculating the template matching cost between the luma template and the current template of the current CB.

EEE 2_11. The method of EEE 2_9, wherein calculating the template matching cost between the current template and at least one of the luma template or the chroma templates comprises: obtaining a luma template cost between the luma template and the current template of the current CB, a first chroma template cost between the first chroma template and the current template, and a second chroma template cost between the second chroma template and the current template; and calculating a total template matching cost as the template matching cost by weighting the luma template cost, the first chroma template cost, and the second chroma template cost.

EEE 2_12. The method of EEE 2_9, wherein calculating the template matching cost between the current template and at least one of the luma template or the chroma templates comprises: obtaining a luma template cost between the luma template and the current template of the current CB, a first chroma template cost between the first chroma template and the current template, and a second chroma template cost between the second chroma template and the current template; obtaining a chroma template cost by adding the first chroma template cost and the second chroma template cost; and obtaining the template matching cost according to the luma template cost and the chroma template cost.

EEE 2_13. The method of EEE 2_9, wherein calculating the template matching cost between the current template and at least one of the luma template or the chroma templates comprises: obtaining a luma template matching cost between the luma template and a current template of the current CB; obtaining a first chroma template matching cost between the first chroma template and the current template; and obtaining a second chroma template matching cost between the second chroma template and the current template; wherein obtaining the final prediction block for the current CB based on the template matching cost comprises: obtaining a luma prediction block based on the luma template matching cost; obtaining a first chroma prediction block based on the first chroma template matching cost; obtaining a second chroma prediction block based on the second chroma template matching cost; and obtaining the final prediction block based on the luma prediction block, the first chroma prediction block, and the second chroma prediction block.

EEE 2_14. The method of any of EEEs 2_10-2_13, wherein a dual tree is disabled for inter slices or intra slices in a coding tree unit (CTU) including the current CB, and the luma CB, the first chroma CB, and the second chroma CB share a same partitioning tree.

EEE 2_15. The method of any of EEEs 2_10-2_13, wherein obtaining at least one of the luma template for the luma coding block or the chroma templates for the chroma CBs utilized for template matching comprises: receiving a flag indicating whether an intra template matching prediction (TMP) is enabled to the luma CB and the chroma CBs; and in response to determining that the flag indicates that the intra TMP is enabled to the luma CB and the chroma CBs, obtaining the luma template for the luma CB, or, obtaining the luma template for the luma CB and the chroma templates for the chroma CBs.

EEE 2_16. The method of EEE 2_9, wherein calculating the template matching cost between the current template of the current CB and at least one of the luma template or the chroma templates comprises: obtaining a first chroma template matching cost between the first chroma template and a current template of the current CB; and obtaining a second chroma template matching cost between the second chroma template and the current template; wherein obtaining the final prediction block for the current CB based on the template matching cost comprises: obtaining a first chroma prediction block based on the first chroma template matching cost; obtaining a second chroma prediction block based on the second chroma template matching cost; and obtaining the final prediction block based on the first and second chroma prediction blocks.

EEE 2_17. The method of EEE 216, wherein obtaining at least one of the luma template for the luma coding block or the chroma templates for the chroma CBs utilized for template matching comprises: receiving a first flag indicating whether an intra template matching prediction (TMP) is enabled for the first chroma CB and a second flag indicating whether the intra TMP is enabled for the second chroma CB; and in response to determining that the first flag indicates that the intra TMP is enabled for the first chroma CB and determining that the second flag indicates that the intra TMP is enabled for the second chroma CB, obtaining the first chroma template for the first chroma CB and the second chroma template for the second chroma CB.

EEE 2_18. The method of EEE 2_9, wherein calculating the template matching cost between the current template of the current CB and at least one of the luma template or the chroma templates comprises: obtaining a first chroma template matching cost between the first chroma template and a current template of the current CB; obtaining a second chroma template matching cost between the second chroma template and the current template; and calculating a chroma template matching cost by adding the first chroma template matching cost and the second chroma template matching cost; wherein obtaining the final prediction block for the current CB based on the template matching cost comprises: obtaining the final prediction block based on the chroma template matching cost.

EEE 2_19. The method of any of EEEs 2_16-2_18, wherein a dual tree is enabled for intra slices in a coding tree unit (CTU) including the current CB.

EEE 2_20. The method of EEE 218, wherein obtaining at least one of the luma template for the luma coding block or the chroma templates for the chroma CBs utilized for template matching comprises: receiving a flag indicating whether an intra TMP is enabled for the chroma CBs; and in response to determining that the flag indicates that the intra TMP is enabled for the chroma CBs, obtaining the first chroma template for the first chroma CB and the second chroma template for the second chroma CB.

EEE 2_21. A method for video encoding, comprising: obtaining, by an encoder, at least one of a luma template for a luma coding block (CB) or chroma templates for chroma CBs utilized for template matching, wherein the chroma templates include a first chroma template for a first chroma CB and a second chroma template for a second chroma CB; calculating, by the encoder, a template matching cost between a current template of a current CB and at least one of the luma template or the chroma templates; and obtaining, by the encoder, a final prediction block of the current CB according to the template matching cost.

EEE 2_22. The method of EEE 221, wherein calculating the template matching cost between the current template and at least one of the luma template or the chroma templates further comprises: calculating the template matching cost between the luma template and the current template of the current CB.

EEE 2_23. The method of EEE 221, wherein calculating the template matching cost between the current template and at least one of the luma template or the chroma templates further comprises: obtaining a luma template cost between the luma template and the current template of the current CB, a first chroma template cost between the first chroma template and the current template, and a second chroma template cost between the second chroma template and the current template; and calculating a total template matching cost as the template matching cost by weighting the luma template cost, the first chroma template cost, and the second chroma template cost.

EEE 2_24. The method of EEE 221, wherein calculating the template matching cost between the current template and at least one of the luma template or the chroma templates comprises: obtaining a luma template cost between the luma template and the current template of the current CB, a first chroma template cost between the first chroma template and the current template, and a second chroma template cost between the second chroma template and the current template; obtaining a chroma template cost by adding the first chroma template cost and the second chroma template cost; and obtaining the template matching cost according to the luma template cost and the chroma template cost.

EEE 2_25. The method of EEE 221, wherein calculating the template matching cost between the current template and at least one of the luma template or the chroma templates comprises: obtaining a luma template matching cost between the luma template and a current template of the current CB; obtaining a first chroma template matching cost between the first chroma template and the current template; and obtaining a second chroma template matching cost between the second chroma template and the current template; and wherein obtaining the final prediction block for the current CB based on the template matching cost comprises: obtaining a luma prediction block based on the luma template matching cost; obtaining a first chroma prediction block based on the first chroma template matching cost; obtaining a second chroma prediction block based on the second chroma template matching cost; and obtaining the final prediction block based on the luma prediction block, the first chroma prediction block, and the second chroma prediction block.

EEE 2_26. The method of any of EEEs 2_21-2_25, wherein a dual tree is disabled for inter slices or intra slices in a coding tree unit (CTU) including the current CB, and the luma CB, the first chroma CB, and the second chroma CB share a same partitioning tree.

EEE 2_27. The method of any of EEEs 2_21-2_25, wherein obtaining at least one of the luma template for the luma CB or the chroma templates for the chroma CBs utilized for template matching comprises: signaling a flag indicating whether an intra TMP is enabled to the luma CB and the chroma CBs; and in response to signaling the flag indicating that the intra TMP is enabled to the luma CB and the chroma CBs, obtaining the luma template for the luma CB, or obtaining the luma template for the luma CB and the chroma templates for the chroma CBs.

EEE 2_28. The method of EEE 221, wherein calculating the template matching cost between the current template of the current CB and at least one of the luma template or the chroma templates comprises: obtaining a first chroma template matching cost between the first chroma template and a current template of the current CB; and obtaining a second chroma template matching cost between the second chroma template and the current template; and wherein obtaining the final prediction block for the current CB based on the template matching cost comprises: obtaining a first chroma prediction block based on the first chroma template matching cost; obtaining a second chroma prediction block based on the second chroma template matching cost; and obtaining the final prediction block based on the first and second chroma prediction blocks.

EEE 2_29. The method of EEE 228, wherein obtaining at least one of the luma template for the luma CB or the chroma templates for the chroma CBs utilized for template matching comprises: signaling a first flag indicating whether an intra template matching prediction (TMP) is enabled for the first chroma CB and a second flag indicating whether the intra TMP is enabled for the second chroma CB; and in response to signaling the first flag indicating that the intra TMP is enabled for the first chroma CB and signaling the second flag indicating that the intra TMP is enabled for the second chroma CB, obtaining the first chroma template for the first chroma CB and the second chroma template for the second chroma CB.

EEE 2_30. The method of EEE 221, wherein calculating the template matching cost between the current template of the current CB and at least one of the luma template or the chroma templates comprises: obtaining a first chroma template matching cost between the first chroma template and a current template of the current CB; obtaining a second chroma template matching cost between the second chroma template and the current template; and calculating a chroma template matching cost by adding the first chroma template matching cost and the second chroma template matching cost; and wherein obtaining the final prediction block for the current CB based on the template matching cost comprises: obtaining the final prediction block based on the chroma template matching cost.

EEE 2_31. The method of any of EEEs 2_28-2_30, wherein a dual tree is enabled for intra slices in a coding tree unit (CTU) including the current CB.

EEE 2_32. The method of EEE 230, wherein obtaining at least one of the luma template for the luma CB or the chroma templates for the chroma CBs utilized for template matching comprises: signaling a flag indicating whether intra TMP is enabled for the chroma CBs; and in response to signaling the flag indicating that the intra TMP is enabled for the chroma CBs, obtaining the first chroma template for the first chroma CB and the second chroma template for the second chroma CB.

EEE 2_33. A method for video decoding, comprising: obtaining, by a decoder, a reference block of a current block and a reference template of the reference block based on intra template matching, wherein each of the current block and the reference block comprises a luma component and a chroma component, and wherein the reference template of the reference block comprises a reference chroma template corresponding to a chroma component of the reference block and a reference luma template corresponding to a collocated luma block; deriving, by the decoder, parameters of a cross-component prediction model based on a chroma template of a chroma component of the current block, the reference chroma template, and the reference luma template; and obtaining, by the decoder, a final prediction for the current chroma block by applying the parameters of the cross-component prediction model to the collocated luma block.

EEE 2_34. The method of EEE 2_33, wherein the cross-component prediction model comprises one of following models: a convolutional cross-component model (CCCM) or a cross-component linear model (CCLM).

EEE 2_35. A method for video encoding, comprising: obtaining, by an encoder, a reference block of a current block and a reference template of the reference block based on intra template matching, wherein each of the current block and the reference block comprises a luma component and a chroma component, and wherein the reference template of the reference block comprises a reference chroma template corresponding to a chroma component of the reference block and a reference luma template corresponding to a collocated luma block; deriving, by the encoder, parameters of a cross-component prediction model based on a chroma template of a chroma component of the current block, the reference chroma template, and the reference luma template of a collocated luma block; and obtaining, by the encoder, a final prediction for the current chroma block by applying the parameters of the cross-component prediction model to the collocated luma block.

EEE 2_36. The method of EEE 2_35, wherein the cross-component prediction model comprises one of following models: a convolutional cross-component model (CCCM) or a cross-component linear model (CCLM).

EEE 2_37. A method for video decoding, comprising: generating, by a decoder, a weighted prediction by weighting an intra predicted block and an intra template matching prediction (TMP) block; deriving, by the decoder, coefficients of a linear filter from a plurality of templates comprising a current template of a current block, an intra predicted template, and a reference template of a reference block; and obtaining, by the decoder, a final prediction by applying the coefficients of the linear filter to the weighted prediction.

EEE 2_38. The method of EEE 2_37, wherein deriving the coefficients of the linear filter from the plurality of templates comprising the current template of the current block, the intra predicted template, and the reference template comprises: obtaining the intra predicted template by conducting intra prediction with a current intra mode; obtaining a fused template by fusing the intra predicted template and the reference template; and deriving the coefficients of the linear filter by using the fused template and the current template to solve a least square equation.

EEE 2_39. The method of EEE 2_37, wherein deriving the coefficients of the linear filter from the plurality of templates comprising the current template of the current block, the intra predicted template, and the reference template further comprises: receiving a flag indicating whether the linear filter model applies; and in response to determining that the flag indicates the linear filter model applies, deriving the coefficients of the linear filter from the plurality of templates comprising the current template of the current block, the intra predicted template, and the reference template.

EEE 2_40. The method of EEE 2_37, wherein deriving the coefficients of the linear filter from the plurality of templates comprising the current template of the current block, the intra predicted template, and the reference template further comprises: deriving the coefficients of the linear filter from the plurality of templates comprising the current template of the current block, the intra predicted template, and the reference template, wherein each of the plurality of templates comprises one of a luma component or chroma components.

EEE 2_41. A method for video encoding, comprising: generating, by an encoder, a weighted prediction by weighting an intra predicted block and an intra template matching prediction (TMP) block; deriving, by the encoder, coefficients of a linear filter from a plurality of templates comprising a current template of a current block, an intra predicted template, and a reference template of a reference block; and obtaining, by the encoder, a final prediction by applying the coefficients of the linear filter to the weighted prediction.

EEE 2_42. The method of EEE 2_41, wherein deriving the coefficients of the linear filter from the plurality of templates comprising the current template of the current block, the intra predicted template, and the reference template comprises: obtaining the intra predicted template by conducting intra prediction with a current intra mode; obtaining a fused template by fusing the intra predicted template and the reference template; and deriving the coefficients of the linear filter using the fused template and the current template to solve a least square equation.

EEE 2_43. The method of EEE 2_41, wherein deriving the coefficients of the linear filter from the plurality of templates comprising the current template of the current block, the intra predicted template, and the reference template further comprises: signaling a flag indicating whether the linear filter model applies; and in response to the flag indicating that the linear filter model applies, deriving the coefficients of the linear filter from the plurality of templates comprising the current template of the current block, the intra predicted template, and the reference template.

EEE 2_44. The method of EEE 2_41, wherein deriving the coefficients of the linear filter from the plurality of templates comprising the current template of the current block, the intra predicted template, and the reference template further comprises: deriving the coefficients of the linear filter from the plurality of templates comprising the current template of the current block, the intra predicted template, and the reference template, wherein each of the plurality of templates comprises one of a luma component or chroma components.

EEE 2_45. An apparatus for video decoding, comprising: one or more processors; and a memory coupled to the one or more processors and configured to store instructions executable by the one or more processors, wherein the one or more processors, upon execution of the instructions, are configured to perform the method in any one of EEEs 2_1-2_4, 2_9-2_13, 2_16-2_18, 2_20, 2_33-2_34, and 2_37-2_40.

EEE 2_46. An apparatus for video encoding, comprising: one or more processors; and a memory coupled to the one or more processors and configured to store instructions executable by the one or more processors, wherein the one or more processors, upon execution of the instructions, are configured to perform the method in any one of EEEs 2_5-2_8, 2_21-2_25, 2_28-2_30, 2_35-2_36, and 2_41-2_44.

EEE 2_47. A non-transitory computer-readable storage medium for storing computer-executable instructions that, when executed by one or more computer processors, cause the one or more computer processors to perform the method in any of EEEs 2_1-2_4, 2_9-2_13, 2_16-2_18, 2_20, 2_33-2_34, and 2_37-2_40.

EEE 2_48. A non-transitory computer-readable storage medium for storing computer-executable instructions that, when executed by one or more computer processors, cause the one or more computer processors to perform the method in any of EEEs 2_5-2_8, 2_21-2_25, 2_28-2_30, 2_35-2_36, and 2_41-2_44.

EEE 2_49. A non-transitory computer-readable storage medium for storing a bitstream to be decoded by the method in any of EEEs 2_1-2_4, 2_9-2_13, 2_16-2_18, 2_20, 2_33-2_34, and 2_37-2_40.

EEE 2_50. A non-transitory computer-readable storage medium for storing a bitstream generated by the method in any of EEEs 2_5-2_8, 2_21-2_25, 2_28-2_30, 2_35-2_36 and 2_41-2_44.

EEE 3_1. A method for decoding video data, comprising: dividing, by a decoder, a template of a current block into a plurality of template segments; selecting, by the decoder, one or more template segments from the plurality of template segments for each block region; obtaining, by the decoder, a plurality of prediction regions for a plurality of block regions by obtaining a respective prediction region for said each block region based on the one or more template segments; and obtaining, by the decoder, a final prediction for the current block based on the plurality of prediction regions.

EEE 3_2. The method of EEE 3_1, wherein each block region is a subblock of the current block, and each subblock has a same size as each template segment; and wherein the plurality of template segments comprise a plurality of first template segments that are on left of the current block and a plurality of second template segments that are on top of the current block.

EEE 3_3. The method of EEE 3_2, wherein selecting the one or more template segments from the plurality of template segments for said each block region comprises: selecting a first number of first template segments from the plurality of first template segments and selecting a second number of second template segments from the plurality of second template segments, wherein the first number of template segments are the nearest template segments to said each block region among the plurality of first template segments, and the second number of second template segments are the nearest template segments to said each block region among the plurality of second template segments; and wherein obtaining a respective prediction region for said each block region based on the one or more template segments comprises: obtaining a respective prediction region for said each block region by applying template matching on the first number of first template segments and the second number of second template segments.

EEE 3_4. The method of EEE 3_2, wherein selecting the one or more template segments from the plurality of template segments for said each block region comprises: selecting a first number of first template segments from the plurality of first template segments, wherein the first number of template segments are the nearest template segments to said each block region among the plurality of first template segments; and wherein obtaining a respective prediction region for said each block region based on the one or more template segments comprises: obtaining a respective prediction region for said each block region by applying template matching on the first number of first template segments.

EEE 3_5. The method of EEE 3_2, wherein selecting the one or more template segments from the plurality of template segments for said each block region comprises: selecting a second number of second template segments from the plurality of second template segments, wherein the second number of template segments are the nearest template segments to said each block region among the plurality of second template segments; and wherein obtaining a respective prediction region for said each block region based on the one or more template segments comprises: obtaining a respective prediction region for said each block region by applying template matching on the second number of second template segments.

EEE 3_6. The method of EEE 3_1, wherein each block region comprises a plurality of subblocks, wherein the plurality of template segments comprise a left template segment and a top template segment, wherein the plurality of block regions comprise a first block region that is adjacent to the left and the top template segments, one or more second block regions that are adjacent to the left template segment, one or more third block regions that are adjacent to the top template segment, and a fourth block region that is not adjacent to the left or the top template segment; wherein selecting the one or more template segments from the plurality of template segments for said each block region comprises: selecting both the left and the top template segments for the first block region and the fourth block region; selecting the left template segment for a second block region; and selecting the top template segment for a third block region; and wherein obtaining a respective prediction region for said each block region based on the one or more template segments comprise: obtaining a respective prediction region for the first block region by applying template matching on the left and the top template segments; obtaining a respective prediction region for the fourth block region by applying template matching on the left and the top template segments; obtaining a respective prediction region for each second block region by applying template matching on the left template segment; and obtaining a respective prediction region for each third block region by applying template matching on the top template segment.

EEE 3_7. The method of EEE 3_1, further comprising: determining, by the decoder, whether the current block is coded with intra TMP mode; and in response to determining that the current block is coded with the intra TMP mode, determining, by the decoder, whether subblock intra TMP is utilized for the current block; and wherein dividing the template of the current block into the plurality of template segments further comprises: in response to determining that the subblock intra TMP is utilized for the current block, dividing the template of the current block into the plurality of template segments.

EEE 3_8. The method of EEE 3_1, further comprising: determining, by the decoder, whether the current block is coded with intra TMP mode; and in response to determining that the current block is coded with the intra TMP mode, receiving, by the decoder, a syntax element indicating whether the subblock intra TMP is utilized; and wherein dividing the template of the current block into the plurality of template segments further comprises: in response to determining that the syntax element indicates that the subblock intra TMP is utilized, dividing the template of the current block into the plurality of template segments.

EEE 3_9. A method for encoding video data, comprising: dividing, by an encoder, a template of a current block into a plurality of template segments; selecting, by the encoder, one or more template segments from the plurality of template segments for each block region; obtaining, by the encoder, a plurality of prediction regions for a plurality of block regions by obtaining a respective prediction region for said each block region based on the one or more template segments; and obtaining, by the encoder, a final prediction for the current block based on the plurality of prediction regions.

EEE 3_10. The method of EEE 3_9, wherein each block region is a subblock of the current block, and each subblock has a same size as each template segment; and wherein the plurality of template segments comprise a plurality of first template segments that are on left of the current block and a plurality of second template segments that are on top of the current block.

EEE 3_11. The method of EEE 310, wherein selecting the one or more template segments from the plurality of template segments for said each block region comprises: selecting a first number of first template segments from the plurality of first template segments and selecting a second number of second template segments from the plurality of second template segments, wherein the first number of template segments are the nearest template segments to said each block region among the plurality of first template segments, and the second number of second template segments are the nearest template segments to said each block region among the plurality of second template segments; and wherein obtaining a respective prediction region for said each block region based on the one or more template segments comprises: obtaining a respective prediction region for said each block region by applying template matching on the first number of first template segments and the second number of second template segments.

EEE 3_12. The method of EEE 310, wherein selecting the one or more template segments from the plurality of template segments for said each block region comprises: selecting a first number of first template segments from the plurality of first template segments, wherein the first number of template segments are the nearest template segments to said each block region among the plurality of first template segments; and wherein obtaining a respective prediction region for said each block region based on the one or more template segments comprises: obtaining a respective prediction region for said each block region by applying template matching on the first number of first template segments.

EEE 3_13. The method of EEE 310, wherein selecting the one or more template segments from the plurality of template segments for said each block region comprises: selecting a second number of second template segments from the plurality of second template segments, wherein the second number of template segments are the nearest template segments to said each block region among the plurality of second template segments; and wherein obtaining a respective prediction region for said each block region based on the one or more template segments comprises: obtaining a respective prediction region for said each block region by applying template matching on the second number of second template segments.

EEE 3_14. The method of EEE 3_9, wherein each block region comprises a plurality of subblocks, wherein the plurality of template segments comprise a left template segment and a top template segment, wherein the plurality of block regions comprise a first block region that is adjacent to the left and the top template segments, one or more second block regions that are adjacent to the left template segment, one or more third block regions that are adjacent to the top template segment, and a fourth block region that is not adjacent to the left or the top template segment; wherein selecting the one or more template segments from the plurality of template segments for said each block region comprises: selecting both the left template segment and the top template segment for the first block region and the fourth block region; selecting the left template segment for a second block region; and selecting the top template segment for a third block region; and obtaining a respective prediction region for said each block region based on the one or more template segments comprise: obtaining a respective prediction region for the first block region by applying template matching on the left and the top template segments; obtaining a respective prediction region for the fourth block region by applying template matching on the left and the top template segments; obtaining a respective prediction region for each second block region by applying template matching on the left template segment; and obtaining a respective prediction region for each third block region by applying template matching on the top template segment.

EEE 3_15. The method of EEE 3_9, further comprising: determining, by the encoder, whether the current block is coded with intra TMP mode; and in response to determining that the current block is coded with the intra TMP mode, determining, by the encoder, whether subblock intra TMP is utilized for the current block; and wherein dividing the template of the current block into the plurality of template segments further comprises: in response to determining that the subblock intra TMP is utilized for the current block, dividing the template of the current block into the plurality of template segments.

EEE 3_16. The method of EEE 3_9, further comprising: in response to determining that the current block is coded with intra TMP mode, signaling, by the encoder, a syntax element indicating whether the subblock intra TMP is utilized; and wherein dividing the template of the current block into the plurality of template segments further comprises: in response to determining that the syntax element indicates that the subblock intra TMP is utilized, dividing the template of the current block into the plurality of template segments.

EEE 3_17. A method for decoding video data, comprising: obtaining, by a decoder, a plurality of first prediction samples using a first prediction process; obtaining, by the decoder, a plurality of second prediction samples using a second prediction process based on the plurality of first prediction samples and a plurality of neighboring reconstructed samples; and obtaining, by the decoder, a final prediction block for a current block according to the plurality of first prediction samples and the plurality of second prediction samples.

EEE 3_18. The method of EEE 3_17, wherein the first prediction process comprises an intra template matching prediction (TMP) mode.

EEE 3_19. The method of EEE 317, wherein the second prediction process comprises a planar mode, and wherein obtaining the plurality of second prediction samples using the second prediction process based on the plurality of first prediction samples and the plurality of neighboring reconstructed samples comprises: obtaining a second prediction sample by weighting two projected neighboring reconstructed samples and two projected first prediction samples.

EEE 3_20. The method of EEE 3_17, further comprising: in response to determining that the current block is coded with an intra mode, receiving, by the decoder, a syntax element that indicates whether to combine the first prediction process and the second prediction process to obtain the final prediction for the current block; and wherein obtaining the final prediction block for the current block according to the plurality of first prediction samples and the plurality of second prediction samples further comprises: in response to determining that the syntax element indicates to combine the first prediction process and the second prediction process to obtain the final prediction for the current block, obtaining the final prediction block for the current block according to the plurality of first prediction samples and the plurality of second prediction samples.

EEE 3_21. The method of EEE 317, wherein the second prediction process comprises an angular intra mode, and wherein obtaining the plurality of second prediction samples using the second prediction process based on the plurality of first prediction samples and the plurality of neighboring reconstructed samples comprises: obtaining a second prediction sample by interpolating a neighboring reconstructed sample and a first prediction sample.

EEE 3_22. The method of EEE 3_17, further comprising: in response to determining that the current block is coded with an intra mode, receiving, by the decoder, a first syntax element that indicates whether to combine the first prediction process and the second prediction process to obtain the final prediction for the current block; and in response to determining that the first syntax element indicates to combine the first prediction process and the second prediction process to obtain the final prediction for the current block, receiving, by the decoder, a second syntax element to determine whether the second prediction process is a planar mode or an angular mode; and wherein obtaining the plurality of second prediction samples using the second prediction process based on the plurality of first prediction samples and the plurality of neighboring reconstructed samples further comprises: in response to determining that the second syntax element indicates that the second prediction process is the planar mode, obtaining a second prediction sample by weighting two projected neighboring reconstructed samples and two projected first prediction samples; and in response to determining that the second syntax element indicates that the second prediction process is the angular mode, obtaining a second prediction sample by interpolating a neighboring reconstructed sample and a first prediction sample.

EEE 3_23. A method for encoding video data, comprising: obtaining, by an encoder, a plurality of first prediction samples using a first prediction process; obtaining, by the encoder, a plurality of second prediction samples using a second prediction process based on the plurality of first prediction samples and a plurality of neighboring reconstructed samples; and obtaining, by the encoder, a final prediction block for a current block according to the plurality of first prediction samples and the plurality of second prediction samples.

EEE 3_24. The method of EEE 3_23, wherein the first prediction process comprises an intra template matching prediction (TMP) mode.

EEE 3_25. The method of EEE 3_23, wherein the second prediction process comprises a planar mode, and wherein obtaining the plurality of second prediction samples using the second prediction process based on the plurality of first prediction samples and the plurality of neighboring reconstructed samples comprises: obtaining a second prediction sample by weighting two projected neighboring reconstructed samples and two projected first prediction samples.

EEE 3_26. The method of EEE 3_23, further comprising: in response to determining that the current block is coded with an intra mode, signaling, by the encoder, a syntax element that indicates whether to combine the first prediction process and the second prediction process to obtain the final prediction for the current block; and wherein obtaining the final prediction block for the current block according to the plurality of first prediction samples and the plurality of second prediction samples further comprises: in response to determining that the syntax element indicates to combine the first prediction process and the second prediction process to obtain the final prediction for the current block, obtaining the final prediction block for the current block according to the plurality of first prediction samples and the plurality of second prediction samples.

EEE 3_27. The method of EEE 3_23, wherein the second prediction process comprises an angular intra mode, and wherein obtaining the plurality of second prediction samples using the second prediction process based on the plurality of first prediction samples and the neighboring reconstructed samples comprises: obtaining a prediction sample in the plurality of second prediction samples by interpolating a neighboring reconstructed sample and a first prediction sample.

EEE 3_28. The method of EEE 3_23, further comprising: in response to determining that the current block is coded with an intra mode, signaling, by the encoder, a first syntax element that indicates whether to combine the first prediction process and the second prediction process to obtain the final prediction for the current block; and in response to determining that the first syntax element indicates to combine the first prediction process and the second prediction process to obtain the final prediction for the current block, signaling, by the encoder, a second syntax element to determine whether the second prediction process is a planar mode or an angular mode; and wherein obtaining the plurality of second prediction samples using the second prediction process based on the plurality of first prediction samples and the plurality of neighboring reconstructed samples further comprises: in response to determining that the second syntax element indicates that the second prediction process is the planar mode, obtaining a second prediction sample by weighting two projected neighboring reconstructed samples and two projected first prediction samples; and in response to determining that the second syntax element indicates that the second prediction process is the angular mode, obtaining a second prediction sample by interpolating a neighboring reconstructed sample and a first prediction sample.

EEE 3_29. An apparatus for video decoding, comprising: one or more processors; and a memory coupled to the one or more processors and configured to store instructions executable by the one or more processors, wherein the one or more processors, upon execution of the instructions, are configured to perform the method in any one of EEEs 3_1-3_8 and 3_17-3_22.

EEE 3_30. An apparatus for video encoding, comprising: one or more processors; and a memory coupled to the one or more processors and configured to store instructions executable by the one or more processors, wherein the one or more processors, upon execution of the instructions, are configured to perform the method in any one of EEEs 3_9-3_16 and 3_23-3_28.

EEE 3_31. A non-transitory computer-readable storage medium for storing computer-executable instructions that, when executed by one or more computer processors, cause the one or more computer processors to perform the method in any of EEEs 3_1-3_8 and 3_17-3_22.

EEE 3_32. A non-transitory computer-readable storage medium for storing computer-executable instructions that, when executed by one or more computer processors, cause the one or more computer processors to perform the method in any of EEEs 3_9-3_16 and 3_23-3_28.

EEE 3_33. A non-transitory computer-readable storage medium for storing a bitstream to be decoded by the method in any of EEEs 3_1-3_8 and 3_17-3_22.

EEE 3_34. A non-transitory computer-readable storage medium for storing a bitstream generated by the method in any of EEEs 3_9-3_16 and 3_23-3_28.

EEE 4_1. A method for video decoding, comprising: in response to determining that multi-hypothesis intra template matching prediction (TMP) is used, obtaining, by a decoder, one or more reference block candidates of a current block; and obtaining, by the decoder, a final prediction for the current block based on the one or more reference block candidates.

EEE 4_2. The method of EEE 4_1, wherein obtaining, by the decoder, the one or more reference block candidates comprises: selecting, by the decoder, one or more prediction block candidates based on minimizing a template matching cost, wherein a template matching cost of the one or more prediction block candidates is less than template matching costs of other prediction block candidates; and setting, by the decoder, the one or more reference block candidates as the one or more prediction block candidates.

EEE 4_3. The method of EEE 4_2, wherein the template matching cost comprises a sum of absolute differences (SAD), a sum of squared differences (SSD), or a sum of other values that measure a similarity between two blocks.

EEE 4_4. The method of EEE 4_1, further comprising: obtaining, by the decoder, an intermediate prediction block; and wherein obtaining, by the decoder, the one or more reference block candidates comprises: deriving, by the decoder, the one or more reference block candidates based on the intermediate prediction block.

EEE 4_5. The method of EEE 4_4, wherein obtaining, by the decoder, the intermediate prediction block comprises: searching, by the decoder, for one or more intermediate reference block candidates, wherein template matching cost of the one or more intermediate reference block candidates is lower than template matching costs of other block candidates; and generating, by the decoder, the intermediate prediction block based on the one or more intermediate reference block candidates.

EEE 4_6. The method of EEE 4_5, wherein the intermediate prediction block is generated using a fixed multi-hypothesis intra TMP or an adaptive multi-hypothesis intra TMP.

EEE 4_7. The method of EEE 4_4, wherein obtaining, by the decoder, the intermediate prediction block comprises: setting, by the decoder, the intermediate prediction block as a reference block, wherein a template matching cost of the reference block is lower than template matching costs of other reference blocks.

EEE 4_8. The method of EEE 4_4, wherein obtaining, by the decoder, the intermediate prediction block comprises: receiving, by the decoder, a block vector (BV) corresponding to the intermediate prediction block signaled in a bitstream; wherein a rate-distortion cost of the intermediate prediction block is lower than rate-distortion costs of other prediction blocks; and wherein the BV is configured to indicate the intermediate prediction block.

EEE 4_9. The method of EEE 4_4, wherein deriving, by the decoder, the one or more reference block candidates based on the intermediate prediction block comprises: obtaining, by the decoder, one or more reference blocks, wherein distances between the one or more references blocks and the intermediate prediction block are less than distances between other reference blocks and the intermediate prediction block; and setting, by the decoder, the one or more reference block candidates as the one or more reference blocks.

EEE 4_10. The method of EEE 4_4, wherein deriving, by the decoder, the one or more reference block candidates based on the intermediate prediction block comprises: obtaining, by the decoder, an intermediate region comprising the intermediate prediction block and a neighboring template corresponding to the intermediate prediction block; obtaining, by the decoder, one or more reference regions corresponding to one or more reference blocks, wherein each of the one or more reference regions comprises a reference block and a neighboring template corresponding to the reference block; obtaining, by the decoder, one or more reference blocks, wherein distances between the one or more references regions containing the one or more reference blocks and the intermediate region are less than distances between other reference regions and the intermediate region; and setting, by the decoder, the one or more reference block candidates as the one or more reference blocks.

EEE 4_11. The method of EEE 4_4, further comprising: dividing, by the decoder, the intermediate prediction block into a plurality of intermediate subblocks; for each one of the plurality of intermediate subblocks, obtaining, by the decoder, one or more reference subblocks, wherein distances between the one or more reference subblocks and the one of the plurality of intermediate subblocks are less than distances between other reference subblocks and the one of the plurality of intermediate subblocks; and selecting, by the decoder, the one or more reference subblocks as one or more reference subblock candidates; and obtaining, by the decoder, a final prediction for a current subblock using the one or more reference subblock candidates.

EEE 4_12. The method of EEE 4_9, wherein a distance comprises a sum of absolute differences (SAD), a sum of squared differences (SSD), or a sum of other values that measure a similarity between two blocks.

EEE 4_13. The method of EEE 49, wherein obtaining, by the decoder, the final prediction for the current block comprises: obtaining, by the decoder, the final prediction for the current block based on the one or more reference block candidates and using a fixed multi-hypothesis intra TMP or an adaptive multi-hypothesis intra TMP.

EEE 4_14. The method of EEE 4_4, wherein the intermediate prediction block comprises one or more pixels, and the multi-hypothesis intra TMP comprises a pixel-level multi-hypothesis intra TMP.

EEE 4_15. The method of EEE 414, further comprising: determining, by the decoder, one or more weighting factors; and wherein obtaining, by the decoder, the final prediction for the current block comprises: obtaining, by the decoder, the final prediction for the current block based on the one or more reference block candidates, the multi-hypothesis intra TMP, and the one or more weighting factors.

EEE 4_16. The method of EEE 415, wherein the one or more weighting factors correspond to one or more reference pixels in one or more reference blocks; and wherein determining, by the decoder, the one or more weighting factors comprises: obtaining, by the decoder, one or more distances, wherein each of the one or more distances is a distance between a current pixel and a collocated pixel in one of the one or more reference blocks; and computing, by the decoder, the one or more weighting factors based on the one or more distances.

EEE 4_17. The method of EEE 415, wherein the one or more weighting factors correspond to one or more reference pixels in one or more reference subblocks; and wherein determining, by the decoder, the one or more weighting factors comprises: obtaining, by the decoder, a current subblock, wherein the current subblock is centered at a current pixel; obtaining, by the decoder, the one or more reference subblocks, wherein distances between the one or more reference subblocks and the current subblock are less than distances between other reference subblocks and the current subblock; and computing, by the decoder, the one or more weighting factors based on the distances between the one or more reference subblocks and the current subblock.

EEE 4_18. The method of EEE 415, wherein the one or more weighting factors correspond to one or more reference pixels in one or more reference subblocks; and wherein determining, by the decoder, the one or more weighting factors comprises: obtaining, by the decoder, a current subblock, wherein the current subblock is centered at a current pixel; obtaining, by the decoder, the one or more reference subblocks, wherein distances between central pixels of the one or more reference subblocks and the current pixel are less than distances between central pixels of other reference subblocks and the current pixel; and computing, by the decoder, the one or more weighting factors based on the distances between the central pixels of the one or more reference subblocks and the current pixel.

EEE 4_19. The method of EEE 416, wherein computing, by the decoder, the one or more weighting factors further comprises: computing, by the decoder, the one or more weighting factors based on the one or more distances and a degree of weighting; wherein, the degree of weighting is one of a fixed value or an adaptively decided value.

EEE 4_20. The method of EEE 4_14, further comprising: obtaining, by the decoder, a current subblock, wherein the current subblock is centered at a current pixel; and obtaining, by the decoder, one or more reference subblocks, wherein distances between the one or more reference subblocks and the current subblock are less than distances between other reference subblocks and the current subblock; and wherein obtaining, by the decoder, the final prediction for the current block comprises: generating, by the decoder and using singular value decomposition (SVD), a prediction subblock based on the current subblock and the one or more reference subblocks; and setting, by the decoder, a pixel at a center of the prediction subblock as a final prediction for the current pixel corresponding to the current subblock.

EEE 4_21. A method for video encoding, comprising: in response to determining that multi-hypothesis intra template matching prediction (TMP) is used, obtaining, by an encoder, one or more reference block candidates of a current block; obtaining, by the encoder, a final prediction for the current block based on the one or more reference block candidates; and generating, by the encoder, a bitstream based on the final prediction.

EEE 4_22. The method of EEE 4_21, wherein obtaining, by the encoder, the one or more reference block candidates comprises: selecting, by the encoder, one or more prediction block candidates based on minimizing a template matching cost, wherein a template matching cost of the one or more prediction block candidates is less than template matching costs of other prediction block candidates; and setting, by the encoder, the one or more reference block candidates as the one or more prediction block candidates.

EEE 4_23. The method of EEE 422, wherein the template cost comprises a sum of absolute differences (SAD), a sum of squared differences (SSD), or a sum of other values that measure a similarity between two blocks.

EEE 4_24. The method of EEE 4_21, further comprising: obtaining, by the encoder, an intermediate prediction block; and wherein obtaining, by the encoder, the one or more reference block candidates comprises: deriving, by the encoder, the one or more reference block candidates based on the intermediate prediction block.

EEE 4_25. The method of EEE 4_24, wherein obtaining, by the encoder, the intermediate prediction block comprises: searching, by the encoder, for one or more intermediate reference block candidates, wherein template matching cost of the one or more intermediate reference block candidates is lower than template matching costs of other block candidates; and generating, by the encoder, the intermediate prediction block based on the one or more intermediate reference block candidates.

EEE 4_26. The method of EEE 425, wherein the intermediate prediction block is generated using a fixed multi-hypothesis intra TMP or an adaptive multi-hypothesis intra TMP.

EEE 4_27. The method of EEE 4_24, wherein obtaining, by the encoder, the intermediate prediction block comprises: setting, by the encoder, the intermediate prediction block as a reference block, wherein a template matching cost of the reference block is lower than template matching costs of other reference blocks.

EEE 4_28. The method of EEE 4_24, wherein obtaining, by the encoder, the intermediate prediction block comprises: signaling, by the encoder, a block vector (BV) corresponding to the intermediate prediction block in a bitstream; wherein a rate-distortion cost of the intermediate prediction block is lower than rate-distortion costs of other prediction blocks; and wherein the BV is configured to indicate the intermediate prediction block.

EEE 4_29. The method of EEE 424, wherein deriving, by the encoder, the one or more reference block candidates based on the intermediate prediction block comprises: obtaining, by the encoder, one or more reference blocks, wherein distances between the one or more references blocks and the intermediate prediction block are less than distances between other reference blocks and the intermediate prediction block; and setting, by the encoder, the one or more reference block candidates as the one or more reference blocks.

EEE 4_30. The method of EEE 424, wherein deriving, by the encoder, the one or more reference block candidates based on the intermediate prediction block comprises: obtaining, by the encoder, an intermediate region comprising the intermediate prediction block and a neighboring template corresponding to the intermediate prediction block; obtaining, by the encoder, one or more reference regions corresponding to one or more reference blocks, wherein each of the one or more reference regions comprises a reference block and a neighboring template corresponding to the reference block; obtaining, by the encoder, one or more reference blocks, wherein distances between the one or more references regions containing the one or more reference blocks and the intermediate region are less than distances between other reference regions and the intermediate region; and setting, by the encoder, the one or more reference block candidates as the one or more reference blocks.

EEE 4_31. The method of EEE 4_24, further comprising: dividing, by the encoder, the intermediate prediction block into a plurality of intermediate subblocks; for each one of the plurality of intermediate subblocks, obtaining, by the encoder, one or more reference subblocks, wherein distances between the one or more reference subblocks and the one of the plurality of intermediate subblocks are less than distances between other reference subblocks and the one of the plurality of intermediate subblocks; selecting, by the encoder, the one or more reference subblocks as one or more reference subblock candidates; and obtaining, by the decoder, a final prediction for a current subblock using the one or more reference subblock candidates.

EEE 4_32. The method of EEE 4_29, wherein a distance comprises a sum of absolute differences (SAD), a sum of squared differences (SSD), or a sum of other values that measure a similarity between two blocks.

EEE 4_33. The method of EEE 429, wherein obtaining, by the encoder, the final prediction for the current block comprises: obtaining, by the encoder, the final prediction for the current block based on the one or more reference block candidates and using a fixed multi-hypothesis intra TMP or an adaptive multi-hypothesis intra TMP.

EEE 4_34. The method of EEE 4_24, wherein the intermediate prediction block comprises one or more pixels, and the multi-hypothesis intra TMP comprises a pixel-level multi-hypothesis intra TMP.

EEE 4_35. The method of EEE 4_34, further comprising: determining, by the encoder, one or more weighting factors; and wherein obtaining, by the encoder, the final prediction for the current block comprises: obtaining, by the encoder, the final prediction for the current block based on the one or more reference block candidates, the multi-hypothesis intra TMP, and the one or more weighting factors.

EEE 4_36. The method of EEE 435, wherein the one or more weighting factors correspond to one or more reference pixels in one or more reference blocks; and wherein determining, by the encoder, the one or more weighting factors comprises: obtaining, by the encoder, one or more distances, wherein each of the one or more distances is a distance between a current pixel and a collocated pixel in one of the one or more reference blocks; and computing, by the encoder, the one or more weighting factors based on the one or more distances.

EEE 4_37. The method of EEE 435, wherein the one or more weighting factors correspond to one or more reference pixels in one or more reference subblocks; and wherein determining, by the encoder, the one or more weighting factors comprises: obtaining, by the encoder, a current subblock, wherein the current subblock is centered at a current pixel; obtaining, by the encoder, the one or more reference subblocks, wherein distances between the one or more reference subblocks and the current subblock are less than distances between other reference subblocks and the current subblock; and computing, by the encoder, the one or more weighting factors based on the distances between the one or more reference subblocks and the current subblock.

EEE 4_38. The method of EEE 435, wherein the one or more weighting factors correspond to one or more reference pixels in one or more reference subblocks; and wherein determining, by the encoder, the one or more weighting factors comprises: obtaining, by the encoder, a current subblock, wherein the current subblock is centered at a current pixel; obtaining, by the encoder, the one or more reference subblocks, wherein distances between central pixels of the one or more reference subblocks and the current pixel are less than distances between central pixels of other reference subblocks and the current pixel; and computing, by the encoder, the one or more weighting factors based on the distances between the central pixels of the one or more reference subblocks and the current pixel.

EEE 4_39. The method of EEE 436, wherein computing, by the encoder, the one or more weighting factors further comprises: computing, by the encoder, the one or more weighting factors based on the one or more distances and a degree of weighting; wherein, the degree of weighting is one of a fixed value or an adaptively decided value.

EEE 4_40. The method of EEE 4_34, further comprising: obtaining, by the encoder, a current subblock, wherein the current subblock is centered at a current pixel; and obtaining, by the encoder, one or more reference subblocks, wherein distances between the one or more reference subblocks and the current subblock are less than distances between other reference subblocks and the current subblock; and wherein obtaining, by the encoder, the final prediction for the current block comprises: generating, by the encoder and using singular value decomposition (SVD), a prediction subblock based on the current subblock and the one or more reference subblocks; and setting, by the encoder, a pixel at a center of the prediction subblock as a final prediction for the current pixel corresponding to the current subblock.

EEE 4_41. An apparatus for video decoding, comprising: one or more processors; and a memory coupled to the one or more processors and configured to store instructions executable by the one or more processors, wherein the one or more processors, upon execution of the instructions, are configured to perform the method in any one of EEEs 4_1-4_20.

EEE 4_42. An apparatus for video encoding, comprising: one or more processors; and a memory coupled to the one or more processors and configured to store instructions executable by the one or more processors, wherein the one or more processors, upon execution of the instructions, are configured to perform the method in any one of EEEs 4_21-4_40.

EEE 4_43. A non-transitory computer-readable storage medium for storing computer-executable instructions that, when executed by one or more computer processors, cause the one or more computer processors to perform the method in any of EEEs 4_1-4_20.

EEE 4_44. A non-transitory computer-readable storage medium for storing computer-executable instructions that, when executed by one or more computer processors, cause the one or more computer processors to perform the method in any of EEEs 4_21-4_40.

EEE 4_45. A non-transitory computer-readable storage medium for storing a bitstream to be decoded by the method in any of EEEs 4_1-4_20.

EEE 4_46. A non-transitory computer-readable storage medium for storing a bitstream generated by the method in any of EEEs 4_21-4_40.

What is claimed is:

1. A method for video decoding, comprising:
obtaining, by a decoder, a current template of a current coding unit (CU) coded with Intra template matching prediction (TMP) mode;
obtaining, by the decoder, an optimal integer predicted template;
obtaining, by the decoder, fractional-pel predicted templates; and
obtaining, by the decoder, a final prediction for the current CU based on distances between the current template and the optimal integer predicted template and the fractional-pel predicted templates.

2. The method of claim 1, wherein the fractional-pel predicted templates comprise at least one of half-pel templates or quarter-pel templates.

3. The method of claim 1, further comprising:
obtaining, by the decoder, an index value signaled in a bitstream, wherein the index value indicates an interpolation accuracy.

4. The method of claim 3, wherein obtaining, by the decoder, the fractional-pel predicted templates comprises:
obtaining, by the decoder, the fractional-pel predicted templates based on the interpolation accuracy.

5. The method of claim 3, wherein the index value is signaled at a particular level comprising Picture Parameter Set (PPS), Sequence Parameter Set (SPS), or slice header.

6. The method of claim 1, wherein obtaining, by the decoder, the fractional-pel predicted templates comprises: interpolating, by the decoder, fractional templates surrounding the optimal integer predicted template; and
wherein obtaining, by the decoder, the final prediction for the current CU comprises: conducting, by the decoder, template matchings.

7. The method of claim 6, wherein interpolating, by the decoder, the fractional templates surrounding the optimal integer predicted template comprises:
interpolating, by the decoder, eight half-pel predicted templates.

8. The method of claim 6, wherein conducting, by the decoder, the template matchings comprise:
computing, by the decoder, a first distance between a current template and the optimal integer predicted template;
computing, by the decoder, several second distances between the current template and the fractional-pel predicted templates;
comparing, by the decoder, the first distance and the several second distances;
identifying, by the decoder, an optimal predicted template leading to a minimum template matching cost based on a result of comparing, by the decoder, the first distance and the several second distances, and a predicted CU corresponding to the optimal predicted template; and
setting, by the decoder, the predicted CU as the final prediction.

9. An apparatus for video decoding, comprising:
one or more processors; and
a memory coupled to the one or more processors and configured to store instructions executable by the one or more processors,
wherein at least one of the one or more processors, upon execution of the instructions, is configured to perform operations comprising:
obtaining, by a decoder, a current template of a current coding unit (CU) coded with Intra template matching prediction (TMP) mode;
obtaining, by the decoder, an optimal integer predicted template;
obtaining, by the decoder, fractional-pel predicted templates; and
obtaining, by the decoder, a final prediction for the current CU based on distances between the current template and the optimal integer predicted template and the fractional-pel predicted templates.

10. The apparatus of claim 9, wherein the fractional-pel predicted templates comprise at least one of half-pel templates or quarter-pel templates.

11. The apparatus of claim 9, wherein the operations further comprise:
obtaining, by the decoder, an index value signaled in a bitstream, wherein the index value indicates an interpolation accuracy.

12. The apparatus of claim 11, wherein obtaining, by the decoder, the fractional-pel predicted templates comprises:
obtaining, by the decoder, the fractional-pel predicted templates based on the interpolation accuracy.

13. The apparatus of claim 11, wherein the index value is signaled at a particular level comprising Picture Parameter Set (PPS), Sequence Parameter Set (SPS), or slice header.

14. The apparatus of claim 9, wherein obtaining, by the decoder, the fractional-pel predicted templates comprises: interpolating, by the decoder, fractional templates surrounding the optimal integer predicted template; and
wherein obtaining, by the decoder, the final prediction for the current CU comprises: conducting, by the decoder template matchings.

15. The apparatus of claim 14, wherein interpolating, by the decoder, the fractional templates surrounding the optimal integer predicted template comprises:
interpolating, by the decoder, eight half-pel predicted templates.

16. The apparatus of claim 14, wherein conducting, by the decoder, the template matchings comprises:
computing, by the decoder, a first distance between a current template and the optimal integer predicted template;
computing, by the decoder, several second distances between the current template and the fractional-pel predicted templates;
comparing, by the decoder, the first distance and the several second distances;
identifying, by the decoder, an optimal predicted template leading to a minimum template matching cost based on a result of comparing, by the decoder, the first distance and the several second distances, and a predicted CU corresponding to the optimal predicted template; and
setting, by the decoder, the predicted CU as the final prediction.

17. A non-transitory computer-readable storage medium storing a bitstream to be decoded by performing the method according to claim 1.

18. The storage medium of claim 17, wherein the fractional-pel predicted templates comprise at least one of half-pel templates or quarter-pel templates.

19. The storage medium of claim 17, wherein the method further comprises:
obtaining, by the decoder, an index value signaled in a bitstream, wherein the index value indicates an interpolation accuracy.

20. A method of storing a bitstream, comprising:
generating a bitstream by performing an encoding method; and
storing the bitstream on a non-transitory computer-readable storage medium,
wherein the encoding method comprises:
encoding, by an encoder, a current template of a current coding unit (CU) coded with Intra template matching prediction (TMP) mode;
obtaining, by the encoder, an optimal integer predicted template;
obtaining, by the encoder, fractional-pel predicted templates; and
obtaining, by the encoder, a final prediction for the current CU based on distances between the current template and the optimal integer predicted template and the fractional-pel predicted templates.
